(19) United States
(12) Patent Application Publication
(10) Pub. No.: US 2026/0330471 A1
(43) Pub. Date: Oct. 22, 2026

(54) SYSTEM

(71) Applicant: SoftBank Group Corp., Tokyo (JP)

(72) Inventor: Megumi NAGANO, Tokyo (JP)

(73) Assignee: SoftBank Group Corp., Tokyo (JP)

(21) Appl. No.: 19/649,180

(22) Filed: Apr. 16, 2026

(30) Foreign Application Priority Data
Apr. 22, 2025 (JP) 2025-070977

(51) Int. Cl. G06Q 30/015; G06N 3/042; G06N 3/0475

(52) U.S. Cl. CPC G06Q 30/015; G06N 3/042; G06N 3/0475

(57) ABSTRACT

The present invention relates to a customer support system comprising an inquiry receiving unit, a priority determining unit, a generative AI response unit, an escalation unit, a knowledge base management unit, a trend learning unit, and the like, which automatically receives, analyzes, and prioritizes various inquiries from customers using generative AI, and automatically generates an optimal response text in cooperation with a knowledge base and an external system. When a reliability is low, automatic escalation to a human operator is performed, and by learning and reflecting an inquiry history and a trend in real time, equalization of response quality, operational efficiency improvement, cost reduction, and customer satisfaction improvement are simultaneously realized.

### CROSS-REFERENCE TO RELATED APPLICATION

The present application claims priority to and incorporates by reference the entire contents of Japanese Patent Application No. 2025-070977 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is the limitations of conventional systems, such as variations in the quality of customer handling occurring in customer support operations, delays in response time to a huge number of inquiries, high labor costs, particularly an increase in costs associated with maintaining a 24/7 system, an increase in fatigue and turnover rate due to an increase in the work burden on customer support personnel, and an inability to respond quickly and accurately when a new customer need or trouble occurs. In order to solve these problems, an object of the present invention is to simultaneously achieve an improvement in customer satisfaction, an improvement in operational efficiency, a reduction in support costs, a reduction in the burden on personnel, and a reduction in the turnover rate by introducing an AI agent that autonomously and continuously learns and evolves utilizing generative AI, thereby realizing automatic reception of content of the inquiry, prioritization, consistent and high-quality automatic response based on a knowledge base, appropriate escalation to a human operator based on a reliability determination, and real-time trend learning and automatic expansion of the knowledge base.

### SUMMARY OF THE INVENTION

Means for solving the problems according to the present invention constitutes a customer support system comprising an inquiry receiving unit, a priority determining unit, a generative AI response unit, an escalation unit, a knowledge base management unit, and a trend learning unit, wherein the inquiry receiving unit receives a customer inquiry from outside in real time; the priority determining unit analyzes the received content of the inquiry by an analysis technology such as natural language processing and automatically determines a priority based on urgency and importance of the content; the generative AI response unit automatically generates an optimal response text using generative AI while referring to the content of the inquiry and information of the knowledge base; the escalation unit automatically escalates the content of the inquiry to a human operator only when a reliability of a response by the generative AI response unit is less than a predetermined threshold; the knowledge base management unit updates the knowledge base as needed by integrating the content of the inquiry, a response history, and further new information from the outside; and the trend learning unit analyzes an appearance frequency and a trend of the content of the inquiry in real time and automatically reflects a new trouble and a customer need in the knowledge base, thereby consistently, autonomously, and efficiently executing processes from reception of an inquiry to a response, escalation when necessary, and expansion of the knowledge base, and simultaneously realizing equalization of the quality of customer handling, shortening of response time, reduction of work burden, reduction of support costs, and improvement of customer satisfaction.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

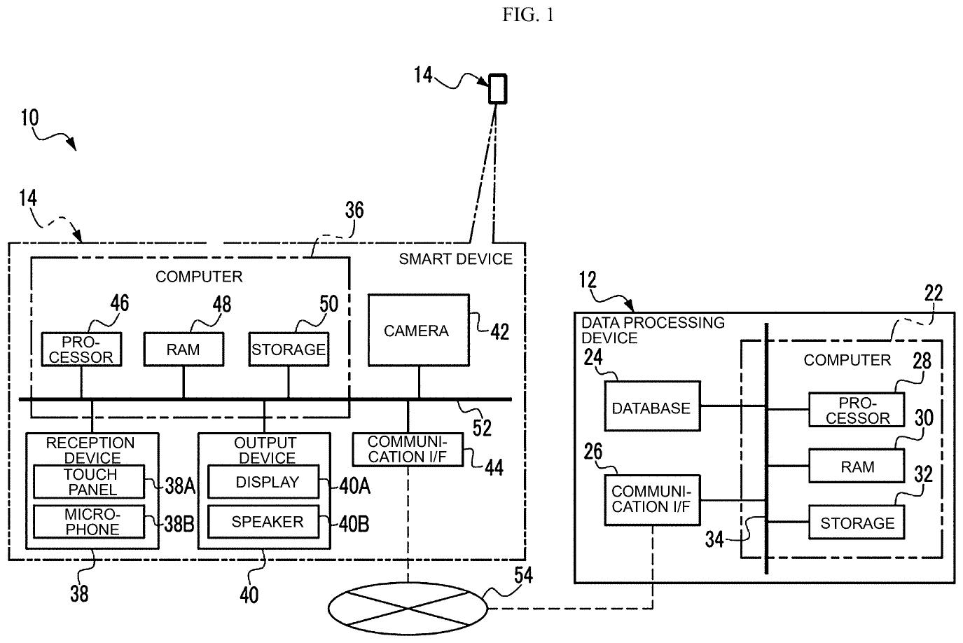

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

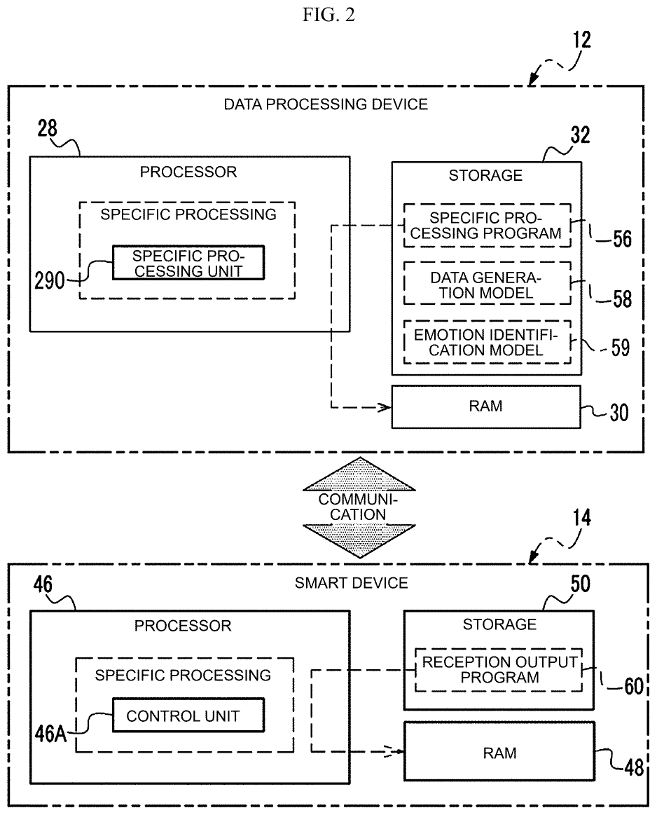

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying out the Present Invention

Embodiments of the present invention will be described more specifically and in detail. The customer support system of the present invention is composed of a server and a terminal, functions of each unit are mainly implemented on the server side, and the terminal side functions as a user interface. Hereinafter, descriptions will be given with depth from all viewpoints, such as the configuration and function of each unit, a utilization method of generative AI, role sharing between the server and the terminal, an operation example, system expandability, security, operation management, response to abnormality, personalization, external cooperation, data protection, management of learning data, and customization for each industry. Specifically, the present system includes a distributed processing cluster composed of a plurality of computing nodes. The computing node is equipped with a plurality of dedicated parallel computing processors for hosting a large language model. The present system adopts a microservice architecture that asynchronously processes a request from the terminal. The architecture executes each functional module as an independent container. Resources are dynamically allocated to the container group by an orchestration tool. The present system thereby prevents a processing delay even under a high load. The present system dramatically improves a response speed in a specific application field of customer support. The present system completely eliminates a manual routing operation by a human operator. The present system thereby significantly reduces an operation cost of a support business. The present system maps an input natural language text to a high-dimensional vector space. The present system quantifies semantic similarity by an operation between vectors. The present system executes an unconventional method fundamentally different from a rule-based process depending on a conventional keyword match. The present system thereby extracts an intention with high accuracy even for a notation fluctuation or an ambiguous expression. The present system autonomously determines an optimal processing flow based on the extracted intention. The present system passes structured data to each subsequent processing unit. The present system thereby dramatically improves processing efficiency of the entire system.

First, the inquiry receiving unit receives a customer inquiry from a customer through a user interface on the terminal side, and transmits the content to the server side. The terminal can be realized by various devices such as a web browser, a smartphone application, a chat application, a call center terminal, a kiosk terminal, and further a smart speaker having a voice recognition function. For example, when the customer inputs “I want to know the delivery status of the product” on a chat screen of the smartphone application, or speaks “Tell me the estimated arrival date of the product I just ordered” by voice, the terminal side acquires text or voice data, performs voice recognition or multilingual translation as necessary, and transmits inquiry data to the server. The terminal side provides various interfaces such as an inquiry input form, a chat window, a voice input button, and an FAQ search screen, and is designed so that the customer can intuitively make an inquiry. Specifically, the present inquiry receiving unit executes initial data processing by utilizing hardware resources on the terminal side. The present terminal acquires a physical analog signal through a built-in microphone or camera. The present terminal converts the acquired analog signal into digital data. For example, when receiving voice data, the present terminal converts the voice data into frequency domain data using a fast Fourier transform. The present terminal processes the converted data into a feature vector called a mel-frequency cepstral coefficient. The present terminal inputs this feature vector to a neural network for voice recognition. The present neural network outputs a probability distribution of phonemes from the input feature vector. The present neural network outputs a high probability score of 0.95 for a phoneme “a”, for example. The present terminal generates the most probable text character string based on this probability distribution. When acquiring text data, the present terminal divides the text into units of words or subwords using a natural language processing library. The present terminal executes a tokenization process of converting each divided unit into an integer identifier. The present terminal generates tokenized one-dimensional array data. The present terminal transmits the generated data to the server using a secure communication protocol. The present server uses the received data as an input to a subsequent natural language processing model. The present processing unit thereby distributes a calculation load on the server side to the terminal side. The present processing unit realizes a high-speed response while suppressing consumption of a communication band. The present processing unit significantly reduces a waiting time of the customer in a use case such as a call center or an online help desk.

The inquiry receiving unit on the server side records the inquiry data received from the terminal together with a time, a customer ID, a terminal type, and an inquiry channel (web, application, telephone, SNS, etc.), and simultaneously executes duplication or spam determination of the inquiry, customer authentication, collation of an inquiry history, and the like. For example, when there are a plurality of inquiries from the same customer in a short time, the contents are automatically integrated to prevent duplicate handling. Furthermore, when the content of the inquiry is unclear or an input error is suspected, the generative AI automatically generates a re-input request message such as “Please enter the details of your question in a little more detail” and returns it to the terminal side. Specifically, the inquiry receiving unit on the present server side converts the received unstructured data into structured data. The present receiving unit inputs the received array of text tokens to a classification model for spam determination. The present classification model is composed of a multilayer perceptron or a convolutional neural network. The present classification model extracts a feature from the input token array, and outputs a continuous value score between 0.0 and 1.0 indicating a probability of being spam. The present classification model outputs a score of 0.85 as the spam probability, for example. When this score exceeds a predetermined threshold, the present receiving unit discards the corresponding data or moves it to an isolation area. When the score is equal to or less than the threshold, the present receiving unit continues the process as a legitimate inquiry. Next, the present receiving unit evaluates the clarity of the inquiry content. The present receiving unit converts the text into a multidimensional embedding vector using an encoder portion of a large language model. The present receiving unit calculates an information entropy of this embedding vector. When the entropy is equal to or greater than a certain value, the present receiving unit determines that the content is ambiguous. Based on this determination result, the present receiving unit activates a module that generates a re-input request. The present module identifies missing information and generates a specific question for the customer. The present processing unit thereby prevents an error in a subsequent response generation process. The present processing unit eliminates waste of calculation resources due to invalid data. The present processing unit improves processing efficiency and response accuracy of the entire system. The present processing unit eliminates the need for a human confirmation operation for an incomplete inquiry in customer support of an e-commerce site or the like.

The priority determining unit is implemented on the server side, and analyzes the content of the received inquiry using natural language processing technology and generative AI. In order to determine urgency and importance from the inquiry text, the generative AI performs keyword extraction such as “emergency”, “urgent”, “stopped”, “error”, “payment delay”, and “personal information leak”, for example, and context understanding. The generative AI has learned past inquiry data and industry-specific prioritization rules, and automatically assigns a priority such that, for example, an inquiry “service has stopped” is given the highest priority, “reissue of invoice” is given a medium priority, and “I want you to tell me how to operate” is given a normal priority. Even when a plurality of inquiries occur simultaneously, the generative AI compares the contents of the respective inquiries and manages a task queue so as to process them in order from the one having a high priority. For example, when a disaster occurs or a large-scale failure occurs, the generative AI can automatically assign a “disaster-related” or “failure-related” inquiry to the highest priority, and postpone the processing order of a normal inquiry. Specifically, the present priority determining unit executes a transformer-based neural network equipped with a self-attention mechanism. The present determining unit inputs a token array of the inquiry text to a model. The present model calculates a dependency relationship between respective tokens, and generates a high-dimensional feature vector considering a context. The present model inputs this feature vector to a fully connected layer. The present model applies a softmax function in an output layer. The present model outputs a probability distribution belonging to each priority class such as “highest priority”, “high”, “medium”, and “low”. The present model outputs a probability score of 0.92 for the “highest priority” class, for example. The present determining unit determines a class having the maximum score in this probability distribution as a final priority. The present determining unit outputs label data indicating the determined priority to a task management module. The present task management module dynamically rearranges a priority queue on a memory based on this label data. The present module moves a task having a high priority to the head of the queue. When allocating tasks to a plurality of computing nodes, the present module dispatches processes in order from the head of the queue. The present processing unit thereby physically shortens a response time of the system to a highly urgent trouble. The present processing unit executes unconventional scheduling different from conventional first-in first-out queue management. The present processing unit prevents expansion of damage in a time-critical use case such as a large-scale communication failure or a payment error in a financial system. The present processing unit completely replaces a process in which a human administrator manually determines a priority, and improves task execution efficiency of the computer system itself.

The generative AI response unit is implemented on the server side, and automatically generates an optimal response text using the generative AI while referring to the knowledge base for the content of the inquiry. For example, in response to an inquiry “I forgot my password”, a response including a specific procedure such as “You can reset your password from the setting screen. We will send you the detailed procedure.” is generated. The generative AI integrally refers to FAQs and manuals registered in the knowledge base, a past response history, and further the latest troubleshooting information, and automatically generates the most appropriate expression and explanation for each inquiry. For example, even for an ambiguous inquiry “I want to know about a new function”, the generative AI can refer to the customer's account information and usage history, and generate a personalized response such as “In the plan you are using, you can use the XX function added last month”. Furthermore, the generative AI can also support multiple languages, and for example, automatically translates an inquiry in a foreign language and generates a response in an appropriate language. Even when the content of the inquiry is complex or includes a plurality of questions, the generative AI can divide the inquiry for each question, individually generate a response, and integrate them to reply. Specifically, the present generative AI response unit adopts an advanced architecture called retrieval-augmented generation. The present response unit first inputs the input inquiry text to an encoder model, and generates a 768-dimensional dense vector, for example. The present response unit executes an approximate nearest neighbor search on a vector database using this dense vector. The present database similarly vectorizes and stores text chunks of past FAQs and manuals. The present response unit calculates a cosine similarity, and extracts a plurality of text chunks having higher similarity scores. The present response unit combines the extracted text chunks and the original inquiry text to construct a new prompt character string. The present response unit tokenizes this prompt character string and inputs it to a large language model dedicated to a decoder. The present language model analyzes a context of the input token string, and predicts a token having the highest probability of appearing next. The present language model outputs a probability distribution of the entire vocabulary set. The present response unit selects the next token from this probability distribution using top-P sampling or temperature parameter control. The present response unit autoregressively repeats this process of prediction and selection to generate a complete response text. The present response unit sequentially generates tokens such as “password”, “reset”, and “procedure”, for example, and finally constructs a natural sentence. The present processing unit stores the generated text data in an output buffer for transmission to the terminal side. The present processing unit thereby strongly suppresses occurrence of hallucination not based on facts. The present processing unit always generates an accurate response reflecting the latest knowledge base. The present processing unit realizes highly accurate information provision personalized for each customer at a support desk of a manufacturing industry having a wide variety of product lineups, or the like.

The escalation unit is implemented on the server side, and determines a reliability of the response generated by the generative AI response unit. The generative AI comprehensively evaluates a matching degree with the knowledge base, a past response record, complexity of the inquiry content, and customer attributes (VIP customer, corporate customer, general customer, etc.), and when determining that “this inquiry has no corresponding information in the knowledge base, and uncertainty is high in AI inference”, for example, automatically generates a message such as “We will connect you to a person in charge”, and automatically transfers the inquiry content to a human operator. For example, in the case of an unprecedented serious trouble such as “services are stopped company-wide due to a system failure”, or in a case requiring personal information or judgment such as “individual consultation on contract details”, the generative AI automatically executes escalation. At the time of escalation, the inquiry content, customer information, a provisional response generated by the AI, a past response history, and the like are collectively transferred to an operator terminal so that the operator can quickly respond. Furthermore, the response content after escalation is also recorded in the knowledge base, and is utilized for future AI learning. Specifically, the present escalation unit acquires a prediction probability of each token output in a process in which the generative AI generates a response. The present escalation unit calculates a log likelihood of this prediction probability, and calculates a reliability score of the entire generated sentence. The present escalation unit further calculates a semantic similarity between the extracted text chunk of the knowledge base and the generated response using another encoder model. The present escalation unit integrates this similarity score and the aforementioned reliability score to determine a final evaluation value. When this evaluation value falls below a predetermined threshold, the present escalation unit executes a branch process of stopping the automatic response by the AI. In this case, the present escalation unit packages text data of the inquiry, a profile vector of the customer, and tensor data of an intermediate state generated by the AI. The present escalation unit transfers this packaged data to a management terminal used by a human operator via a network. At the same time, the present escalation unit transmits a control signal for displaying a warning flag on a screen of the operator. The present processing unit thereby physically blocks a risk that inaccurate information is provided to the customer. The present processing unit provides a mechanism in which the system itself autonomously detects an inference limit of the AI. The present processing unit is extremely important in a use case requiring high accuracy, such as a complex contract change procedure in a financial institution or an individual symptom consultation in a medical institution. By filtering only an exceptional case requiring human judgment, the present processing unit optimizes a business load on the operator and improves reliability of the entire system.

The knowledge base management unit is implemented on the server side, and updates the knowledge base as needed by integrating the content of the inquiry, a response history, and new information from the outside. For example, when an administrator adds new service content, or when a handling method accompanying a legal revision is changed, new information can be registered in the knowledge base from an administrator terminal. In addition, a response automatically generated by the generative AI and a frequent inquiry detected by the trend learning unit are also automatically added to the knowledge base. For example, when “inquiries regarding a specific error code are rapidly increasing recently”, the trend learning unit detects the trend, and the knowledge base management unit automatically registers a solution to the corresponding error. The knowledge base is constructed including information from FAQs, manuals, troubleshooting guides, laws and regulations, industry news, and external information sources (SNS, bulletin boards, news sites, etc.). The knowledge base is designed to be efficiently searchable by a hierarchical structure or tagging, and the generative AI extracts, summarizes, and reconstructs optimal information according to the content of the inquiry to generate a response text. Specifically, the present knowledge base management unit executes a data pipeline that continuously processes unstructured text data collected from various information sources. The present management unit divides an input long document into short text chunks having semantic cohesion. In this division process, the present management unit automatically recognizes a sentence boundary or a paragraph break using a natural language processing library. The present management unit inputs each divided text chunk to an embedding model. The present embedding model outputs a high-dimensional floating-point vector reflecting semantics of the text. The present management unit arranges this vector data in a high-dimensional vector space, and constructs an index using a hierarchical navigable small world algorithm. The present management unit holds this index structure on a memory to enable a high-speed similarity search. Every time new information is added, the present management unit calculates a vector of a corresponding text chunk and dynamically updates the index. The present management unit further periodically executes a garbage collection process of deleting a vector corresponding to old information or invalid information from the index. The present processing unit thereby always maintains a search speed and accuracy of the knowledge base in an optimal state. The present processing unit realizes a flexible information search based on semantic similarity, which cannot be realized by a conventional keyword-based relational database. The present processing unit makes it possible to immediately reflect the latest technical information in a response generation process in a support department of a software development company where product specifications are frequently changed, or the like.

The trend learning unit is implemented on the server side, and analyzes an appearance frequency and a trend of the content of the inquiry in real time. The generative AI analyzes a past inquiry history in chronological order, and automatically detects a trend such as “inquiries regarding payment errors have increased to three times the normal level this week” or “questions regarding operation methods are concentrated after the release of a new function”, for example. The detected trend information is transmitted to the knowledge base management unit, and a new FAQ or troubleshooting guide is automatically generated and registered as necessary. For example, the generative AI can automatically collect related information from external information sources such as SNS and bulletin boards, and utilize it for expanding the knowledge base. Furthermore, the trend learning unit also analyzes an inquiry trend according to a seasonal variation, a campaign period, and a social event (disaster, legal revision, epidemic, etc.), and automatically optimizes the content of the knowledge base and a response policy of the AI. Specifically, the present trend learning unit executes a neural network model specialized for time-series data analysis. The present learning unit vectorizes text data of inquiries received within a certain past period, and generates a multidimensional tensor arranged along a time axis. The present learning unit inputs this tensor to a long short-term memory network or a one-dimensional convolutional neural network. The present network learns a temporal dependency and periodicity, and predicts a future transition of the number of inquiries regarding a specific topic. The present network outputs a numerical vector indicating the predicted number of cases for each topic. The present learning unit calculates an error between this predicted value and an actual observed value, and applies an anomaly detection algorithm. When the error exceeds a statistical allowable range, the present learning unit determines that a sudden trend has occurred. Based on this determination result, the present learning unit extracts a representative keyword group of a rapidly increasing topic. The present learning unit generates alert data including this keyword group, and transmits it to the knowledge base management unit or a dashboard of an administrator. The present processing unit thereby allows the system itself to detect a sign of a problem before a human notices it. The present processing unit exerts a tremendous effect in a use case of early discovering a rapid increase in inquiries immediately after a large-scale promotional activity, a chain of complaints due to a potential defect of a product, or the like. The present processing unit enables proactive system operation based on prediction rather than reactive handling, and prevents depletion of support resources.

The terminal side is realized by various devices such as a web browser, a smartphone application, a chat application, a call center terminal, a kiosk terminal, and a smart speaker used by a customer, and provides various functions such as inquiry input, display of an automatic response by AI, a chat screen with a person in charge at the time of escalation, FAQ search, voice guidance, push notification, file attachment, and inquiry by image recognition (for example, transmitting a photograph of a product to identify a defective part). For example, when the customer inputs “I want to change the payment method” in a chat window, the generative AI generates a response on the server side, and immediately displays a response such as “You can change the payment method from My Page. The procedure is here.” on the terminal side. Furthermore, when escalation occurs, the terminal side automatically switches to a chat screen with the person in charge, and the customer and the person in charge can directly communicate with each other. Voice input and multilingual support are also supported on the terminal side. For example, when a foreign customer makes an inquiry in English, the terminal side automatically translates it, the server side converts it into Japanese and the AI processes it, and a response can also be returned in English. Specifically, the present terminal side not only provides a user interface but also functions as an advanced edge computing node. The present terminal acquires image data captured by a built-in camera, and converts it into a multidimensional tensor having three channels of RGB. The present terminal normalizes this image tensor, and inputs it to a lightweight convolutional neural network deployed in the terminal. The present network extracts a feature map of an object in the image, and outputs coordinate data of a bounding box indicating a defective part and a class probability of the object. The present terminal outputs a probability score of 0.88 for a class “screen crack”, for example. The present terminal transmits this analysis result to the server together with text data. The present terminal also establishes an always-connected communication session using a WebSocket with the server. The present terminal receives response data push-delivered from the server in real time through this session. The present terminal immediately renders the received text data on a chat interface on a screen. When receiving a control flag indicating that escalation has occurred, the present terminal automatically changes a layout of the screen and switches to a direct communication mode with a human operator. The present processing unit thereby reduces an image processing load on the server side, and saves a network band of the entire system. The present processing unit dramatically reduces an input burden on the customer and shortens a time until problem resolution in a use case where visual information is indispensable, such as failure diagnosis of a home appliance or accident response of an automobile.

In terms of security, all inquiry data and customer information are exchanged between the server and the terminal by encrypted communication, and access authority management, log audit, personal information protection, data masking, anonymization processing, and the like are executed on the server side. For example, the content of the inquiry including personal information can be automatically masked by the AI and transferred to a person in charge. Furthermore, all learning data of the AI and update histories of the knowledge base are also recorded as audit logs to prevent unauthorized access and information leakage. Specifically, the present security management unit executes strict encryption and anonymization processing on all data flowing in the system. In communication between the terminal and the server, the present management unit uses a transport layer security protocol and encrypts a packet by an AES 256-bit encryption algorithm. The present management unit inputs text data received on the server side to a named entity recognition model. The present model is based on a transformer architecture, and outputs a class label of an entity for each token of the input text. The present model outputs labels such as “person's name”, “telephone number”, and “credit card number”, and their certainty scores, for example. The present management unit identifies a token whose certainty score exceeds a threshold, and physically replaces the character string with a masking character such as an asterisk. The present management unit passes only safe text data after this masking process is completed to a subsequent generative AI model or log recording module. Furthermore, every time an access request to a database occurs, the present management unit evaluates an access control list that collates a process ID of a request source and an authority level. The present processing unit thereby fundamentally eliminates a risk that personal information is mixed into the learning data of the AI. The present processing unit enables system operation completely complying with compliance in an industry to which strict data protection regulations are applied, such as a financial institution or a medical institution. The present processing unit provides an automated information protection mechanism that does not depend on human visual confirmation, and reduces an occurrence probability of a security incident to the utmost limit.

In terms of operation management, it is possible to centrally manage confirmation of the content of the knowledge base, monitoring of response accuracy of the AI, browsing of trend analysis results, confirmation of an escalation history, monitoring of a system operation status, alert notification at the time of failure occurrence, and the like from an administrator terminal. For example, when the response accuracy of the AI falls below a certain standard, the administrator can be automatically notified to prompt a review of the knowledge base and retraining of the AI model. Specifically, this operation management unit provides an observability platform that continuously monitors the performance of the entire system and the inference accuracy of the AI model. This management unit collects the response text output by the generative AI response unit and a feedback signal from the customer. This management unit inputs this data into an evaluation model and calculates a reward score indicating the validity of the response. This management unit calculates a moving average of this reward score and holds it in a memory as a time-series trend graph. When this moving average value falls below a preset baseline, this management unit generates a drift detection alert indicating performance degradation of the model. Triggered by this alert, this management unit automatically activates a fine-tuning pipeline using a new learning data set. At the same time, this management unit collects hardware metrics such as a CPU usage rate, a GPU memory consumption amount, and a network latency of each computation node in units of milliseconds. This management unit stores this metric data in a time-series database and visualizes it on an administrator's dashboard. Thereby, this processing unit quantitatively evaluates the health of the system and prevents performance degradation in advance. In the operation of a large-scale call center or the like, this processing unit assists the administrator in intuitively grasping the state of the system and making a quick decision based on data. This processing unit automates a continuous improvement cycle of the AI model and maintains high response quality even in long-term operation.

As a response to an abnormality, when a server failure or a network failure occurs, a mechanism can be implemented in which an automatic response such as “The system is currently congested. Please wait a moment.” is displayed on the terminal side, the inquiry data is temporarily stored on the terminal side, and the data is retransmitted to the server after recovery. Specifically, this abnormality response unit executes an autonomous failover mechanism for enhancing fault tolerance in a distributed system. The application on this terminal side periodically transmits a heartbeat signal to the server. When this application cannot receive a response confirmation from the server within a certain period of time, it determines that a network failure or a server down has occurred. Based on this determination, this application switches the user interface to an offline mode. This application temporarily writes the inquiry data input by the customer into a local database in the terminal. At this time, this application assigns a time stamp and a unique transaction ID to the data. This application repeats a reconnection attempt using an exponential backoff algorithm as a background process. When this application detects that communication with the server has been restored, it reads untransmitted data from the local database and collectively transmits it to the server. This server side confirms this transaction ID and executes an idempotent process that prevents duplicate registration of data. Thereby, this processing unit reliably protects the customer's input data even during a temporary communication disconnection. This processing unit provides a seamless user experience in use cases such as access from a moving smartphone or use from an area with an unstable communication environment. This processing unit improves the availability of the entire system and completely guarantees data consistency after failure recovery.

As a personalization function, the generative AI refers to customer attributes (age, gender, region, contract plan, past inquiry history, purchasing history, etc.), and can, for example, generate a response with easy-to-understand expressions and a large character size for elderly people, automatically guide a corporate customer to contact information of a sales representative in charge, or preferentially escalate to a VIP customer. Specifically, this personalization function executes a dynamic context injection process for realizing information provision optimized for each customer. This system accesses a customer relationship management database using a customer ID as a key, and acquires a multidimensional profile vector including attribute data and a past behavior history of the corresponding customer. This system passes this profile vector to a prompt construction module of the generative AI. This module combines the inquiry text and the profile vector to generate a conditioned input tensor. This system inputs this input tensor into a large language model. This language model dynamically adjusts the style of the output text and the selection of vocabulary based on the profile information. For example, when a profile of an elderly person is input, this language model changes attention weights so as to avoid technical terms and increase the output probability of plain words. When a profile of a corporate customer is input, this language model inserts a specific text block including the contact information of the sales representative in charge into the generation result. Thereby, this processing unit realizes not a uniform automatic response but a detailed response that is close to the situation of each individual customer. This processing unit provides extremely high value in use cases where customer satisfaction is directly linked to business, such as customer support for luxury brands and personal banking counters. This processing unit reproduces a personalized response performed by a human operator while referring to a manual, at high speed and accurately by computer calculation.

As external cooperation, API cooperation is performed with a payment system, an inventory management system, a delivery management system, a customer management system, an SNS, an external FAQ database, and the like, and the generative AI refers to external data in real time to generate a response. For example, in response to an inquiry “I want to know the delivery status of the product”, the latest delivery status can be acquired from the delivery management system, and a dynamic response such as “Your product has been shipped today and is scheduled to arrive tomorrow” can be generated. Specifically, this external cooperation unit provides an agent function for the generative AI to autonomously communicate with an external system. This system causes a large language model to read specifications of available external APIs in advance as structured data. When this language model analyzes the inquiry text and infers that external data is necessary to generate a response, it outputs a function execution command for calling a specific API. For example, when it is necessary to confirm the delivery status, this language model outputs data in a JSON format including an API endpoint of the delivery management system and a tracking number as an argument. This external cooperation unit parses this JSON data, generates an actual HTTP request, and transmits it to the external system. This external cooperation unit receives response data returned from the external system, converts it into a text format, and inputs it into the language model again. This language model incorporates this latest dynamic data into the context and generates a final response text. Thereby, this processing unit solves the fundamental problem that the knowledge of the AI is fixed at the time of learning. This processing unit provides an accurate and practical response in all use cases requiring real-time performance, such as confirmation of an inventory status, inquiry of a ticket reservation status, and confirmation of a financial account balance. This processing unit seamlessly integrates a plurality of independent systems via the AI, and realizes complete automation of business processes.

As data protection and learning data management, inquiry data and response data used for learning of the AI are subjected to anonymization and aggregation processing in compliance with the Personal Information Protection Law and industry guidelines, and deletion and correction of the learning data are also possible as necessary. For example, when there is a deletion request from a customer, the corresponding data is promptly excluded from the learning data set. Specifically, this data protection and learning data management unit executes advanced arithmetic processing for ensuring data privacy in the life cycle of a machine learning model. When receiving a specific data deletion request from a customer, this management unit completely erases a physical record on a storage in which the corresponding data is stored. Furthermore, when the data has already been used for learning of a neural network, this management unit activates a special algorithm called machine unlearning. This algorithm mathematically estimates the influence that the data point to be deleted has given to the weight parameters of the model. This algorithm performs a process corresponding to an inverse operation of a gradient descent method, and updates a weight matrix so as to selectively forget only the memory related to the corresponding data. By this process, this management unit creates a state completely compliant with privacy regulations while avoiding an enormous calculation cost of retraining the entire model from scratch. This management unit executes a test using a verification data set on the updated model, and confirms that other general knowledge is not impaired. Thereby, this processing unit technically guarantees the right to be forgotten stipulated in the General Data Protection Regulation in Europe and the like. This processing unit enables continuous performance improvement of the AI while eliminating legal risks in healthcare services and financial services that handle a large amount of personal information.

As customization for each industry, for example, in order to respond to inquiry content, business flows, laws and regulations, and technical terms peculiar to each industry such as a telecommunications industry, a retail industry, a service industry, a financial industry, a medical industry, and an educational industry, the learning model and the knowledge base of the generative AI are optimized for each industry. For example, in the medical industry, in response to inquiries such as “medical appointment”, “confirmation of test results”, and “side effects of medicine”, a response compliant with the Medical Care Act and personal information protection regulations is generated, and escalation to a doctor or a pharmacist is also automated as necessary. Specifically, this customization function for each industry executes a parameter-efficient fine-tuning process for specializing a general-purpose large language model to a specific domain. This system freezes main weight parameters of a pre-trained huge neural network to make them un-updatable. This system additionally inserts a small learnable parameter using low-rank matrix factorization inside each transformer layer. This system learns only this added low-rank matrix by a gradient descent method using a dedicated corpus including technical terms peculiar to the industry such as the medical industry and the financial industry, guidelines of laws and regulations, and a past response history. By this method, this system achieves extremely high inference accuracy in an industry-specific task while dramatically reducing calculation resources and memory consumption. For example, in a model of a medical domain, this system outputs a probability distribution of a related disease name from an input text of a symptom with high accuracy. This system executes a routing process of automatically transmitting an alert to a doctor's terminal according to the degree of urgency of the output disease. Thereby, this processing unit quickly constructs a dedicated AI assistant completely adapted to complex business requirements of each industry. This processing unit automates advanced support business requiring specialized knowledge, and enables expert resources to be concentrated on more important tasks.

As described above, the embodiment of the present invention, as a server-terminal cooperation type customer support system with generative AI as a core, consistently, autonomously, and efficiently executes from inquiry reception to response generation, escalation, knowledge base expansion, trend analysis, personalization, external cooperation, security, operation management, abnormality response, data protection, and industry customization, and simultaneously realizes equalization of the quality of customer handling, reduction of response time, reduction of business burden, reduction of support cost, improvement of customer satisfaction, legal compliance, and expandability, flexibility, and safety of the system. Specifically, the system according to the present embodiment is realized by an advanced distributed computing architecture in which a plurality of independent computation modules operate asynchronously and in parallel. This system pipeline-processes a series of complex tasks such as vectorization of input data, classification of intention, calling of an external API, generation of text, and evaluation of reliability on a parallel computation cluster using a GPU. By this pipeline processing, this system realizes extremely high throughput and low latency that cannot be achieved by a single processor. By deeply integrating natural language processing technology and machine learning algorithms, this system fundamentally solves technical problems such as lack of flexibility and increase in maintenance cost that conventional rule-based systems have had. This system absorbs ambiguity of input data by probabilistic inference, and always autonomously selects an optimal output path. Thereby, in a specific application field of customer support, this system provides a non-conventional processing method that not only imitates a human cognitive process but also multiplies high-speed data search and parallel processing capability unique to a computer. As a result, this system fundamentally redefines a communication interface between a company and a customer, and exhibits a clear technical effect of dramatically improving the accuracy and efficiency of information transmission.

### System Configuration

The system according to the present embodiment comprises an inquiry receiving unit, a priority determining unit, a generative AI response unit, an escalation unit, a knowledge base management unit, a trend learning unit, a user interface unit, an external cooperation unit, a security management unit, and an operation management unit. The inquiry receiving unit receives an inquiry from various devices such as a web browser, a smartphone application, a chat application, a call center terminal, a kiosk terminal, and a voice recognition terminal, and receives an inquiry in various data formats such as text, voice, and image, for example, when a customer inputs “I want to know the delivery status of the product” on a chat screen, speaks “Tell me the estimated arrival date of the product I just ordered” by voice, or transmits a photograph saying “I want you to see the defective part of this product” using an image attachment function, performs preprocessing such as voice recognition, image recognition, and language translation as necessary, and transmits the inquiry data to the server side. Furthermore, the inquiry receiving unit assigns an inquiry reception time, a customer ID, a terminal type, and an inquiry channel (web, application, telephone, SNS, etc.), and simultaneously executes collation of an inquiry history, deduplication, spam determination, customer authentication, and the like. For example, when there are a plurality of inquiries from the same customer in a short time, the contents are automatically integrated, and when there is an input mistake or an unclear inquiry, a re-input request message such as “Please fill in the content of your question in a little more detail” is automatically generated and returned to the terminal side. Specifically, each unit constituting this system adopts a cross-modal encoder architecture for integrally processing multimodal data. This inquiry receiving unit inputs input data of different modalities of text, voice, and image into respective dedicated neural networks. This receiving unit inputs the text data into a transformer-based language model, inputs the voice data into a convolutional neural network-based acoustic model, and inputs the image data into a vision transformer. This receiving unit inputs feature vectors output from these respective models into a projection layer for mapping to a common multidimensional latent space. By this projection processing, this receiving unit makes it possible to calculate a semantic relationship between a text such as “a scratch in this photograph” and attached image data in the same vector space, for example. This receiving unit passes this integrated multimodal vector to a subsequent processing unit. At the same time, this receiving unit analyzes meta information of the input data and generates a unique transaction ID using a hash function. This receiving unit searches an in-memory database using this ID, and confirms the presence or absence of a request from the same customer within the past few minutes. When detecting duplication, this receiving unit executes a process of merging vector data of a new request into existing session data. Thereby, this processing unit accurately grasps a complex inquiry across a plurality of channels and media as a single context. This processing unit improves a customer experience in an omnichannel environment, eliminates redundant processing on the server side, and optimizes utilization efficiency of calculation resources.

The priority determining unit analyzes the content of the received inquiry using the generative AI and natural language processing technology, performs keyword extraction such as “emergency”, “urgent”, “stopped”, “error”, “payment delay”, and “personal information leak” and context understanding, for example, and automatically determines urgency and importance of the inquiry. The priority determining unit has learned past inquiry data and industry-specific prioritization rules, and automatically assigns a priority such that, for example, an inquiry “the service has stopped” is given the highest priority, “reissue of an invoice” is given a medium priority, and “I want you to tell me how to operate” is given a normal priority. Furthermore, when a plurality of inquiries occur simultaneously, the contents of the respective inquiries are compared, and a task queue is managed so as to process the inquiries in order from one having a high priority. For example, when a disaster occurs or a large-scale failure occurs, it is also possible to assign a “disaster-related” or “failure-related” inquiry to the highest priority and postpone the processing order of a normal inquiry. In addition, it is also possible to automatically raise the priority for an inquiry from a corporate customer or a VIP customer. Specifically, this priority determining unit executes a multi-class classification algorithm for quantifying a degree of urgency from a context of a natural language. This determining unit inputs an embedding vector of the input text into a multilayer perceptron, and applies a non-linear activation function in each hidden layer to extract a feature. This determining unit applies a softmax function in a final output layer, and outputs an array of probability distributions for four classes of “emergency”, “high”, “medium”, and “low”, for example. In calculating this probability distribution, this determining unit uses a weight parameter pre-trained so as to minimize a cross-entropy error using past incident data. For example, in response to an input “the system is down and business is stopped”, this determining unit assigns an extremely high probability score of 0.98 to the “emergency” class. Based on this score, this determining unit generates a priority label of the task, and transmits it to a task management module corresponding to a scheduler of an operating system. This module receives this label and dynamically rewrites a data structure of a queue in which processes waiting for execution are stored. This module rearranges a pointer of a task having a high priority to the head of the queue, and immediately assigns it to an available computation thread. Thereby, this processing unit optimizes allocation of system resources not by a static rule but by dynamic inference based on the content of the input data. This processing unit provides a technical foundation for minimizing damage in a use case where a processing delay causes a fatal result, such as a report of a mission-critical system failure or a report of a security incident.

The generative AI response unit automatically generates an optimal response text using the generative AI while referring to the knowledge base for the content of the inquiry. For example, in response to an inquiry “I forgot my password”, a response including a specific procedure such as “You can reset your password from the setting screen. We will send you the detailed procedure.” is generated, and in response to an inquiry “I want to know the delivery status of the product”, a dynamic response such as “Your product has been shipped today and is scheduled to arrive tomorrow” is generated. The generative AI response unit integrally refers to FAQs and manuals registered in the knowledge base, a past response history, latest troubleshooting information, and real-time data acquired from an external system, and automatically generates the most appropriate expression and explanation for each inquiry. For example, even for an ambiguous inquiry such as “I want to know about a new function”, a personalized response such as “In the plan you are using, you can use the XX function added last month” can be generated by referring to the customer's account information and usage history. Furthermore, multilingual support is also possible, and for example, even an inquiry in a foreign language is automatically translated, and a response is generated in an appropriate language. When a plurality of questions are included, it is also possible to divide each question, generate a response individually, and integrate and reply. Specific examples of a prompt text used when operating the generative AI response unit include “Generate the most appropriate and easy-to-understand response text in Japanese for the following inquiry content, referring to the knowledge base and considering the customer's attributes and past history. Inquiry content: ‘I forgot my password’”, “Generate a response text including a procedure that the customer can immediately execute for the following inquiry content, referring to the FAQ and the manual, acquiring the latest information from the external system as necessary. Inquiry content: ‘I want to know the delivery status of the product’”, and “Generate a response text for the following inquiry content, referring to the knowledge base, in English if the customer is a foreigner, and in Japanese otherwise. Inquiry content: ‘I want to know about a new function’”. Specifically, the generative AI response unit executes an autoregressive text generation algorithm that calculates a probability of a word appearing next based on the input prompt. The response unit divides a prompt character string into tokens in units of subwords, vectorizes each token, and passes it to an input layer of a large-scale language model. The language model has a structure in which several tens of layers of transformer blocks are stacked, and calculates a complex dependency relationship between tokens by a self-attention mechanism in each block. The language model converts an output vector of a final layer into a logit vector having the same number of dimensions as a vocabulary size, applies a softmax function, and outputs a probability distribution of a next token. From this probability distribution, the response unit adjusts a distribution shape of the probability using a scaling factor called a temperature parameter, and samples the most appropriate token. The response unit adds the sampled token to the end of an input sequence, and repeats a cycle of inputting it to the model again until an end token is output. In this process, the response unit injects real-time data in a JSON format acquired from the external system and a profile vector of the customer into a hidden state of the model as a context. Thereby, the response unit generates not just a general response but a personalized text that perfectly matches the current situation of a specific customer. For example, in response to an inquiry regarding “delivery status”, the response unit converts structured data “status: shipped, scheduled arrival: tomorrow” acquired from an external API into a natural Japanese sentence and outputs it. Thereby, the processing unit completely automates a process in which a human operator collects information across a plurality of systems and manually creates a sentence. The processing unit dramatically improves a processing speed of a support operation, eliminates an artificial input error and an information transmission omission, and equalizes an output quality of the entire system.

The escalation unit determines a reliability of a response generated by the generative AI response unit, comprehensively evaluates a matching degree with the knowledge base, a past response record, a complexity of the content of the inquiry, and an attribute of the customer, and automatically generates a message such as “We will connect you to an operator” and automatically transfers the content of the inquiry to a human operator when determining, for example, that “this inquiry has no corresponding information in the knowledge base, and an uncertainty in an inference of the AI is also high”. For example, in the case of an unprecedented serious trouble such as “services are stopped company-wide due to a system failure”, or in a case where personal information or judgment is required such as “individual consultation on contract details”, the escalation unit automatically executes an escalation. At the time of the escalation, the content of the inquiry, customer information, a provisional response generated by the AI, a past response history, and the like are collectively transferred to an operator terminal so that the operator can quickly respond. Furthermore, the content of the response after the escalation is also recorded in the knowledge base and utilized for future AI learning. Specifically, the escalation unit acquires a generation probability distribution of each token output by the generative AI response unit. The escalation unit calculates a Shannon entropy of the probability distribution. The escalation unit quantifies the calculated entropy value as an uncertainty score. The escalation unit determines whether or not the uncertainty score exceeds a preset threshold. The escalation unit calculates a cosine similarity between a related document group extracted from the knowledge base and the generated response text. The escalation unit determines that a risk of hallucination is high when the cosine similarity is less than a second threshold. The escalation unit executes a subsequent routing process based on the determination result. In the routing process, the escalation unit transfers the inquiry data to a terminal used by a human operator. In the transfer process, the escalation unit combines text data of the inquiry, an attribute vector of the customer, and text data of the provisional response generated by the AI. The escalation unit serializes the combined data and transmits it to the operator terminal. As an input to the AI, the escalation unit receives, for example, a 512-dimensional text embedding vector, a 128-dimensional numerical vector indicating a past purchasing history of the customer, and a flag array indicating a current system status. As a preprocessing of the input data, the escalation unit executes normalization of the text data and removal of stop words. As an output from the AI, the escalation unit outputs, for example, a reliability score in a range of 0.0 to 1.0, a binary label indicating necessity of escalation, and categorical data indicating a transfer destination department. When the output binary label is 1, the escalation unit adds the inquiry data to a queue of the transfer destination department. With this configuration, the system automatically and quantitatively detects an inference limit of the AI. The system prevents an inaccurate response from being provided to the customer. The system has a technical effect of preventing a decrease in customer satisfaction. The system is particularly effective in a use case where high accuracy is required, such as an inquiry regarding a suspicion of unauthorized use in a financial institution or an urgent health consultation in a medical institution. After the completion of the transfer process, the escalation unit acquires a final response text by the operator. The escalation unit stores the final response text in the database as a correct label. The system executes fine-tuning of the generative AI using the correct label. The system updates a weight parameter of the model using a cross-entropy error function. By the learning process, the system improves an autonomous response rate of the AI to a similar inquiry in the future.

The knowledge base management unit updates the knowledge base as needed by integrating the content of the inquiry, a response history, and new information from the outside. For example, when an administrator adds new service content or when a handling method is changed due to a legal revision, new information can be registered in the knowledge base from an administrator terminal. In addition, a response automatically generated by the generative AI and a frequent inquiry detected by the trend learning unit are also automatically added to the knowledge base. For example, when “inquiries regarding a specific error code are rapidly increasing recently”, the trend learning unit detects the trend, and the knowledge base management unit automatically registers a solution to the error. The knowledge base is constructed including information from FAQs, manuals, troubleshooting guides, laws and regulations, industry news, and external information sources (SNS, bulletin boards, news sites, etc.). The knowledge base is designed to be efficiently searchable by a hierarchical structure and tagging, and the generative AI extracts, summarizes, and reconstructs optimal information according to the content of the inquiry to generate a response text. Specifically, the knowledge base management unit controls a high-dimensional vector database constructed in the system. The knowledge base management unit inputs newly acquired text data to a natural language processing model. The natural language processing model is, for example, a large-scale language model based on a transformer architecture. As a preprocessing of the text data, the knowledge base management unit executes deletion of unnecessary symbols and morphological analysis. As an input to the AI, the knowledge base management unit receives, for example, a text character string of a new FAQ, metadata indicating a category of the FAQ, and a timestamp of a creation date and time. As an output from the AI, the knowledge base management unit outputs, for example, a 768-dimensional dense vector, an identification ID of a cluster to which the text belongs, and a floating-point number indicating importance. The knowledge base management unit registers the output dense vector in an index of the vector database. As a subsequent process, the knowledge base management unit executes a distance calculation with an existing vector group using an approximate nearest neighbor search algorithm. The knowledge base management unit determines whether or not overlapping information exists based on a result of the distance calculation. When an overlap exists, the knowledge base management unit moves old information to an archive area. With this configuration, the system manages a huge amount of knowledge data as coordinates in a high-dimensional space. The system enables an advanced search based on semantic similarity, not just a keyword match. The system has a technical effect of dramatically improving search accuracy. The system is extremely useful in a use case where advanced specialized knowledge is required, such as management of a complex troubleshooting manual for a medical device or a search for a frequently revised legal document. The knowledge base management unit receives a new frequent keyword list from the trend learning unit. Based on the keyword list, the knowledge base management unit automatically crawls a related document from an external website. The knowledge base management unit removes noise from the acquired document. The knowledge base management unit divides the document into paragraphs. The knowledge base management unit vectorizes each divided paragraph again and stores it in the database. The system autonomously executes this series of processes without human intervention. The system always maintains a freshness of the knowledge base in the latest state. The system significantly reduces an operation cost.

The trend learning unit analyzes an appearance frequency and a trend of the content of the inquiry in real time, and automatically detects a trend such as “inquiries regarding payment errors have increased to three times the normal level this week” or “questions regarding an operation method are concentrated after a new function release”, for example. The detected trend information is transmitted to the knowledge base management unit, and a new FAQ or troubleshooting guide is automatically generated and registered as necessary. For example, the generative AI can automatically collect related information from an external information source such as an SNS or a bulletin board, and utilize it for expanding the knowledge base. Furthermore, the trend learning unit also analyzes an inquiry trend according to a seasonal variation, a campaign period, and a social event (disaster, legal revision, epidemic, etc.), and automatically optimizes the content of the knowledge base and a response policy of the AI. Specifically, the trend learning unit includes a dedicated arithmetic module that executes time-series data analysis and an unsupervised learning algorithm. The trend learning unit aggregates inquiry data continuously flowing in from the inquiry receiving unit for each certain time window. As an input to the AI, the trend learning unit receives, for example, a time-series array indicating an appearance frequency of a specific keyword in the past 24 hours, a numerical vector indicating an emotion score of each inquiry, and a one-hot vector indicating an attribute category of the customer. The trend learning unit executes a normalization process and calculation of a moving average on the input data. As an output from the AI, the trend learning unit outputs, for example, an anomaly score indicating a degree of deviation from a normal state, a cluster center vector of a rapidly rising topic, and a time-series predicted value for predicting the number of future inquiries. The trend learning unit determines whether or not the output anomaly score exceeds a preset threshold. As a subsequent process, the trend learning unit issues an emergency alert to the operation management unit when the threshold is exceeded. The trend learning unit extracts a representative inquiry text closest to the cluster center vector. The trend learning unit transmits the extracted text to the knowledge base management unit. With this configuration, the system detects a sign of a minute change that is difficult for a human to visually notice at an early stage. The system prevents development into a large-scale failure or a flaming incident. The system has a technical effect of realizing proactive customer support. The system exerts a tremendous effect in a use case where real-time performance is extremely important, such as monitoring of a bug report immediately after an update of a large-scale online game or early discovery of an initial defect at the time of a new product launch, for example. The trend learning unit dynamically groups the inquiry data using a density-based spatial clustering algorithm. The trend learning unit calculates a growth rate of each group. The trend learning unit recognizes a group having a rapid growth rate as a new trend. Based on the recognition result, the system adds a dynamic context to a prompt of the generative AI response unit. The system supports generation of an appropriate response reflecting the latest trend.

The user interface unit is realized by various devices such as a web browser, a smartphone application, a chat application, a call center terminal, a kiosk terminal, and a smart speaker used by a customer, and provides various functions such as inquiry input, display of an automatic response by AI, a chat screen with an operator at the time of escalation, FAQ search, voice guidance, push notification, file attachment, and inquiry by image recognition. For example, when a customer inputs “I want to change my payment method” in a chat window, the generative AI generates a response on the server side, and immediately displays a response such as “You can change your payment method from My Page. The procedure is here.” on the terminal side. Furthermore, when an escalation occurs, the screen automatically switches to a chat screen with an operator on the terminal side, and the customer and the operator can directly communicate. Voice input and multilingual support are also supported on the terminal side, and for example, when a foreign customer makes an inquiry in English, it is automatically translated on the terminal side, converted into Japanese on the server side, processed by the AI, and a response can also be returned in English. Specifically, the user interface unit includes a communication control module that manages asynchronous communication between a client terminal and a server. The user interface unit establishes a persistent bidirectional communication channel using a WebSocket protocol. The user interface unit processes a multimodal input from a customer in real time. As an input to the AI, the user interface unit receives, for example, 16 kHz audio waveform data acquired from a microphone, a 224-pixel square RGB image tensor captured by a camera, and a coordinate array indicating a swipe trajectory from a touch panel. As a preprocessing of the input data, the user interface unit executes noise reduction of audio and normalization of an image. As an output from the AI, the user interface unit outputs, for example, a text character string of a voice recognition result, bounding box coordinates of an object included in an image, and a probability distribution indicating an emotional state of a customer. The user interface unit transfers the output text character string to the inquiry receiving unit. As a subsequent process, the user interface unit inputs a response text received from the server to a speech synthesis engine. The user interface unit reproduces generated audio waveform data from a speaker. With this configuration, the system provides accessibility even to a customer unfamiliar with text input or a visually impaired customer. The system has a technical effect of realizing an intuitive and seamless user experience. The system is extremely effective in a use case where hands-free operation is required, such as a route guidance request by voice from a driving driver or a report of a machine trouble using an image from a factory worker, for example. The user interface unit includes a local cache mechanism for continuing operation even in an environment where a network bandwidth is unstable. The user interface unit temporarily saves input data in a local storage when communication is disconnected. The user interface unit automatically retransmits the data to the server after communication is restored. The system completely prevents data loss.

The external cooperation unit performs API cooperation with a payment system, an inventory management system, a delivery management system, a customer management system, an SNS, an external FAQ database, and the like, and the generative AI generates a response by referring to external data in real time. For example, in response to an inquiry “I want to know the delivery status of the product”, the latest delivery status can be acquired from the delivery management system, and a dynamic response such as “Your product has been shipped today and is scheduled to arrive tomorrow” can be generated. Alternatively, it is also possible to generate a real-time response such as “Currently, it is in stock. You can place an order” in cooperation with the inventory management system. Furthermore, by collecting information from an SNS or a bulletin board, information regarding a trouble or a new function that is a hot topic outside can be automatically reflected in the knowledge base. Specifically, the external cooperation unit includes an API gateway that integrally manages data exchange between a plurality of heterogeneous systems. The external cooperation unit issues an asynchronous HTTP request to a RESTful interface or a GraphQL endpoint provided by each external system. As an input to the AI, the external cooperation unit receives, for example, a character string indicating a session ID of a customer, an alphanumeric string indicating an SKU code of a target product, and a query object in a JSON format specifying a search condition. As a preprocessing of the input data, the external cooperation unit executes provision of an authentication token and encryption of a payload. As an output from the AI, the external cooperation unit outputs, for example, an integer value indicating the number of stocks acquired from an external system, categorical data indicating a delivery status, and a floating-point number array indicating a recommendation score of a related product. The external cooperation unit transfers the output data to the generative AI response unit. As a subsequent process, the external cooperation unit embeds the acquired structured data into a natural language prompt template. With this configuration, the system reflects not only static knowledge base information but also dynamic transaction data that changes momentarily in a response. The system always provides the latest and accurate information to a customer. The system has a technical effect of significantly improving an inquiry resolution rate. The system is indispensable in a use case where freshness of information is directly linked to customer satisfaction, such as real-time inventory confirmation on an e-commerce site or provision of flight delay information in an airline system, for example. The external cooperation unit includes a circuit breaker mechanism that monitors a response delay or a timeout from an external system. When a specific external system goes down, the external cooperation unit immediately switches to access to alternative cache data. The external cooperation unit prevents a cascading failure of the entire system. The system maintains high availability and fault tolerance.

The security management unit executes encrypted communication of inquiry data and customer information, access authority management, log audit, personal information protection, data masking, anonymization processing, and the like. For example, the content of an inquiry including personal information can be automatically masked by the AI and transferred to an operator. Furthermore, learning data of the AI and an update history of the knowledge base are all recorded as an audit log to prevent unauthorized access and information leakage. For example, when there is a deletion request from a customer, corresponding data can be promptly excluded from a learning data set. Specifically, the security management unit includes a dedicated security module that executes advanced encryption and anonymization processing on all data circulating in the system. The security management unit encrypts a communication path using a transport layer security protocol. The security management unit applies an advanced encryption standard algorithm to stored data. As an input to the AI, the security management unit receives, for example, plaintext text data input by a customer, a JSON object including profile information of the customer, and a character string indicating an IP address of an access source. As a preprocessing of the input data, the security management unit executes tokenization of text and normalization of a character code. As an output from the AI, the security management unit outputs, for example, an array of character offsets indicating a position where personal information is included, an entity label indicating a type of detected personal information, and a secure text character string after masking processing. The security management unit transfers the output masked text to the generative AI response unit. As a subsequent process, the security management unit completely deletes the detected personal information from the original text or replaces it with dummy data. With this configuration, the system physically and logically eliminates a risk of confidential information being mixed into learning data of a large-scale language model. The system prevents a data leakage accident. The system has a technical effect of satisfying strict compliance requirements. The system provides an essential function in a use case where the highest level of confidentiality is required, such as an inquiry including electronic medical record information of a patient in a medical institution or a trouble report including a credit card number in a financial institution, for example. The security management unit executes a lightweight neural network model specialized for named entity recognition in a local environment. The security management unit completes detection of personal information without depending on an external API. The security management unit maximizes a security level while minimizing a processing delay.

The operation management unit can centrally manage confirmation of the content of the knowledge base, monitoring of response accuracy of the AI, browsing of a trend analysis result, confirmation of an escalation history, monitoring of a system operation status, alert notification at the time of failure occurrence, and the like from an administrator terminal. For example, when the response accuracy of the AI falls below a certain standard, it is possible to automatically notify an administrator and prompt a review of the knowledge base or relearning of an AI model. Furthermore, when a system failure or a network failure occurs, a mechanism can be implemented in which an automatic response such as “The system is currently congested. Please wait for a while.” is displayed on the terminal side, inquiry data is temporarily saved on the terminal side, and retransmitted to the server after recovery. Specifically, the operation management unit includes an orchestration engine that monitors an operation status of the entire system in real time and controls dynamic allocation of resources. The operation management unit periodically collects a health check signal and performance metrics from each microservice. As an input to the AI, the operation management unit receives, for example, a time-series array of a CPU usage rate in the past one hour, a numerical vector indicating memory consumption, and an integer value indicating the number of requests per unit time. As a preprocessing of the input data, the operation management unit executes removal of an outlier and smoothing of data. As an output from the AI, the operation management unit outputs, for example, a time-series curve indicating a future load prediction, an anomaly score indicating a sign of a system failure, and a recommended number of container instances to be additionally started. Based on the output recommended number, the operation management unit calls an API of a cloud infrastructure as a subsequent process. The operation management unit automatically executes a scale-out process of a computing node. With this configuration, the system autonomously expands resources without human intervention even for a sudden rapid increase in traffic. The system completely prevents service stoppage and response delay. The system has a technical effect of guaranteeing stable service continuity. The system is extremely important in a use case where an unpredictable load fluctuation occurs, such as concentration of access to a website immediately after a television commercial broadcast or a flood of inquiries to an infrastructure company at the time of a large-scale disaster occurrence, for example. The operation management unit accumulates the collected metrics data in a multidimensional database. The operation management unit draws a real-time graph on a dashboard for an administrator. When detecting that the response accuracy of the AI has decreased, the operation management unit automatically starts a relearning pipeline. The system continuously prevents performance degradation of the model.

As described above, the system according to the present embodiment includes the inquiry receiving unit, the priority determining unit, the generative AI response unit, the escalation unit, the knowledge base management unit, the trend learning unit, the user interface unit, the external cooperation unit, the security management unit, and the operation management unit, and by each unit operating in cooperation, it is possible to consistently realize an autonomous and efficient response centered on the generative AI, expansion of the knowledge base, trend analysis, personalization, external cooperation, security, operation management, response at the time of abnormality, data protection, and industry customization for various inquiries from customers. Specific examples of a prompt text to be read by the generative AI include “Generate the most appropriate and easy-to-understand response text in Japanese for the following inquiry content, referring to the knowledge base and considering the customer's attributes and past history. Inquiry content: ‘I forgot my password’”, “Generate a response text including a procedure that the customer can immediately execute for the following inquiry content, referring to the FAQ and the manual, acquiring the latest information from the external system as necessary. Inquiry content: ‘I want to know the delivery status of the product’”, and “Generate a response text for the following inquiry content, referring to the knowledge base, in English if the customer is a foreigner, and in Japanese otherwise. Inquiry content: ‘I want to know about a new function’”. Specifically, the system adopts a microservice architecture in which each functional unit is deployed as an independent container. The system asynchronously executes communication between the respective containers via a message queuing system. As an input to the AI, the system receives, for example, an inquiry text from a customer, a text group of related documents searched from the knowledge base, and vector data indicating a past response history of the customer. As a preprocessing of the input data, the system combines all text data into a single prompt character string and inserts a special token. As an output from the AI, the system outputs, for example, a text character string of a generated response, a citation index of a document that is a basis of the response, and a probability score indicating a certainty factor of the response. The system transmits the output response text to the user interface unit. As a subsequent process, the system starts the escalation unit when the certainty factor score is less than a threshold. With this configuration, unlike a simple rule-based chatbot, the system executes advanced inference based on deep understanding of context and dynamic information synthesis. The system realizes a flexible and accurate response equal to or better than that of a human operator. The system has a technical effect of dramatically improving productivity of a customer support operation. The system provides an optimal solution in a use case where high scalability and expertise are simultaneously required, such as 24/7 multilingual support in a multinational corporation or technical inquiry handling in a manufacturing industry having a complex product lineup, for example. The system utilizes a cluster of tensor processing units in order to speed up an inference process of the generative AI. The system applies quantization and pruning techniques of a model. The system reduces an inference latency to a millisecond unit. The system operates a large-scale language model without impairing a real-time interactive experience.

### Implementation Steps

Step 1: Inquiry Reception When a customer makes an inquiry through various devices such as a web browser, a smartphone application, a chat application, a call center terminal, a kiosk terminal, and a voice recognition terminal, an inquiry receiving unit receives content of the inquiry in a data format such as text, voice, and image, and transmits the content to a server together with additional information such as a reception time, a customer ID, a terminal type, and an inquiry channel. For example, the content of the inquiry is received in various formats, such as when the customer inputs “I want to know the delivery status of the product” on a chat screen, speaks “Tell me the estimated arrival date of the product I just ordered” by voice, or transmits a photograph using an image attachment function saying “I want you to look at the defective part of this product”. When the content of the inquiry is unclear or an input error is suspected, the receiving unit generates a re-input request message such as “Please enter the content of your question in a little more detail” using generative AI, and returns the message to the terminal side. As a specific example of a prompt text to be read by the generative AI, “If the following inquiry content is unclear, generate a polite Japanese message to request the customer to re-input. Inquiry content: “ ” can be cited. Specifically, the inquiry receiving unit includes a data ingestion pipeline that integrally processes multimodal input data. The inquiry receiving unit converts unstructured data flowing in from different channels into a standardized internal format. The inquiry receiving unit receives, as an input to the AI, for example, an image tensor in JPEG format uploaded by the customer, a text character string output from a voice recognition engine, and a floating-point number of latitude and longitude acquired from a GPS sensor of the terminal. The inquiry receiving unit executes resolution conversion of the image, noise removal of the text, and geohash conversion of the coordinate data as preprocessing of the input data. The inquiry receiving unit outputs, as an output from the AI, for example, bounding box coordinates indicating a damaged part in the image, a classification label indicating an intention of the text, and a quality score of the input data. The inquiry receiving unit determines whether or not the output quality score is less than a predetermined threshold. The inquiry receiving unit generates a prompt for a re-input request when the quality score is low, and transmits the prompt to the client terminal as the subsequent process. With this configuration, the system multilaterally grasps the situation faced by the customer including not only text but also visual and spatial information. The system dramatically improves the accuracy of information collection at an initial stage. The system exhibits a technical effect of minimizing errors in subsequent inference processing. The system is extremely effective in use cases where it is difficult to explain the situation only with text, such as analysis of a vehicle damage image in accident reception of automobile insurance and reading of an error screen in failure diagnosis of a home appliance. The inquiry receiving unit temporarily caches the received data in an in-memory database. The inquiry receiving unit synchronizes a plurality of input streams using a session ID as a key. The system completely guarantees data consistency even in a distributed environment.
Step 2: Priority Determination A priority determining unit analyzes the received content of the inquiry using generative AI and natural language processing technology, performs keyword extraction such as “emergency”, “urgent”, “stopped”, “error”, “payment delay”, and “personal information leak” and context understanding, and automatically determines urgency and importance of the inquiry. For example, a priority is assigned such that an inquiry “service has stopped” is given the highest priority, “reissue of invoice” is given a medium priority, and “I want you to tell me how to operate” is given a normal priority. When a plurality of inquiries occur simultaneously, the contents of each inquiry are compared, and a task queue is managed so as to process the inquiries in order from the one having a high priority. As a specific example of a prompt text to be read by the generative AI, “Determine urgency and importance included in the following inquiry content, and output a priority as a numerical value. Inquiry content: ‘Service has stopped’” and the like can be cited. Specifically, the priority determining unit includes an inference engine that executes an advanced text classification algorithm based on natural language processing. The priority determining unit inputs the received text data into a word embedding model and converts it into a high-dimensional semantic vector. The priority determining unit receives, as an input to the AI, for example, a 768-dimensional text embedding vector, a categorical variable indicating a contract rank of the customer, and an integer value indicating the number of past claims. The priority determining unit executes normalization of the vector and combination of feature amounts as preprocessing of the input data. The priority determining unit outputs, as an output from the AI, for example, an urgency score in a range of 0.0 to 1.0, a multi-class label indicating a category of the inquiry, and a floating-point number indicating a negative degree of emotion. The priority determining unit inserts the inquiry data into a priority queue based on the output urgency score. The priority determining unit dynamically sorts elements in the queue in descending order of the score as the subsequent process. With this configuration, the system breaks away from a simple first-in first-out processing order, and realizes optimal resource allocation according to business importance and customer urgency. The system completely prevents a delay in responding to a serious incident. The system exhibits a technical effect of significantly improving an achievement rate of a service level agreement. The system provides an indispensable function in critical use cases where every minute and second counts, such as a report of a server down in a cloud service provider and a contact of loss or theft in a credit card company. The priority determining unit uses an ensemble learning model such as a support vector machine or a gradient boosting decision tree in combination. The priority determining unit integrates an inference result of a large language model and a predicted value of a conventional machine learning model. The system enhances the robustness of the determination to the utmost limit.
Step 3: Automatic Response Generation A generative AI response unit automatically generates an optimal response text using generative AI while referring to a knowledge base for the content of the inquiry. For example, in response to an inquiry “I forgot my password”, a response including a specific procedure such as “You can reset your password from the setting screen. We will send you the detailed procedure.” is generated, and in response to an inquiry “I want to know the delivery status of the product”, a dynamic response such as “Your product has been shipped today and is scheduled to arrive tomorrow” is generated. FAQs and manuals registered in the knowledge base, a past response history, latest troubleshooting information, and real-time data acquired from an external system are integrally referred to, and the most appropriate expression and explanation are automatically generated for each inquiry. As specific examples of a prompt text to be read by the generative AI, “Generate the most appropriate and easy-to-understand response text in Japanese for the following inquiry content by referring to the knowledge base and considering customer attributes and past history. Inquiry content: ‘I forgot my password’” and “Generate a response text including a procedure that the customer can immediately execute for the following inquiry content by referring to FAQs and manuals and acquiring the latest information from an external system as necessary. Inquiry content: ‘I want to know the delivery status of the product’” and the like can be cited. Specifically, the generative AI response unit executes an advanced inference pipeline based on a retrieval-augmented generation architecture. The generative AI response unit executes a similarity search on the vector database using the inquiry text as a query. The generative AI response unit receives, as an input to the AI, for example, text character strings of the top 5 retrieved documents, JSON data indicating the latest transaction history of the customer, and a character string of constraint conditions defined as a system prompt. The generative AI response unit executes truncation and summarization of the text so as to fit within the limit of a context window as preprocessing of the input data. The generative AI response unit outputs, as an output from the AI, for example, a text character string of a response composed of natural language, an ID list of documents referred to in the response, and an array of recommended commands indicating an action to be taken next by the customer. The generative AI response unit transfers the output response text to the reliability determination module. The generative AI response unit generates metadata for rendering the recommended command as a button element on a user interface of the client terminal as the subsequent process. With this configuration, the system suppresses the problem of hallucination inherently possessed by a large language model, and always provides accurate information based on facts. The system seamlessly fuses dynamic external data and a static knowledge base. The system exhibits a technical effect of raising the quality of the response to a human expert level. The system exerts tremendous power in use cases requiring high accuracy and recency, such as generation of a response reflecting the latest legal revision in tax consultation and complex coding support regarding API specifications of software. The generative AI response unit sequentially generates tokens using an autoregressive decoder network. The generative AI response unit searches for an optimal sequence of words using a beam search algorithm. The system constructs fluent and logical sentences at high speed.
Step 4: Reliability Determination and Escalation A reliability of the response generated by the generative AI response unit is determined, and a matching degree with the knowledge base, a past response history, complexity of the content of the inquiry, and customer attributes are comprehensively evaluated. When the reliability is less than a predetermined threshold, an escalation unit automatically generates a message such as “We will connect you to an operator” and automatically transfers the content of the inquiry to a human operator. For example, in the case of an unprecedented serious trouble such as “services are stopped company-wide due to a system failure”, or in a case where personal information or judgment is required such as “individual consultation on contract details”, the escalation unit automatically executes escalation. As a specific example of a prompt text to be read by the generative AI, “Generate a Japanese message recommending escalation to an operator when there is no corresponding information in the knowledge base or when uncertainty in AI inference is high for the following inquiry content. Inquiry content: ‘A system failure has occurred’” and the like can be cited. Specifically, the escalation unit includes a scoring engine that multilaterally evaluates the quality of the response generated by the generative AI response unit. The escalation unit calculates a log likelihood for each token of the generated text. The escalation unit receives, as an input to the AI, for example, a text vector of the generated response, a document vector of the referred knowledge base, and a binary array indicating a past escalation history of the customer. The escalation unit executes inner product calculation between vectors and scaling of feature amounts as preprocessing of the input data. The escalation unit outputs, as an output from the AI, for example, a reliability score from 0 to 100 indicating the accuracy of the response, a category code indicating a reason for escalation, and an identifier indicating an optimal transfer destination operator group. The escalation unit determines whether or not the output reliability score falls below a preset threshold. The escalation unit serializes a session state of the inquiry when the score falls below the threshold as the subsequent process. The escalation unit transmits the serialized data to a routing queue of the designated operator group. With this configuration, the system dynamically and accurately separates an area that can be processed by AI and an area where humans should intervene. The system prevents customer confusion caused by an inappropriate response. The system exhibits a technical effect of optimizing the workload of the operator. The system plays an extremely important role in use cases where human empathy and advanced judgment are indispensable, such as individual consultation on complex payment conditions of life insurance and return negotiation of expensive products. The escalation unit highlights the provisional response generated by the AI and the document that became the basis of the inference when the operator takes over the handling. The system supports the operator's context understanding. The system significantly shortens the handover time.
Step 5: Update and Expansion of Knowledge Base A knowledge base management unit updates a knowledge base as needed by integrating content of the inquiry, a response history, and new information from the outside. When an administrator adds new service content or when a handling method is changed due to a legal revision, new information can be registered in the knowledge base from an administrator terminal. In addition, a response automatically generated by generative AI and a frequent inquiry detected by a trend learning unit are also automatically added to the knowledge base. For example, when “inquiries regarding a specific error code are rapidly increasing recently”, the trend learning unit detects the trend, and the knowledge base management unit automatically registers a solution for the corresponding error. As a specific example of a prompt text to be read by the generative AI, “Analyze an inquiry history of the past week, extract frequently occurring new inquiry content and its response, and list new items to be added to the knowledge base in Japanese” and the like can be cited. Specifically, the knowledge base management unit includes an information extraction pipeline that automatically constructs a structured knowledge graph from unstructured data. The knowledge base management unit inputs text data of a new solution or a response history into a named entity recognition model. The knowledge base management unit receives, as an input to the AI, for example, a text character string of a handling memo input by an operator, an alphanumeric string indicating a model number of a related product, and numerical data indicating a required time until resolution. The knowledge base management unit executes chunking of the text and filtering of stop words as preprocessing of the input data. The knowledge base management unit outputs, as an output from the AI, for example, a list of extracted entities, triple data indicating a relationship between entities, and a summary text to be registered as a new FAQ. The knowledge base management unit inserts the output triple data into the knowledge graph database. The knowledge base management unit inputs the summary text into an embedding model to generate a high-dimensional vector as the subsequent process. The knowledge base management unit adds the vector to an index of a vector search engine. With this configuration, the system automatically accumulates tacit knowledge obtained from daily support operations as explicit knowledge. The system dramatically reduces human costs required for maintenance of the knowledge base. The system exhibits a technical effect of accelerating knowledge sharing throughout the organization. The system is extremely effective in use cases where it is necessary to prevent personalization of knowledge, such as sharing of a workaround for an unknown bug in an IT help desk and digitalization of know-how of a skilled worker at a manufacturing site. The knowledge base management unit periodically executes batch processing for detecting contradictions and duplications in the knowledge base. The knowledge base management unit automatically flags old information and prompts the administrator to review it. The system always keeps the quality of the knowledge base high.
Step 6: Trend Analysis and Automatic Learning A trend learning unit analyzes an appearance frequency and a trend of content of the inquiry in real time, and automatically detects a trend such as “inquiries regarding payment errors have increased to three times the normal level this week” or “questions regarding operation methods are concentrated after the release of a new function”, for example. The detected trend information is transmitted to the knowledge base management unit, and a new FAQ or troubleshooting guide is automatically generated and registered as necessary. As a specific example of a prompt text to be read by the generative AI, “Analyze an inquiry history of the past 30 days in chronological order, and summarize rapidly increasing inquiry content and its background factors in Japanese” and the like can be cited. Specifically, the trend learning unit includes an analysis engine that executes a real-time anomaly detection algorithm for streaming data. The trend learning unit continuously subscribes to inquiry data from a distributed messaging system. The trend learning unit receives, as an input to the AI, for example, an integer value indicating the number of appearances of a specific topic in the latest one hour, a floating-point number indicating a moving average value of the past week, and a semantic vector of the topic. The trend learning unit executes difference calculation of time-series data and calculation of a Z-score as preprocessing of the input data. The trend learning unit outputs, as an output from the AI, for example, a momentum score indicating a degree of rapid rise of the trend, a percentage indicating a probability of occurrence of an anomaly, and a list of related keywords. The trend learning unit determines whether or not the output momentum score exceeds a predetermined warning level. The trend learning unit issues a draft creation command for a new FAQ to the knowledge base management unit when the warning level is exceeded as the subsequent process. With this configuration, the system detects initial symptoms of SNS flaming or a large-scale system failure faster than humans. The system minimizes the spread of damage. The system exhibits a technical effect of dramatically improving crisis management capability. The system is indispensable in use cases where a delay in initial response leads to fatal results, such as early discovery of a wide-area communication failure in a telecommunications carrier and detection of a rapid increase in claims of foreign matter contamination in a food manufacturer. The trend learning unit extracts a hidden topic from the inquiry text using a latent Dirichlet allocation method. The trend learning unit visualizes the transition of each topic as a time-series graph. The system provides valuable insights to the management layer and the marketing department.
Step 7: Response and Notification to Customer A user interface unit immediately displays a response text received from the generative AI response unit or the escalation unit or a reply from an operator on a terminal such as a web browser, a smartphone application, a chat application, a call center terminal, a kiosk terminal, and a voice recognition terminal. For example, a response such as “You can change your payment method from My Page. The procedure is here.” is displayed on a chat window, or when escalation occurs, the screen is automatically switched to a chat screen with the operator. Voice input and multilingual support are also supported, and a response can be returned in English to a foreign customer. Specifically, the user interface unit includes a presentation layer that renders data in an optimal format according to device characteristics on the client side. The user interface unit parses a payload in JSON format received from the server. The user interface unit receives, as an input to the AI, for example, a text character string of the generated response, metadata indicating an emotional tone of the response, and resolution data indicating a screen size of the customer's device. The user interface unit executes HTML escape processing of the text and parsing of markdown as preprocessing of the input data. The user interface unit outputs, as an output from the AI, for example, a CSS style sheet optimized for the client's screen, text with SSML tags for a speech synthesis engine, and parameters of display animation. The user interface unit passes the output data to a browser engine or a drawing module of a native application of the client terminal. The user interface unit asynchronously transmits a read flag indicating that the customer has browsed the response to the server as the subsequent process. With this configuration, the system provides a consistent and high-quality user experience on any device such as a smartphone, a smart speaker, and a kiosk terminal. The system reduces the cognitive load of the customer. The system exhibits a technical effect of improving a self-resolution rate. The system is extremely effective in use cases corresponding to diverse user layers, such as a support screen combining large characters and voice reading for the elderly, and a rich chat UI for the younger generation. The user interface unit cooperates with a real-time translation API for multilingual support. The user interface unit automatically detects a language setting of the customer's browser. The system realizes seamless communication across language barriers.

### Specific Use Case

For example, in a company providing a communication service, when a customer makes an inquiry using a chat function of a smartphone application saying “The Internet suddenly disconnected, I want you to respond urgently”, the inquiry receiving unit receives this text data and transmits it to the server together with additional information such as a reception time, a customer ID, used terminal information, and a channel type. The priority determining unit analyzes keywords such as “urgently” and “disconnected” and context using generative AI, and determines that the degree of urgency is extremely high. As a specific example of a prompt text to be read by the generative AI, “Determine a degree of urgency from the following inquiry content, and explain the reason in Japanese if the degree of urgency is high. Inquiry content: ‘The Internet suddenly disconnected, I want you to respond urgently’” can be cited. Specifically, the inquiry receiving unit activates a dedicated natural language processing pipeline for extracting technical terms peculiar to communication failures and highly urgent expressions. The inquiry receiving unit inputs the received text data into a morphological analyzer and executes part-of-speech decomposition. The inquiry receiving unit receives, as an input to the AI, for example, a text character string including keywords such as “disconnected” and “urgently”, an alphanumeric string indicating a cell ID of a base station acquired from the customer's terminal, and an integer value indicating a communication error code. The inquiry receiving unit executes vectorization of the text and normalization of the error code as preprocessing of the input data. The inquiry receiving unit outputs, as an output from the AI, for example, an urgency score indicated in a range of 0 to 100, polygon coordinate data indicating an area where the failure has occurred, and a classification label indicating a cause category of the failure. The priority determining unit determines that the output urgency score is 90 or more. The priority determining unit inserts the inquiry data at the head of a highest priority processing queue as the subsequent process. With this configuration, the system instantly identifies a truly critical failure report from a huge amount of inquiries. The system discovers a local failure that cannot be detected only by a network monitoring system at an early stage from customer voices. The system exhibits a technical effect of minimizing downtime. The system exerts a tremendous effect in use cases where aggregation of micro events is required, such as identification of a radio wave interference occurring only in a specific apartment and detection of a communication defect depending on a specific smartphone model. The priority determining unit adds a past inquiry history of the customer and importance of a contract plan as a weighting coefficient. The system realizes robust routing that never misses an emergency contact from a VIP customer.

The generative AI response unit refers to “primary handling procedure at the time of communication failure”, “regional failure information”, “customer contract information”, and the like from the knowledge base, and automatically generates a specific and situation-adapted response text such as “Currently, there is a possibility that a communication failure has occurred in some areas. We will inform you of the restoration work status after confirming your area. If you are in a hurry, please also try restarting your terminal.” using the generative AI. As a specific example of a prompt text to be read by the generative AI, “Generate a response text in easy-to-understand Japanese including a primary handling procedure that the customer can immediately execute for the following inquiry content by referring to the knowledge base and failure information. Inquiry content: ‘The Internet suddenly disconnected, I want you to respond urgently’” can be cited. Specifically, the generative AI response unit issues a real-time query to an external failure management database that manages an operating status of a communication network. The generative AI response unit dynamically embeds the acquired failure status as a context of the prompt. The generative AI response unit receives, as an input to the AI, for example, an inquiry text from the customer, a timestamp of a scheduled restoration time acquired from the failure management database, and list data indicating a failure influence range of a target area. The generative AI response unit converts the timestamp into a human-readable date and time format and tokenizes the text data as preprocessing of the input data. The generative AI response unit outputs, as an output from the AI, for example, an apology text character string indicating empathy for the customer, a character string indicating a specific estimated restoration time, and a bulleted list of troubleshooting procedures that can be tried on the customer side. The generative AI response unit transmits the output response text to the user interface unit. The generative AI response unit maintains an interactive session for tracking an execution result of the troubleshooting procedure included in the response text as the subsequent process. With this configuration, the system presents a specific solution completely personalized to the customer's current location and the real-time situation of the network, rather than a mere reply of a boilerplate text. The system immediately dispels the customer's anxiety. The system exhibits a technical effect of dramatically suppressing concentration of incoming calls to a call center. The system is extremely important in use cases where a large number of customers are simultaneously affected, such as communication failure handling during a wide-area power outage accompanying a natural disaster such as a typhoon or an earthquake, and guidance during temporary congestion at a large-scale event venue. The generative AI response unit applies output filtering for making the tone and manner of the response comply with brand guidelines of the company. The system completely prevents generation of an inappropriate expression.

In the reliability determination, when corresponding failure information does not exist in the knowledge base or when uncertainty in inference by the AI is high, the escalation unit generates a message such as “We will connect you to a human operator. We apologize for the inconvenience, but please let us know your detailed usage status.”, and transfers the content of the inquiry, customer information, a provisional response generated by the AI, a past response history, and the like to a human operator terminal. As a specific example of a prompt text to be read by the generative AI, “Generate a Japanese message recommending escalation to a human operator when there is no corresponding information in the knowledge base for the following inquiry content. Inquiry content: ‘The internet suddenly disconnected, I want an urgent response’” is given. Specifically, the escalation unit verifies semantic consistency between a draft response generated by the generative AI response unit and confirmed failure information in the knowledge base. The escalation unit receives, as an input to the AI, for example, a text vector of the generated response, a flag array indicating the latest status of a failure management database, and a floating-point number indicating a sentiment analysis score of the customer. The escalation unit executes cosine similarity calculation between vectors and normalization of the sentiment score as preprocessing of the input data. The escalation unit outputs, as an output from the AI, for example, a hallucination risk score from 0.0 to 1.0 indicating uncertainty of the response, a binary flag indicating necessity of escalation, and a group ID of an operator having an optimal handling skill. The escalation unit determines that the output binary flag is true. The escalation unit packages all context data of the inquiry in a JSON format as the subsequent process. The escalation unit immediately push-delivers the packaged data to a console of a dedicated operator specified by the group ID. With this configuration, the system completely blocks a risk that the AI arbitrarily transmits unconfirmed failure information or an inaccurate recovery prospect to the customer. The system prevents a decrease in reliability of a company. The system has a technical effect of seamlessly realizing human professional intervention for a complex event. The system functions as an essential safety mechanism in a use case where misinformation may cause enormous damage, such as failure handling of a dedicated line service for corporations or a defect of an emergency call system related to human life, for example. The escalation unit automatically transmits a bridging message such as “Currently, a specialized technical operator is checking the detailed situation” to the customer until the operator starts handling. The system reduces a perceived waiting time of the customer.

The knowledge base management unit records the content of the current inquiry, the response generated by the AI, and the final handling content by the human operator, and automatically adds a failure handling procedure and an FAQ to the knowledge base in preparation for a case where a similar failure occurs in another region or for another customer. For example, when inquiries saying “The internet does not connect” from the same region are concentrated in a short period of time, the trend learning unit detects the trend, and the knowledge base management unit automatically generates a fixed phrase such as “Currently, a communication failure is occurring in the XX region. Recovery work is in progress.”, so as to enable immediate response to subsequent inquiries of the same type. As a specific example of a prompt text to be read by the generative AI, “Analyze the inquiry history of the past 24 hours, and if failure-related inquiries from the same region are rapidly increasing, generate failure information and a response text example to be added to the knowledge base in Japanese.” is given. Specifically, the knowledge base management unit activates an automatic generation process of new failure handling knowledge triggered by an anomaly detection alert received from the trend learning unit. The knowledge base management unit inputs a plurality of inquiry texts generated from the same region to a clustering algorithm, and extracts a common event. The knowledge base management unit receives, as an input to the AI, for example, a text group of 50 similar inquiries accumulated in the past 24 hours, a character string of a final resolution procedure input by the operator, and extracted data of a system log indicating a cause of the failure. The knowledge base management unit executes text summarization, personal information masking, and noise data removal as preprocessing of the input data. The knowledge base management unit outputs, as an output from the AI, for example, a title character string of a new FAQ, a response template text for customers, and an array of metadata tags for searching the FAQ. The knowledge base management unit indexes the output response template in the vector database. The knowledge base management unit transmits a publication approval request for the new FAQ to an administrator's dashboard as the subsequent process. With this configuration, the system immediately and automatically generates a company-wide handling manual from handling results of the first few cases when a sudden failure occurs. The system rapidly increases an autonomous response rate of the AI to subsequent inquiries of the same type. The system has a technical effect of preventing a breakdown of a support department. The system exhibits tremendous power in a use case where inquiries of the same content explosively increase in a short period of time, such as when a nationwide defect caused by an OS update of a smartphone occurs or when a server of a popular game goes down, for example. When detecting that the failure has recovered, the knowledge base management unit automatically changes a status of the added FAQ to archived. The system prevents old information from being mixed into search results as noise.

Further, for example, in a retail business, when a customer inquires to a chatbot on a website, “The ordered product has not arrived, I want to check the delivery status”, the inquiry receiving unit receives this content, and the priority determining unit assigns a medium priority from keywords such as “has not arrived” and “want to check”. The generative AI response unit acquires the latest delivery status from the knowledge base through an API of a delivery management system, and generates a dynamic response such as “The ordered product was shipped from the delivery center today and is scheduled to arrive tomorrow. The delivery slip number is XX.”. As a specific example of a prompt text to be read by the generative AI, “Acquire the latest delivery status from the delivery management system for the following inquiry content, and generate a Japanese response text that can reassure the customer. Inquiry content: ‘The ordered product has not arrived, I want to check the delivery status’” is given. Specifically, the external cooperation unit establishes secure API communication with the delivery management system and an inventory management system existing in a backend of the retail business. The external cooperation unit extracts a named entity such as an order number or a tracking number from the inquiry text of the customer. The external cooperation unit receives, as an input to the AI, for example, an extracted 12-digit order number character string, an authentication session token of the customer, and an API endpoint URL of a delivery company. The external cooperation unit executes construction of an HTTP request header and JSON encoding of a payload as preprocessing of the input data. The external cooperation unit outputs, as an output from the AI, for example, latitude and longitude data of a current position returned from a system of the delivery company, a timestamp indicating a scheduled delivery date and time, and a category code indicating a delivery status. The external cooperation unit transfers the output structured data to the generative AI response unit. The generative AI response unit incorporates the data into a natural language prompt and generates a response text for the customer as the subsequent process. With this configuration, the system generates a personalized dynamic response based on transaction data individual to the customer in real time, not limited to presenting a static FAQ. The system saves the customer the trouble of logging into another system to check. The system has a technical effect of dramatically improving customer experience. The system is extremely effective in a use case where close cooperation with the backend system is indispensable, such as a large amount of inquiries about delivery status during a busy season such as mid-year gifts or year-end gifts, or inventory confirmation of a limited product, for example. The external cooperation unit includes a throttling mechanism that monitors a rate limit of an external API and dynamically adjusts a transmission interval of requests. The system continues stable data acquisition while preventing an excessive load on the external system.

Furthermore, for example, in a service industry, when a customer inquires “I want to change my restaurant reservation” using a voice recognition terminal, the inquiry receiving unit converts voice data into text, and the priority determining unit determines the importance of the reservation change. The generative AI response unit acquires information of a reservation management system from the knowledge base, and generates a personalized response such as “You can change your reservation free of charge until the day before. Please let us know your desired date and time.”. As a specific example of a prompt text to be read by the generative AI, “Generate a Japanese response text that allows the customer to immediately perform a procedure by referring to the information of the reservation management system for the following inquiry content. Inquiry content: ‘I want to change my restaurant reservation’” is given. Specifically, the system includes a recurrent neural network as a voice recognition module. The voice recognition module converts input voice waveform data into a mel-frequency cepstral coefficient feature vector. The feature vector is expressed as a multidimensional tensor continuous in a time axis direction. The priority determining unit includes a transformer model having a self-attention mechanism. The transformer model converts the text-converted inquiry data into a word embedding vector. The transformer model receives the word embedding vector as an input. The transformer model calculates a dependency relationship between each word. The transformer model outputs an importance score. The importance score is a floating-point number taking a continuous value from zero to one. For example, when the importance score is 0.8 or more, the system stores the inquiry in a priority queue. The generative AI response unit includes a large language model. The large language model receives a prompt text as an input tensor. The input tensor is a one-dimensional array of token IDs. The large language model combines structured data acquired from the reservation management system with the prompt text. The large language model outputs an appearance probability distribution of a next token. The system selects an optimal token sequence using a beam search algorithm. The system decodes the selected token sequence into natural language text data. As a technical effect, the system completely automates from voice input to response generation without intervention of a human operator. Thereby, the system shortens a response time to a millisecond unit. The system dramatically improves processing throughput of a reservation change procedure. As a specific application field, the system is applied to a reservation management system of a restaurant or an accommodation reservation system of a hotel. The system dramatically reduces a load of telephone handling during a busy season. The system reduces a waiting time of the customer to zero. The system improves customer satisfaction. The system prevents missing a reservation. The system contributes to maximization of sales. The system executes a noise removal process of the voice data. The noise removal process uses a convolutional neural network. The convolutional neural network effectively removes background noise. The system improves accuracy of voice recognition. The system prevents generation of an incorrect response due to misrecognition. The system executes an update process of a reservation management database asynchronously. The asynchronous process avoids lock contention of the database. The system optimizes processing efficiency of the entire system. By executing a vector operation in a high-dimensional space, the system realizes deep understanding of a context impossible with conventional rule-based keyword matching. The system accurately extracts an intention of the customer. The system immediately determines whether the reservation change is possible or not. The system proposes an optimal alternative date and time to the customer. The system dynamically generates proposal content. The system refers to a past usage history of the customer. The system recommends a seat or a plan tailored to the customer's preference. The system provides a personalized customer experience. The system executes all these processes at high speed on a memory inside a computer. The system minimizes dependence on an external network. The system eliminates communication delay. The system realizes a real-time dialogue.

In this way, the system of the present invention consistently, autonomously, and efficiently executes from inquiry reception to priority determination, automatic response generation, reliability determination and escalation, update and expansion of the knowledge base, and trend analysis in various industries such as a communication industry, a retail industry, and a service industry, and realizes high-quality customer handling utilizing the generative AI. In each use case, by appropriately designing a specific example of a prompt text to be read by the generative AI, it is possible to achieve both an optimal automatic response according to the content of the inquiry and business characteristics, and business efficiency improvement. Specifically, the system adopts a distributed processing architecture composed of a plurality of microservices. The system executes each processing module as an independent container. The system dynamically distributes a load of each module using a container orchestration tool. The system individually loads a dedicated language model for the communication industry and a dedicated language model for the retail industry onto a memory. The system determines a domain of the input inquiry data using a classifier. The classifier uses a support vector machine algorithm. The classifier converts the inquiry text into a TF-IDF vector and receives it as an input. The classifier outputs a domain label. The system routes processing to an appropriate dedicated language model based on the output domain label. The system automates an optimization process of the prompt text using reinforcement learning. The reinforcement learning model receives a satisfaction score of the customer as a reward. The reinforcement learning model changes a component of the prompt according to a policy function. The reinforcement learning model searches for an optimal prompt structure. As a technical effect, the system adapts to technical terms and specific business flows for each industry with high accuracy. The system generates an accurate response even to a specialized inquiry that is difficult to handle with a general-purpose model. The system eliminates the trouble of manual adjustment by an administrator by automatic optimization of the prompt. The system significantly reduces an operation cost. As a specific application field, the system is applied to an integrated customer support center of a conglomerate company developing diversified businesses. The system processes from failure handling of a communication service to return handling of a retail department on a single platform. The system cross-sectionally searches the knowledge base of each department. The system provides a one-stop response even to a complex inquiry. The system prevents the customer from being passed around. The system dramatically improves customer experience. The system visualizes an inquiry trend of each industry in real time using a trend analysis module. The trend analysis module uses a time-series clustering algorithm. The trend analysis module automatically extracts a rapidly increasing inquiry topic. The system automatically generates a new FAQ entry based on the extracted topic. The system autonomously expands the knowledge base. The system includes a self-healing capability against an unknown trouble. The system continuously improves availability and reliability of the entire system. The system executes these advanced information processes at high speed using a parallel arithmetic processor. The system completely replaces conventional manual work by a human. The system realizes sophistication of computer technology itself.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

Embodiments of the customer support system for an e-commerce site of the present invention will be described in detail with further specificity and randomly added depth. The system is composed of a server and a terminal, an inquiry receiving unit, a priority determining unit, a generative AI response unit, an escalation unit, a knowledge base management unit, a trend learning unit, a product information management unit, an order information management unit, an external cooperation unit, a security management unit, and an operation management unit are implemented on the server side, and a user interface unit is implemented on the terminal side. Specifically, the server is configured as a cluster system in which a plurality of physical arithmetic nodes are coupled by a high-speed network switch. The server executes each functional unit as an independent software process. The server uses a shared memory area and a message queuing protocol for inter-process communication. The inquiry receiving unit processes tens of thousands of simultaneous connections using an asynchronous IO multiplexing technology. The priority determining unit accelerates inference of a natural language processing model using a dedicated tensor arithmetic accelerator. The generative AI response unit divides and arranges a large language model having tens of billions of parameters into a plurality of graphics processing units. The escalation unit adopts a hybrid configuration of a rule engine and a machine learning model. The knowledge base management unit realizes a search response in a millisecond unit using a distributed in-memory database. The trend learning unit executes real-time data analysis using a stream data processing engine. The product information management unit and the order information management unit use a relational database and a document-oriented database together to achieve both data consistency and flexibility. The external cooperation unit provides a RESTful API and a GraphQL endpoint. The security management unit physically protects an encryption key using a hardware security module. The operation management unit collects metrics of the entire system and accumulates them in a time-series database. The user interface unit on the terminal side is implemented as a single-page application. The user interface unit optimizes redrawing of a screen using a virtual DOM technology. As a technical effect, the system acquires extremely high scalability and fault tolerance by configuring each functional unit with a loosely coupled architecture. Even when a load is concentrated on a specific functional unit, the system can independently scale out only the functional unit. The system minimizes downtime of the entire system. As a specific application field, the system is applied to a backend system of a large-scale e-commerce platform. The system provides a stable service even against a sudden traffic surge such as during a sale period. The system processes all inquiries from customers without delay. In the system, each functional unit cooperates to automatically complete a complex business transaction. The system constructs a fully autonomous support environment that does not require intervention of a human operator. The system efficiently utilizes hardware resources of a computer to the utmost limit. The system breaks through limitations of a conventional monolithic system design. The system becomes a foundation of a next-generation intelligent system.

First, the inquiry receiving unit receives an inquiry from various devices such as a web browser, a smartphone application, a chat application, a voice recognition terminal, a kiosk terminal, and further a smart speaker and a wearable terminal. For example, various formats of inquiries are received, such as when a customer inputs “Tell me recommended products” on a chat screen of a smartphone application, when speaking “The product I just ordered has not arrived” to a voice recognition terminal, when transmitting a photograph saying “I want you to see a defective part of this product” using an image attachment function, or when inputting “I want to know the inventory status for store pickup” on a kiosk terminal. The inquiry receiving unit adds additional information such as a reception time, a customer ID, a terminal type, an inquiry channel (web, application, telephone, SNS, etc.), position information, language information, and device information to the received content of the inquiry, and transmits it to the server. Furthermore, when the content of the inquiry is unclear or an input error is suspected, a re-input request message such as “Please fill in the content of your question in a little more detail”, “Please fill in the product name accurately”, or “Please specify which order your question is about” is automatically generated using the generative AI, and returned to the terminal side. For example, when the customer inputs only “has not arrived”, a specific additional question such as “Please specify which product has not arrived” is automatically generated. Specifically, the inquiry receiving unit includes a multimodal data integration module. The multimodal data integration module inputs text data, voice data, and image data to respective dedicated neural networks. When receiving the image data, the system converts the image data into a three-dimensional pixel value tensor. The system inputs the pixel value tensor to a convolutional neural network. The convolutional neural network extracts a feature vector from the image. When receiving the voice data, the system converts the voice data into an acoustic feature matrix. The system inputs the acoustic feature matrix to a recurrent neural network. The recurrent neural network outputs a token sequence of text from the voice. The system projects feature vectors obtained from these different modalities into the same high-dimensional vector space. The system combines the projected vectors to generate an integrated context vector. The system inputs the integrated context vector to the generative AI. The generative AI calculates information entropy of the input integrated context vector. When the information entropy exceeds a preset threshold, the generative AI determines that the content of the inquiry is unclear. The generative AI calculates an attention weight for specifying missing information. The generative AI generates text data of a re-input request message for complementing the specified missing information. As a technical effect, the system acquires an ability to uniformly process various input formats. The system enables the customer to make an inquiry using a device or a method that is easiest to use. The system prevents stagnation of processing due to lack of information. The system efficiently collects necessary information through an interactive process. As a specific application field, the system is applied to a customer contact platform of a retail business developing an omnichannel strategy. The system seamlessly integrates an inquiry with an image from a kiosk terminal in a physical store and a text inquiry from an online store. The system provides flexible support according to the situation of the customer. The system automatically specifies a defective part of a product using an image recognition technology. The system reduces a burden of requesting a long explanation from the customer. The system improves customer experience. The system executes these multimodal processes in real time on a parallel arithmetic cluster. The system overcomes limitations of a conventional system depending on a single modality. The system expands a perception ability of a computer.

The priority determining unit analyzes the received content of the inquiry using the generative AI and a natural language processing technology, extracts keywords and contexts such as “cancellation”, “return”, “urgent”, “delay”, “defective product”, “payment error”, “personal information leak”, “complaint”, “high-priced order”, and “corporate customer”, and automatically determines urgency and importance of the inquiry. For example, a priority is automatically assigned such that inquiries such as “I want to cancel my order”, “I want to return a product”, “I cannot pay”, “The product was broken”, and “Personal information may have been leaked” are given the highest priority, “I want to know the delivery status”, “I want to change the order content”, and “I want a receipt issued” are given a medium priority, and “Tell me recommended products”, “I want to know information on new products”, and “I want to write a review” are given a normal priority. Even when a plurality of inquiries occur simultaneously, the generative AI comprehensively evaluates various factors such as the content of each inquiry, customer attributes (VIP, corporation, repeater, first-time user, etc.), a past response history, an order amount, and whether or not it is during a campaign period, and manages a task queue so as to process in order from an inquiry having a high priority. For example, during a sale period or a large-scale campaign, it is also possible to assign inquiries such as “delivery delay”, “out of stock”, and “coupon unavailable” to the highest priority, and postpone a processing order of normal inquiries. Specifically, the priority determining unit includes a deep learning model combining a multilayer perceptron and a self-attention mechanism. The deep learning model receives, as an input, an embedding vector of the inquiry text, a vector obtained by one-hot encoding a categorical variable of the customer attribute, and a scalar value obtained by normalizing a continuous value such as the order amount. The system combines these input data to construct a single input tensor. The deep learning model passes the input tensor through a plurality of hidden layers. The deep learning model applies a softmax function in a final layer. The deep learning model outputs a probability distribution for three classes of highest priority, medium priority, and normal priority. The system adopts a class having the highest probability as the priority of the inquiry. Furthermore, the system calculates a continuous degree of urgency score from zero to one hundred for each inquiry using a regression model. The system updates a data structure of a dynamic priority queue based on the calculated degree of urgency score. The system sorts elements in the queue in descending order of the degree of urgency score. Every time a new inquiry arrives, the system specifies an appropriate insertion position using a binary search algorithm. The system optimizes task scheduling in a millisecond unit. As a technical effect, the system realizes advanced triage considering a complex context and background information of the customer, which is impossible with simple keyword matching. The system immediately extracts a truly urgent matter without burying it. The system prevents an increase in customer dissatisfaction and development into a serious trouble. As a specific application field, the system is applied to customer support of an e-commerce site that implements a large-scale sale event. The system instantly specifies a fatal inquiry such as a system down or a payment error even under a situation where traffic jumps to several tens of times normal. The system intensively allocates limited operators and computational resources to the most important task. The system maximizes business efficiency. The system inputs an external factor such as a campaign period to the model as a context vector. The system dynamically adapts to a change in situation. The system executes flexible prioritization that cannot be handled by a static rule-based system. The system achieves sophistication of autonomous resource management by a computer.

The generative AI response unit integrates information acquired from the knowledge base, the product information management unit, the order information management unit, and the external cooperation unit for the content of the inquiry, and automatically generates an optimal response text using the generative AI. For example, in response to an inquiry “Tell me recommended products”, a purchasing history, a browsing history, cart information, current campaign information, an inventory status, a review evaluation, a purchasing trend of a similar customer, seasonality, trend information, and the like of the customer are comprehensively analyzed, and a personalized proposal such as “Recommended products for you are A, B, and C. B is currently on discount. A has a high review evaluation, and C has only a few left in stock” is automatically generated. In response to an inquiry “I want to know the delivery status”, the latest delivery status (delivery company, slip number, delivery status, scheduled arrival date, delivery delay information, etc.) of the corresponding customer is acquired from the order information management unit, and a real-time response such as “The ordered product is currently being delivered and is scheduled to arrive tomorrow. The delivery company is Company X, and the slip number is 123456” is returned. In response to an inquiry such as “I want to return a product“ or ”I want to cancel”, a procedure method and conditions (returnable period, non-returnable product, return shipping fee burden, refund method, cancellable timing, etc.) are extracted from the knowledge base, and specific guidance such as “You can apply for a return from My Page within 14 days after the product arrives. Food and opened products are not eligible for return” or “Cancellation of an order is possible until before shipping. If it has already been shipped, please use the return procedure” is provided. Furthermore, also for inquiries such as “Tell me payment methods”, “I want a receipt issued”, “I want to know how to use a coupon”, “I want to check my point balance”, and “Is gift wrapping possible?”, corresponding information is extracted from the product information management unit, the order information management unit, and the external cooperation unit, and the generative AI generates an optimal response. The generative AI is also capable of multilingual support, and for example, automatically translates even an inquiry in a foreign language and generates a response in an appropriate language. Even when the content of the inquiry is complex or includes a plurality of questions, it is possible to divide it for each question, individually generate a response, and integrate them to reply. Specifically, the generative AI response unit adopts a retrieval-augmented generation architecture. The system inputs the inquiry text to an encoder model and generates a high-dimensional query vector. The system executes an approximate nearest neighbor search on a vector database using the query vector. The system extracts a plurality of related knowledge chunks based on cosine similarity. The system integrates the extracted knowledge chunks, a profile vector of the customer, and real-time API response data as structured data in a JSON format. The system embeds the structured data into a natural language prompt template. The system inputs the constructed prompt to a large language model. The large language model autoregressively generates a token and outputs a final response text. The system includes a language identification model for multilingual support. The language identification model outputs a language label from a distribution of character codes of the input text. The system calls an appropriate translation model based on the language label. When a plurality of questions are included, the system divides the input text into a list of independent sentences using a parser. The system executes a response generation process in parallel for each sentence. The system combines the generated plurality of responses into one natural paragraph using a summarization model. As a technical effect, the system strongly suppresses occurrence of hallucination not based on facts. The system always guarantees a response based on the latest and accurate information. The system provides completely customized information for each customer. As a specific application field, the system is applied to a comprehensive online shopping mall handling millions of products. The system instantly calculates enormous product data and complex delivery conditions. The system resolves a customer's question with accuracy and speed far exceeding human memory and search ability. The system automatically creates an opportunity for cross-selling or up-selling. The system directly contributes to an improvement in sales. The system completes these complex information integration and text generation in a millisecond unit. The system maximizes advanced information processing capability of a computer.

The escalation unit determines a reliability of the response generated by the generative AI response unit, and comprehensively evaluates a matching degree with the knowledge base, a past response track record, complexity of the content of the inquiry, customer attributes (VIP customer, corporate customer, general customer, etc.), an order amount, a risk degree, and the like. For example, in the case of a non-standardized inquiry such as “This inquiry has no corresponding information in the knowledge base, and uncertainty in inference by the AI is high”, “I want to return a plurality of products at the same time, but some are opened”, “Special handling for overseas delivery”, “Defect of a high-priced product”, “Suspicion of personal information leak”, or “Complaint requiring legal action”, the escalation unit provides guidance saying “We will connect you to a human operator”, and transmits the content of the inquiry, customer information, a provisional response generated by the AI, a past response history, related order information, product information, risk evaluation, and the like to a human operator terminal. At the time of escalation, related information is automatically summarized and displayed so that the human operator can quickly respond, and the human operator can create a final response while referring to the provisional response of the AI. The handling content after escalation is also recorded in the knowledge base and utilized for future AI learning. Specifically, the escalation unit includes a reliability evaluation model using ensemble learning. The reliability evaluation model calculates a log likelihood of a generation probability of each token output by the generative AI. The system calculates an average value of the log likelihoods, and sets this as an internal certainty score. The system calculates cosine similarity between an inquiry vector and an extracted knowledge chunk vector, and sets this as an external evidence score. The system normalizes a numerical value of a VIP flag or an order amount of the customer, and sets this as a business risk score. The system inputs the internal certainty score, the external evidence score, and the business risk score as a feature vector to a random forest classifier. The random forest classifier outputs a binary label indicating necessity of escalation and a comprehensive risk probability taking a continuous value from zero to one. When the binary label is true or when the comprehensive risk probability exceeds a preset threshold, the system triggers an escalation process. In the escalation process, the system packages a session state of the customer, all extracted context data, and a trace log of an inference process of the generative AI as a JSON object. The system asynchronously transmits the JSON object to a dashboard application of an operator via a message broker. As a technical effect, the system autonomously recognizes limitations of the AI, and prevents a decrease in customer satisfaction and a legal risk due to an inappropriate response. The system accurately isolates a case requiring human professional knowledge. The system structures and provides all information necessary for problem solving to the operator. The system dramatically reduces investigation time of the operator. As a specific application field, the system is applied to an e-commerce platform handling financial products and high-priced jewelry. The system functions as a safety net in a severe environment where a slight misguidance leads to enormous damage. The system accumulates text data of the final response corrected by the operator in a database as a correct label. The system periodically executes fine-tuning of the generative AI using the accumulated data. The system continuously improves accuracy of the model through human intervention. The system constructs a cooperative learning loop between a human and a machine. The system realizes self-evolution of a computer system.

The knowledge base management unit updates the knowledge base as needed by integrating the content of the inquiry, a response history, new information from the outside, manual addition/modification by an administrator, legal revision, campaign information, product specification change, FAQ update, information from an external information source (SNS, bulletin board, news site, etc.), and the like. For example, by adding information such as “a new electronic payment service has become available”, “a return policy has been changed”, “a new product has been added”, “a delivery company has been changed”, “a campaign period has been extended”, and “a receipt issuing method has been changed due to legal revision” to the knowledge base, the AI can immediately handle customers based on the latest information. A response automatically generated by the generative AI and a frequent inquiry detected by the trend learning unit are also automatically added to the knowledge base. For example, when “return inquiries for a specific brand are rapidly increasing recently”, the trend learning unit detects the trend, and the knowledge base management unit automatically registers return conditions and notes for the corresponding product. The knowledge base is designed to be efficiently searchable by a hierarchical structure and tagging, and the generative AI extracts, summarizes, and reconstructs optimal information according to the content of the inquiry to generate a response text. Specifically, the knowledge base management unit includes a hybrid storage system of a high-dimensional vector database and a graph database. The system inputs new text data input from the outside into a natural language processing pipeline. The pipeline divides the text data into chunks having semantic cohesion. The system inputs each chunk into a pre-trained embedding model. The embedding model outputs a 768-dimensional dense vector. The system inserts the dense vector into the vector database. At the same time, the system extracts an entity from the text using a named entity extraction model. The system registers a relationship between the extracted entities in the graph database in a triple format. The system dynamically reconstructs an index of the vector database using an HNSW algorithm. The system executes optimization of the index in a background process every time data addition or update occurs. As a technical effect, the system maintains an ability to search for related information from a huge amount of unstructured data in milliseconds. The system prevents information silos and always provides the latest knowledge to the generative AI. The system dramatically improves precision and recall of a search by combining semantic similarity by a vector search and a logical relationship by a graph search. As a specific application field, the system is applied to a support system for pharmaceuticals and electronic devices in which legal revisions and product specification changes frequently occur. The system completely eliminates erroneous guidance based on old information. The system strongly supports compliance observance. The system calculates a cluster center vector of frequent inquiries received from the trend learning unit. The system specifies an existing FAQ entry closest to the cluster center vector. When the existing FAQ does not exist, the system automatically generates a new pair of a question text and a response text of the FAQ using the generative AI. The system registers the generated pair in the database as an unapproved status, and notifies the administrator. The system automates life cycle management of knowledge. The system realizes autonomous knowledge acquisition and organization by a computer.

The trend learning unit analyzes an appearance frequency and a trend of the content of the inquiry and a purchasing trend in real time, and analyzes a past inquiry history and customer behavior data in chronological order. For example, trends such as “return inquiries for a specific brand have increased to three times the normal level this week”, “questions regarding discount conditions are occurring frequently after the start of a new campaign”, “inquiries about seasonal products are rapidly increasing”, “inquiries about delivery delays are concentrated in a specific region”, and “inquiries about a product talked about on SNS are rapidly increasing” are automatically detected. The detected trend information is transmitted to the knowledge base management unit, and a new FAQ and troubleshooting guide are automatically generated and registered as needed. Furthermore, the trend learning unit also analyzes an inquiry trend according to seasonal fluctuation, a campaign period, and a social event (disaster, legal revision, epidemic, etc.), and automatically optimizes the content of the knowledge base and a response policy of the AI. Specifically, the trend learning unit includes a time-series anomaly detection model implemented on a stream data processing framework. The system receives an occurrence event of an inquiry in real time. The system calculates an aggregate count for each certain time window using a topic label, a product ID, and a region code extracted from each event as keys. The system constructs the aggregated count data as a multivariate time-series tensor. The system inputs the time-series tensor into a long short-term memory network. The long short-term memory network outputs a predicted count value at a current time step from a past data pattern. The system calculates a residual between the predicted count value and an actual count value. When the residual exceeds a dynamically set statistical threshold, the system determines that an abnormal trend has occurred in the topic. The system applies a latent Dirichlet allocation method to an inquiry text group related to the topic determined to be abnormal. The system extracts a specific keyword distribution from the text group. As a technical effect, the system discovers a sign of a minute change early by a statistical approach before a human notices it. The system makes it possible to take a measure before a problem becomes large-scale. The system improves accuracy of call volume prediction of a support center, and contributes to optimization of personnel allocation. As a specific application field, the system is applied to a retail business having a logistics network expanding nationwide. The system immediately detects a rapid increase in inquiries about delivery delays due to localized bad weather. The system automatically push-delivers a message of an apology for the delay and a status explanation to customers in the region. The system prevents an active inquiry from a customer in advance. The system prevents depletion of support resources. The system analyzes periodicity of seasonal fluctuation using Fourier transform. The system learns a pattern of inquiries that increase in a specific season. The system adds a weight to a search score of a related FAQ when the season approaches. The system induces the generative AI to preferentially refer to an appropriate context according to the season. The system realizes data-driven proactive customer support. The system embodies advanced predictive analysis technology by a computer.

The product information management unit manages a product database, and centrally manages a product name, description, price, inventory status, image, review information, campaign information, sales period, category information, related product information, gift availability, allergy information, origin information, and the like. For example, when addition of a new product, inventory fluctuation, price revision, campaign start/end, fluctuation of review evaluation, addition of a product supporting gift wrapping, or the like occurs, the product information management unit automatically updates the database, and the generative AI response unit refers to the latest product information to generate a response or a recommendation. For example, it is possible to immediately respond to inquiries such as “tell me the new products of this week”, “I want you to display only products in stock”, “tell me the products on discount”, “tell me the products that can be gift-wrapped”, and “tell me the allergy-friendly products”. Specifically, the product information management unit manages product data using a distributed in-memory data grid. The system holds attribute data of each product on a memory in a key-value store format. The system inputs a text description of the product into a natural language processing model, and extracts a semantic feature vector. The system inputs image data of the product into a convolutional neural network, and extracts a visual feature vector. The system combines these feature vectors to generate a multimodal product vector. The system registers the multimodal product vector in a vector index. The system receives an inventory fluctuation event from an inventory management system via a webhook. Upon receiving the event, the system immediately updates an inventory flag of the corresponding product on the in-memory data grid. The system executes an update process as an atomic transaction. As a technical effect, the system processes a complex search query for millions of product data within a few milliseconds. The system eliminates a bottleneck of disk IO, and realizes extremely high throughput. The system guarantees that the generative AI always refers to the latest inventory status and price information. The system prevents an opportunity loss and customer dissatisfaction such as a product becoming out of stock immediately after guiding that it is “in stock”. As a specific application field, the system is applied to an apparel e-commerce site that frequently conducts flash sales. The system follows an inventory status and price information that fluctuate on a second-by-second basis in real time. In response to a complex condition search from a customer such as “tell me a red dress that is currently in stock and is 3,000 yen or less”, the system instantaneously extracts a corresponding product by combining a vector similarity search and metadata filtering. The system passes a list of the extracted products to the generative AI response unit as a JSON array. The system learns a co-occurrence relationship between products using a graph neural network. The system dynamically generates a related product link saying “people who bought this product also bought these products”. The system integrates an advanced recommendation algorithm into a product management platform. The system solves a problem of computer technology of achieving both centralized data management and high-speed access.

The order information management unit manages an order history and a delivery status, and centrally manages order content, an order date, a delivery status, a delivery slip number, delivery company information, a payment status, an order change history, a cancellation history, a return history, a gift designation history, and the like for each customer. For example, in response to inquiries such as “the ordered product does not arrive”, “I want to know the delivery status”, “I want to change the order content”, “I want a receipt to be issued”, and “I want to add a gift designation”, the order information management unit extracts corresponding information, and the generative AI response unit generates a response in real time. Specifically, the order information management unit includes a distributed database system adopting an event sourcing architecture. The system records each state change such as creation of an order, completion of payment, shipment of a product, and completion of delivery in an append-only data store as an immutable event log. The system stores a time stamp, a transaction ID, and state difference data in a JSON format in each event log. By replaying these event logs in chronological order, the system reconstructs an accurate state of the order at an arbitrary point in time as a materialized view on a memory. When receiving an inquiry from a customer, the system refers to a hash index using a customer ID as a search key. The system acquires the materialized view of the corresponding order in constant time. The system converts the acquired order data into a structured context object. The system provides the context object to the generative AI response unit. As a technical effect, the system fundamentally eliminates data update conflict and inconsistency. The system guarantees extremely high transaction processing performance and data integrity. Since the system can instantaneously restore an order state at an arbitrary point in time in the past, it easily responds to complex troubleshooting and an audit request. As a specific application field, the system is applied to an online marketplace in which a plurality of third-party sellers participate. The system abstracts different delivery flows and payment conditions for each seller with a unified event model. The system provides a consistent order tracking interface to a customer. The system periodically polls tracking information from a delivery company via an API. When there is a change in the tracking information, the system appends it to the data store as a new delivery event. The system enables the generative AI to generate an extremely fine-grained real-time response such as “currently, the product has just left the nearest delivery office”. In response to an order cancellation request, the system strictly determines whether a current state is in a cancellable phase using a state machine. The system outputs a determination result as a Boolean value. The system implements complex business logic as a strict state transition model inside a computer. The system maximizes accuracy and automation of business processing.

The external cooperation unit performs API cooperation with a payment system, a delivery management system, an inventory management system, a customer management system, an SNS, an external FAQ database, and the like, and the generative AI refers to external data in real time to generate a response. For example, in response to an inquiry “I want to know the delivery status of the product”, the latest delivery status is acquired from the delivery management system, and a dynamic response such as “your product has been shipped today and is scheduled to arrive tomorrow” can be generated. Alternatively, it is also possible to generate a real-time response such as “currently, it is in stock. You can place an order” in cooperation with the inventory management system. Furthermore, by collecting information from an SNS or a bulletin board, information regarding a trouble or a new function talked about outside can be automatically reflected in the knowledge base. Specifically, the external cooperation unit functions as an API gateway in a microservice architecture. The system uses a RESTful API and GraphQL on an HTTPS protocol for communication with an external system. The system securely manages authentication information for each external system as an encrypted environment variable. The system implements a circuit breaker pattern for calling an external API. When a response from the external system cannot be obtained within a certain time, or when an error rate exceeds a threshold, the system temporarily blocks a request to the external system. As a fallback process, the system returns cached latest data, or issues an instruction to cause the generative AI to generate a response to the effect that “it cannot be confirmed due to system congestion at present”. The system parses and maps data in an XML or JSON format acquired from the external system to an internal standardized data model. The system outputs the mapped data as a context variable to be embedded in a prompt of the generative AI. As a technical effect, the system prevents a failure of the external system from spreading to the entire system. The system maintains high fault tolerance and availability. The system simplifies processing logic of the generative AI by uniformly handling various data formats. As a specific application field, the system is applied to a cross-border EC platform expanding globally. The system dynamically cooperates with different payment gateways of each country and systems of local delivery companies. The system routes an appropriate external API according to a country of residence of a customer. The system connects to a public streaming API of an SNS, and collects posts including a specific hashtag or brand name in real time. The system applies an emotion analysis model to the collected text data. When posts having a high negative emotion score rapidly increase, the system infers that a new trouble has occurred. The system transmits the information to the knowledge base management unit as an alert. The system autonomously senses a change in an external environment, and updates internal knowledge. The system realizes an advanced information processing mechanism that dynamically interacts with the external world, rather than a closed system.

The security management unit executes encrypted communication of inquiry data and customer information, access authority management, log audit, personal information protection, data masking, anonymization processing, unauthorized access detection, information leakage prevention, anonymization/aggregation processing of learning data, and the like. For example, the content of the inquiry including personal information can be automatically masked by the AI and transferred to a human operator. Furthermore, learning data of the AI and an update history of the knowledge base are all recorded as an audit log to prevent unauthorized access and information leakage. When there is a deletion request from a customer, corresponding data is promptly excluded from a learning data set. Specifically, the security management unit constructs a multi-layer defense architecture from a network layer to an application layer. The system forces end-to-end encryption using a TLS protocol for all external communications. The system applies encryption using an AES 256-bit algorithm to stored data. The system applies a named entity extraction model to an input inquiry text. The named entity extraction model is a hybrid model of a bidirectional long short-term memory network and a conditional random field. The model specifies personal information such as a name, a telephone number, a credit card number, and an address in the text on a character-by-character basis. The system replaces the specified character string with a masking character such as an asterisk. The system uses only the masked text as inference and learning data of the generative AI. The system records all system operations and data access events as an unalterable audit log using hash chain technology. The system stores the audit log in a WORM storage. The system includes an anomaly detection model that monitors behavior of network traffic. The anomaly detection model learns features of a normal communication pattern using an autoencoder. The system calculates a reconstruction error of input traffic data. When the reconstruction error exceeds a threshold, the system determines that there is a suspicion of a zero-day attack or data exfiltration, and immediately disconnects the session. As a technical effect, the system completely protects confidential data from increasingly sophisticated cyber attacks and internal fraud. The system realizes safe AI operation compliant with privacy protection regulations. The system fundamentally eliminates a risk that an AI model memorizes personal information by masking processing. As a specific application field, the system is applied to a customer support system of a financial institution or a medical institution where strict information management is required. In response to a data deletion request (right to be forgotten) from a customer, the system automatically executes a script that physically deletes, rather than logically deletes, a corresponding record on a distributed database. The system applies machine unlearning technology to a trained AI model. The system cancels an influence given by a specific data point to a weight parameter of the model by inverse calculation of a gradient. The system erases a specific memory without retraining the entire model. The system dramatically enhances reliability of computer technology from the viewpoint of security and privacy protection.

The operation management unit can centrally manage confirmation of the content of the knowledge base, monitoring of response accuracy of the AI, browsing of a trend analysis result, confirmation of an escalation history, monitoring of a system operation status, alert notification at the time of failure occurrence, batch update of FAQs, batch registration of campaign information, management of external cooperation settings, authority management of a human operator, and the like from an administrator terminal. For example, when the response accuracy of the AI falls below a certain standard, it is possible to automatically notify an administrator and prompt a review of the knowledge base or retraining of an AI model. When a system failure or a network failure occurs, a mechanism can also be implemented in which an automatic response such as “the system is currently congested. Please wait for a while.” is displayed on the terminal side, inquiry data is temporarily stored on the terminal side, and is retransmitted to the server after recovery. Specifically, the operation management unit arranges an agent program that collects telemetry data of the entire system in each node. The system writes metrics such as a CPU usage rate, memory consumption, a network bandwidth, an API response time, and inference latency of the generative AI to a time-series database every second. The system aggregates the collected data and draws it as a real-time graph on a web-based dashboard. In order to evaluate the response accuracy of the AI, the system calculates a moving average of a feedback score from a customer and an escalation rate. When the moving average value falls below a preset allowable lower limit value, the system fires an alert event. The system transmits the alert event to an email address of the administrator via an SMTP protocol. When detecting occurrence of a failure, the system issues a failover command to a traffic control module. The system switches a routing destination of a request to a standby backup cluster. The system returns an HTTP status code 503 to an application on the terminal side. Upon receiving the status code, the application on the terminal side serializes and stores the inquiry data in a local storage. The application on the terminal side periodically attempts reconnection to the server using an exponential backoff algorithm. After confirming that the connection has been recovered, the application on the terminal side deserializes the stored data and retransmits it to the server. As a technical effect, the system significantly reduces a monitoring burden on a system administrator. The system instantaneously detects performance degradation or failure occurrence, and activates an automatic recovery process. The system does not lose input data of a customer even when a network is disconnected. The system realizes extremely high availability and fault tolerance. As a specific application field, the system is applied to a support center of an infrastructure company that requires non-stop operation 24 hours a day, 365 days a year. The system provides a function for the administrator to batch-import thousands of FAQ data from a CSV file through a GUI. The system asynchronously vectorizes the imported data in the background, and updates an index. The system streamlines operation and maintenance work, and reduces a total cost of ownership over the entire life cycle of the system. The system embodies a mechanism of autonomous monitoring and control of a computer system.

The user interface unit is realized by various devices such as a web browser, a smartphone application, a chat application, a voice recognition terminal, a kiosk terminal, a smart speaker, and a wearable terminal used by a customer, and provides various functions such as inquiry input, display of an automatic response by AI, a chat screen with a human operator at the time of escalation, FAQ search, voice guidance, push notification, file attachment, inquiry by image recognition, gift designation, review posting, order history display, point balance display, coupon use, and gift wrapping designation. For example, when a customer inputs “tell me the payment methods” in a chat window, the generative AI generates a response on the server side, and immediately displays a response such as “credit card, electronic payment service, and bank transfer are available” on the terminal side. When escalation occurs, the screen automatically switches to a chat screen with a human operator on the terminal side, and the customer and the human operator can directly interact. Voice input and multilingual support are also supported on the terminal side. For example, when a foreign customer makes an inquiry in English, the terminal side automatically translates it, the server side converts it into Japanese and the AI processes it, and a response can also be returned in English. Specifically, the user interface unit operates as a single-page application constructed using a front-end framework. The system uses a WebSocket protocol for bidirectional communication with the server. Every time a customer inputs text with a keyboard, the system transmits a character string being input to the server in real time. The system executes a predictive conversion model on the server side, and returns a candidate for a word to be input next to the terminal side. The system updates drawing of the chat screen at high speed using virtual DOM technology. Upon receiving a trigger signal for escalation from the server, the system dynamically switches a component on the screen from an AI chat mode to a manned chat mode. The system loads a lightweight voice recognition model and machine translation model into a local memory on the terminal side. The system converts voice waveform data acquired from a microphone into text within the terminal using edge computing technology. When the converted text is a foreign language, the system translates it into Japanese text within the terminal. The system transmits the translated Japanese text to the server. The system translates the Japanese response text received from the server back into the original foreign language within the terminal. The system displays the translated response text on the screen, or outputs it as voice using a voice synthesis model. As a technical effect, the system minimizes a communication payload between the server and the terminal. The system saves a network bandwidth, and shortens a response delay to the utmost limit. The system distributes a load on the server side by effectively utilizing computing resources of an edge device. The system provides a seamless and intuitive user experience. As a specific application field, the system is applied to a smartphone application for a user using a mobile line with an unstable communication environment. The system enables browsing of a past chat history and search of a basic FAQ even in an offline state. In an image attachment function, the system automatically downscales a resolution of an image on the terminal side, applies JPEG compression, and then transmits it. The system shortens an upload time. The system provides an interface optimized for hardware characteristics of various devices. The system improves quality of human-computer interaction.

As a personalization function, the generative AI refers to customer attributes (age, gender, region, contract plan, past inquiry history, purchasing history, review posting history, point balance, gift usage history, corporate/individual classification, VIP status, etc.), and can generate a response with easy-to-understand expressions and a large font size for elderly people, automatically guide contact information of a sales representative in charge for corporate customers, preferentially escalate for VIP customers, and guide a special coupon for repeaters, for example. Specifically, the system includes a customer profiling module. The customer profiling module extracts various attribute data and behavior history data of a customer from a database. The system converts the extracted categorical data into a one-hot vector. The system scales continuous value data by standardization processing. The system combines these data to construct a customer feature vector of several hundred dimensions. The system reduces dimensions of the customer feature vector using a principal component analysis algorithm to generate a dense profile vector. The system embeds the profile vector as a context in a system message area of a prompt of the generative AI. The system dynamically gives a meta-instruction such as “since this customer is an elderly person, avoid technical terms, shorten one sentence, and respond in a polite tone” to the generative AI. When a corporate customer flag is true, the system acquires contact information of a corresponding account manager from the database, and automatically adds it to the end of a response text. When the VIP status is the highest, the system adds a fixed bias value to an output score of the priority determining unit, and forcibly inserts it at the head of a task queue. The system calculates a cosine similarity between a purchasing history vector of the customer and purchasing history vectors of all other customers using a collaborative filtering algorithm. The system specifies an ID of a coupon frequently used by a customer group having high similarity. The system instructs the generative AI to include the specified coupon information in the response. As a technical effect, the system eliminates uniform handling, and provides information perfectly adapted to the context of each individual customer. The system reduces a cognitive load on a customer, and shortens a time until problem resolution. The system improves customer loyalty, and contributes to an increase in a repeat rate. As a specific application field, the system is applied to a support portal of a comprehensive communication carrier having customers of various age groups and attributes. The system prompts quick self-resolution by a chatbot for a younger age group, and presents a lead to manned support in an easy-to-understand manner as needed for an older age group. The system realizes optimal resource allocation according to a customer segment. The system dynamically rewrites an HTML tag of an output text of the generative AI. The system automatically applies a CSS class designating a font size for elderly people. The system achieves consistent personalization by automatic processing of a computer from data processing of a back end to drawing of a front end.

As customization for each industry, a learning model and a knowledge base of the generative AI are optimized for each industry in order to respond to inquiry content, a business flow, laws and regulations, technical terms, seasonal fluctuation, gift demand, allergy information, origin information, warranty provisions, repair reception, model number confirmation, an expiration date, campaign information, a point system, gift wrapping, a delivery method, refrigerated/frozen handling, regular purchase, a large order for corporations, overseas delivery, return conditions, legal compliance, and the like peculiar to each industry, such as apparel, home appliances, food, books, daily necessities, cosmetics, sporting goods, furniture, baby products, pet products, outdoor products, medical supplies, and health foods, for example. For example, in the home appliance field, in response to inquiries such as “warranty period”, “repair reception”, and “model number confirmation”, warranty provisions and a repair reception flow are automatically guided, and in the food field, in response to inquiries such as “expiration date”, “allergy information”, and “origin”, corresponding information is extracted from the product information management unit and responded. Specifically, the system fine-tunes a general-purpose large language model into a specialized model for each industry using domain adaptation technology. The system collects text data of past inquiry logs, product manuals, and related laws and regulations of each industry. The system continuously executes pre-training by self-supervised learning using the collected text data. The system updates weight parameters of the model according to vocabulary and context peculiar to the industry. The system further executes supervised fine-tuning using high-quality response data created by an operator as a correct label. The system creates an independent namespace of a vector database for each industry. The system indexes a product model number, a specification document, and tree structure data of troubleshooting in a namespace for the home appliance industry. The system indexes management rules for raw materials, allergic substances, and an expiration date in a namespace for the food industry. The system determines a domain of an input inquiry using a classification model. The system dynamically selects a specialized model and a namespace of a vector database corresponding to the determined domain, and routes processing. As a technical effect, the system accurately interprets technical terms and implicit rules peculiar to an industry that cannot be understood by a general-purpose model. The system prevents generation of an irrelevant response, and provides high-quality support at an expert level. The system makes it possible to incorporate a complex business flow of each industry into the system as an algorithm. As a specific application field, the system is applied to a platform base of a general trading company handling a plurality of different commercial materials or an online mall in which various tenants reside. The system automatically applies optimal support logic according to an industry type of a tenant. In repair reception of a home appliance, the system automatically extracts a model number and a serial number from an image of a product label transmitted by a customer using optical character recognition technology. The system verifies the extracted character string using a regular expression, and transmits it to an API of a repair management system. In an allergy inquiry of food, the system scans an ingredient array of a product database, and strictly determines whether a designated allergen is included by a Boolean operation. The system absorbs a difference in requirements for each industry at a level of a software architecture, and realizes scalable customization.

As described above, the embodiment of the present invention, as a customer support system for an e-commerce site of a server-terminal cooperation type with generative AI as a core, consistently, autonomously, and efficiently executes processes from inquiry reception to response generation, escalation, knowledge base expansion, trend analysis, personalization, external cooperation, security, operation management, abnormality handling, data protection, and industry customization, thereby simultaneously realizing equalization of quality of customer handling, reduction of response time, reduction of business burden, reduction of support cost, improvement of customer satisfaction, legal compliance, and expandability, flexibility, and safety of the system. Specifically, the present system integrates these diverse functional modules as an event-driven microservice architecture. The present system asynchronously performs data transfer between the respective modules via a distributed messaging queue. The present system prevents blocking of the entire system even when a processing delay occurs in a specific module. The present system packages each microservice as a container image. The present system operates these containers on a container orchestration platform. The present system constantly monitors metrics of a CPU usage rate and a memory consumption amount. When detecting an increase in load, the present system dynamically increases the number of replicas of the corresponding container according to an autoscaling algorithm. When the load decreases, the present system decreases the number of replicas and releases calculation resources. The present system offloads an inference process of the generative AI to a cluster of dedicated tensor arithmetic processors. The present system maximizes an operation rate of a hardware arithmetic unit by batching and processing inference requests. As a technical effect, the present system completely breaks through the limit of manual work by a human operator. The present system maintains a response speed in milliseconds for tens of thousands of simultaneous inquiries. The present system eliminates human errors and always provides accurate information with a constant quality. The present system dramatically reduces enormous personnel costs and training costs required for support business. As a specific application field, the present system is applied to a customer service infrastructure of a mega-tech company having tens of millions of active users in a global market. The present system continues to process multilingual and multi-domain inquiries unattended 24 hours a day, 365 days a year. The present system constructs a loop in which the system itself learns from experience and evolves through trend analysis and automatic update of the knowledge base. The present system functions not merely as a business efficiency improvement tool but as an intelligent computer system that performs advanced information processing and autonomous decision making. The present system integrates data encryption and access control at a hardware level, and ensures an extremely high security standard. The present system establishes a next-generation technical infrastructure that provides an ultimate customer experience while clearing modern complex business requirements and strict legal regulations.

### System Configuration

The system according to the present embodiment includes an inquiry receiving unit, a priority determining unit, a generative AI response unit, an escalation unit, a knowledge base management unit, a trend learning unit, a product information management unit, an order information management unit, an external cooperation unit, a security management unit, an operation management unit, and a user interface unit. The inquiry receiving unit receives inquiries from various devices such as a web browser, a smartphone application, a chat application, a voice recognition terminal, a kiosk terminal, a smart speaker, and a wearable terminal, and receives inquiries in various data formats such as text, voice, and image, for example, when a customer inputs “Tell me recommended products” on a chat screen, when the customer speaks “The product I just ordered has not arrived” to the voice recognition terminal, when the customer transmits a photograph saying “I want you to see a defective part of this product” using an image attachment function, or when the customer inputs “I want to know the inventory status for store pickup” on the kiosk terminal. The inquiry receiving unit adds additional information such as a reception time, a customer ID, a terminal type, an inquiry channel, position information, language information, and device information, and transmits the information to a server. Furthermore, when the content of the inquiry is unclear or an input mistake is suspected, the inquiry receiving unit automatically generates a re-input request message such as “Please enter the content of your question in a little more detail”, “Please enter the product name accurately”, or “Please specify which order your question is about” using the generative AI, and returns the message to the terminal side. As a specific example of a prompt text to be read by the generative AI, “When the following inquiry content is unclear, generate a polite Japanese message for requesting the customer to re-input. Inquiry content: ‘Not arrived’” can be cited. Specifically, the present system interconnects the respective functional units via a high-speed internal bus and a network interface. The inquiry receiving unit receives asynchronous requests from a plurality of devices in parallel using multi-thread processing. The present system stores the received text data in a memory as a byte sequence in a UTF-8 format. The present system acquires the voice data as PCM waveform data with a sampling rate of 16,000 hertz. The present system acquires the image data as a three-dimensional tensor of 8 bits for each of RGB. The present system inputs these raw data to a preprocessing pipeline. The preprocessing pipeline executes text normalization, voice noise removal, and image size normalization. The present system inputs the preprocessed data to respective dedicated encoder neural networks, and converts the data into fixed-length latent representation vectors. The present system combines these latent representation vectors to generate a single multimodal feature vector. The present system supplies the multimodal feature vector to an input layer of the generative AI. The generative AI is a large language model based on a transformer architecture. The generative AI calculates a degree of context missing as information entropy from the input feature vector. When the information entropy exceeds a threshold, the generative AI embeds the content of the inquiry into a prompt template. The generative AI autoregressively generates text data of a specific re-input request such as “Could you please let us know the order number or the product name of which product has not arrived?”. As a technical effect, the present system absorbs differences in devices by processing various input modalities in a unified vector space. The present system prevents errors due to lack of information in advance, and efficiently collects necessary information while maintaining the context of the dialogue. The present system suppresses useless database searches and generation of erroneous responses, and prevents waste of calculation resources. As a specific application field, the present system is applied to a web counter of television shopping frequently used by elderly people and users with low IT literacy. The present system understands an intention of a user's ambiguous input through a natural dialogue like a human. The present system reduces user frustration and lowers a drop-off rate. The present system automates a process of prompt engineering and dynamically constructs an optimal prompt. The present system maximizes a natural language understanding capability of a computer.

The priority determining unit analyzes the received content of the inquiry using the generative AI and natural language processing technology, extracts keywords and contexts such as “cancellation”, “return”, “urgent”, “delay”, “defective product”, “payment error”, “personal information leak”, “claim”, “high-priced order”, and “corporate customer”, and automatically determines urgency and importance of the inquiry. For example, the priority determining unit automatically assigns a priority such that inquiries such as “I want to cancel my order”, “I want to return a product”, “I cannot pay”, “The product was broken”, and “Personal information may have been leaked” are given the highest priority, “I want to know the delivery status”, “I want to change the order content”, and “I want a receipt issued” are given a medium priority, and “Tell me recommended products”, “I want to know information on new products”, and “I want to write a review” are given a normal priority. Even when a plurality of inquiries occur simultaneously, the generative AI comprehensively evaluates various factors such as the content of each inquiry, customer attributes, a past handling history, an order amount, and whether or not it is during a campaign period, and manages a task queue so as to process the inquiries in descending order of priority. As a specific example of a prompt text to be read by the generative AI, “Determine urgency and importance included in the following inquiry content, and output a priority as a numerical value. Inquiry content: ‘The product was broken’” can be cited. Specifically, the priority determining unit adopts a BERT-based bidirectional encoder model as the natural language processing technology. The present system divides the inquiry text into an array of subword tokens using a tokenizer. The present system converts each token into an embedding vector and adds positional encoding. The present system inputs the vector array to the bidirectional encoder model. The bidirectional encoder model outputs a sentence vector considering the context of the entire text. The present system combines the sentence vector and structured data such as customer attribute data and an order amount to generate an integrated feature vector. The present system inputs the integrated feature vector to a regression network composed of a fully connected layer and a sigmoid activation function. The regression network outputs a degree of urgency score taking a continuous value from 0 to 100. The present system also inputs a prompt to the generative AI, and acquires a numerical value of the priority as an inference result. The present system integrates the output score of the regression network and the output numerical value of the generative AI in a framework of ensemble learning, and calculates a final priority score. The present system inserts the inquiry data into a data structure of a priority heap queue using the calculated priority score as a key. When an operator or an automatic response module acquires a task, the present system always pops a task with the maximum priority from a root node of the heap queue. As a technical effect, the present system accurately detects a hidden emergency that is overlooked by simple rule-based keyword matching through deep understanding of the context. The present system dynamically and optimally executes task scheduling. The present system concentrates limited processing resources on a task with the largest business impact. The present system dramatically improves processing efficiency and responsiveness of the entire system. As a specific application field, the present system is applied to an emergency support desk when a large-scale cyber attack or system failure occurs. The present system instantaneously extracts an extremely serious inquiry saying “My account has been hijacked and an unauthorized payment is being made” from a large amount of general inquiries saying “I cannot log in”, and directly connects the inquiry to a security team. The present system minimizes the spread of damage. The present system executes vector operations in a high-dimensional space and operations of a complex heap tree structure at high speed on a memory. The present system completes triage with a speed and accuracy far exceeding human cognitive ability. The present system realizes a fundamental improvement of a business process by computer technology.

The generative AI response unit integrates information acquired from the knowledge base, the product information management unit, the order information management unit, and the external cooperation unit for the content of the inquiry, and automatically generates an optimal response text using the generative AI. For example, in response to an inquiry “Tell me recommended products”, the generative AI response unit comprehensively analyzes a customer's purchase history, browsing history, cart information, campaign information, inventory status, review evaluation, purchase trend of similar customers, seasonality, trend information, and the like, and automatically generates a personalized proposal such as “Recommended products for you are A, B, and C. B is currently on discount. A has a high review evaluation, and C has only a few in stock.” In response to an inquiry “I want to know the delivery status”, the generative AI response unit acquires the latest delivery status of the corresponding customer from the order information management unit, and returns a real-time response such as “The ordered product is currently being delivered and is scheduled to arrive tomorrow. The delivery company is Company X, and the slip number is 123456.” In response to an inquiry such as “I want to return a product” or “I want to cancel my order”, the generative AI response unit extracts a procedure method and conditions from the knowledge base, and provides specific guidance such as “You can apply for a return from My Page within 14 days after the product arrives. Food and opened products are not eligible for return.” or “You can cancel your order before shipping. If it has already been shipped, please use the return procedure.” As a specific example of a prompt text to be read by the generative AI, “Generate the most appropriate Japanese response text for the following inquiry content by referring to the knowledge base, product information, and order information. Inquiry content: ‘I want to return a product’” can be cited. Specifically, the generative AI response unit is executed on a distributed processing cluster composed of a plurality of arithmetic nodes. The arithmetic node includes a dedicated parallel arithmetic processor for inferring a large language model at high speed. The generative AI response unit acquires a customer's inquiry text as input data. The generative AI response unit divides the input text into subword units using natural language processing technology to generate a token sequence. The generative AI response unit converts each token into a 768-dimensional word embedding vector. The generative AI response unit further acquires product metadata acquired from the product information management unit as a structured numerical vector. The generative AI response unit normalizes time-series delivery status data acquired from the order information management unit to generate a feature vector. The generative AI response unit combines these heterogeneous data to construct a multidimensional input tensor. For example, the input tensor includes a text vector indicating the content of the inquiry, a user profile vector indicating the customer's past purchase history, and a binary vector indicating the current inventory status. The generative AI response unit supplies this input tensor to an input layer of the large language model. The large language model is composed of dozens of layers of transformer blocks having a self-attention mechanism. The large language model executes a non-linear operation in a high-dimensional space on the input tensor, and calculates a contextual dependency relationship between the respective tokens. The large language model outputs a probability distribution vector indicating a generation probability of each token in a vocabulary space as an output. The generative AI response unit selects a token sequence with the highest probability using a beam search algorithm, and generates a response text in natural language. For example, the output data includes a text character string “The recommended product for you is A” and a score value in a range of 0.0 to 1.0 indicating its generation reliability. The generative AI response unit transmits the generated response text to the subsequent user interface unit. When the generation reliability score is less than a predetermined threshold, the generative AI response unit transfers the response text to the escalation unit. With this configuration, the present system generates not merely a response of a fixed phrase but a highly personalized response in which dynamically changing external data and a customer's context are integrated in real time. As a result, the present system exhibits a technical effect of dramatically improving response accuracy in customer support. Furthermore, the present system eliminates time for a human operator to manually search a plurality of databases, and significantly reduces a processing delay of the entire system. The large language model is pre-trained using a huge amount of past handling history data so as to minimize a cross-entropy error function. The generative AI response unit periodically executes fine-tuning of the model based on customer feedback using a reinforcement learning method. As a specific application field, the present system is optimal for an automatic customer handling system in a large-scale e-commerce platform handling millions of products. The present system maintains stable response performance by dynamically scaling out arithmetic resources even against a sudden rapid increase in inquiries during a busy season.

The escalation unit determines a reliability of the response generated by the generative AI response unit, and comprehensively evaluates a matching degree with the knowledge base, a past response record, complexity of the content of the inquiry, customer attributes, an order amount, a risk degree, and the like. For example, in the case of a non-standardized inquiry such as “This inquiry has no corresponding information in the knowledge base, and there is high uncertainty in AI inference”, “I want to return a plurality of products at the same time, but some of them have been opened”, “Special handling for overseas delivery”, “Defect of a high-priced product”, “Suspicion of personal information leak”, or “Claim requiring legal action”, the escalation unit provides guidance saying “We will connect you to a person in charge”, and transmits the content of the inquiry, customer information, a provisional response generated by the AI, a past handling history, related order information, product information, risk evaluation, and the like to an operator terminal. As a specific example of a prompt text to be read by the generative AI, “When there is no corresponding information in the knowledge base for the following inquiry content, generate a Japanese message recommending escalation to a person in charge. Inquiry content: ‘I want to consult about special handling for overseas delivery’” can be cited. Specifically, the escalation unit functions as an independent arithmetic module hosting a dedicated classification neural network. The escalation unit acquires an embedding vector of the response text output from the generative AI response unit as input data. The escalation unit further acquires a numerical vector indicating the customer's past claim history and a scalar value indicating the current order amount. The escalation unit combines these input data to generate a 1024-dimensional integrated feature tensor. For example, the input data includes a 768-dimensional vector of the response text, a normalized numerical value indicating the customer's claim frequency, and a floating-point number indicating a unit price of the product. The escalation unit supplies this integrated feature tensor to an input layer of a multilayer perceptron. The multilayer perceptron non-linearly transforms a feature space of the input data using a plurality of hidden layers and a rectified linear unit function. The multilayer perceptron applies a sigmoid function in an output layer, and calculates a probability score indicating the necessity of escalation. The escalation unit outputs a risk score which is a continuous value in a range of 0.0 to 1.0 and a binary flag indicating whether or not escalation is necessary as output data. For example, the output data includes a high risk score of 0.85 and a flag value of 1 indicating that escalation is necessary. When the calculated risk score exceeds a preset threshold, the escalation unit automatically routes the inquiry session to a terminal operated by a human operator. Upon routing, the escalation unit transmits the generated provisional response and the extracted risk factor as structured data to the operator terminal. With this configuration, the present system reliably and quickly hands over a complex inquiry or a high-risk case exceeding an inference limit of the AI model to a human operator. As a result, the present system exhibits a technical effect of preventing a decrease in customer satisfaction and manifestation of a legal risk due to an inappropriate automatic response in advance. Furthermore, the present system visualizes a determination criterion for escalation as a quantitative score, and enables an operation administrator to dynamically adjust the threshold. The classification neural network is optimized by supervised learning using past escalation history data so as to minimize a binary cross-entropy loss. The escalation unit collects a final handling result of the operator as a correct label, and periodically updates a weight parameter of the model. As a specific application field, the present system is optimal for a customer support system in a field requiring high accuracy and compliance observance, such as financial services and medical device sales.

The knowledge base management unit updates the knowledge base as needed by integrating the content of the inquiry, a response history, new information from the outside, manual addition/correction by an administrator, legal revision, campaign information, product specification change, FAQ update, information from an external information source, and the like. For example, by adding information such as “A new electronic payment service has become available”, “The return policy has been changed”, “A new product has been added”, “The delivery company has been changed”, “The campaign period has been extended”, and “The receipt issuing method has been changed due to legal revision” to the knowledge base, the AI can immediately handle customers based on the latest information. A response automatically generated by the generative AI and a frequent inquiry detected by the trend learning unit are also automatically added to the knowledge base. As a specific example of a prompt text to be read by the generative AI, “Analyze the inquiry history of the past week, extract frequently occurring new inquiry content and its response, and list new items to be added to the knowledge base in Japanese.” can be cited. Specifically, the knowledge base management unit is configured as an information retrieval system integrating a high-dimensional vector database and a document embedding model. The knowledge base management unit receives a new text document transmitted from an administrator terminal or structured data acquired from an external system as input data. The knowledge base management unit divides the input long text into a plurality of short chunks having semantic cohesion using a natural language processing algorithm. The knowledge base management unit supplies each chunk to an input layer of the document embedding model. The document embedding model adopts a bidirectional transformer architecture, and converts a contextual meaning of the text into a dense vector in a high-dimensional space. The knowledge base management unit outputs a 768-dimensional embedding vector corresponding to each chunk as output data. For example, the input data includes a text character string “The return policy has been changed, and food cannot be returned.” The knowledge base management unit stores a 768-dimensional floating-point array generated from this text in the vector database. When storing a new vector, the knowledge base management unit calculates a cosine similarity with an existing vector group. When there is an existing vector whose similarity exceeds a predetermined threshold, the knowledge base management unit updates or integrates an existing record in order to avoid duplication of information. The knowledge base management unit constructs a hierarchical navigable small world graph as an index structure of the vector database. With this configuration, the present system converts a huge amount of unstructured text data into a mathematical representation that can be searched at high speed by a computer. As a result, the present system exhibits a technical effect of shortening a search latency to milliseconds when the generative AI response unit refers to the latest knowledge in real time. Furthermore, the present system realizes a meaning-based similarity search that does not depend on an exact match of keywords, and extracts accurate information even for an inquiry including orthographical variants and synonyms. The document embedding model is pre-trained using a contrastive learning method such that a vector distance between semantically similar sentences becomes closer and a vector distance between different sentences becomes farther. The knowledge base management unit reconstructs an index of the entire vector database by periodic batch processing to prevent deterioration of search performance. As a specific application field, the present system is optimal for an internal help desk system of a large-scale manufacturing industry or telecommunications carrier in which a large amount of product manuals and internal regulations are updated daily. The present system eliminates information silos and always provides the latest single source of truth to the AI model.

The trend learning unit analyzes an appearance frequency and a trend of the content of the inquiry and a purchasing trend in real time, and analyzes a past inquiry history and customer behavior data in chronological order. For example, the trend learning unit automatically detects a trend such as “Return inquiries for a specific brand have increased to three times the normal level this week”, “Questions regarding discount conditions are occurring frequently after the start of a new campaign”, “Inquiries about seasonal products are rapidly increasing”, “Inquiries about delivery delays are concentrated in a specific region”, or “Inquiries about a product talked about on SNS are rapidly increasing”. The detected trend information is transmitted to the knowledge base management unit, and a new FAQ or troubleshooting guide is automatically generated and registered as necessary. As a specific example of a prompt text to be read by the generative AI, “Analyze the inquiry history of the past 30 days in chronological order, and summarize rapidly increasing inquiry content and its background factors in Japanese.” can be cited. Specifically, the trend learning unit is an independent arithmetic module implementing a recurrent neural network specialized for time-series data analysis. The trend learning unit acquires an appearance frequency vector of keywords aggregated at regular time intervals from the inquiry receiving unit as input data. The trend learning unit further acquires a time-series array indicating the number of delivery delays by region acquired from the order information management unit. The trend learning unit normalizes these data to generate a multidimensional time-series tensor. For example, the input data includes a 24-dimensional numerical vector indicating the number of appearances of the word “return” per hour in the past 24 hours, and an array indicating the number of occurrences of an error code in a specific region. The trend learning unit supplies this time-series tensor to an input layer of a long short-term memory network. The long short-term memory network learns a long-term dependency relationship and periodicity hidden in the time-series data using a memory cell holding a past hidden state. The long short-term memory network calculates a predicted appearance frequency of each keyword at the next time step. The trend learning unit calculates a residual between the predicted value and an actual observed value to calculate an abnormality degree score. The trend learning unit outputs a list of keywords whose abnormality degree score exceeds a threshold and a continuous value indicating a degree of rapid increase thereof as output data. For example, the output data includes a character string “return of a specific brand” and a numerical value of an abnormality degree score of 3.5. When the abnormality degree score satisfies a predetermined criterion, the trend learning unit transmits the trend information to the operation management unit and the knowledge base management unit as an asynchronous message. With this configuration, the present system automatically detects a minute change or a sudden abnormality that tends to be overlooked by human monitoring in real time. As a result, the present system exhibits a technical effect of enabling proactive handling before a large-scale system failure or a serious defect of a product spreads widely. Furthermore, the present system provides a prediction index for dynamically allocating arithmetic resources according to a fluctuation of a trend. The long short-term memory network is trained by a backpropagation through time algorithm using history data of the past several years so as to minimize a mean square error. The trend learning unit executes a filtering process in a frequency domain using Fourier transform as a preprocessing in order to correct external factors such as seasonal variation and day-of-week effect. As a specific application field, the present system is optimal for a monitoring system of an apparel industry sensitive to reactions on social media or a ticket sales platform in which a large amount of transactions occur in a short period of time.

The product information management unit manages a product database, and centrally manages a product name, description, price, inventory status, image, review information, campaign information, sales period, category information, related product information, gift availability, allergy information, origin information, and the like. For example, when addition of a new product, inventory fluctuation, price revision, start/end of a campaign, fluctuation of review evaluation, addition of a product supporting gift wrapping, or the like occurs, the product information management unit automatically updates the database, and the generative AI response unit generates a response or recommendation by referring to the latest product information. As a specific example of a prompt text to be read by the generative AI, “Generate an optimal product recommendation text in Japanese based on the following customer attributes, purchase history, inventory information, and campaign information. Customer attributes: female in her 30s, purchase history: cosmetics, inventory: product A in stock, campaign: product B on discount.” can be cited. Specifically, the product information management unit adopts a hybrid storage architecture combining a relational database and a distributed in-memory cache. The product information management unit acquires a structured data object including product metadata transmitted from an external core system as input data. The product information management unit further acquires a high-resolution image tensor indicating an appearance of the product. The product information management unit maps these heterogeneous data to an integrated feature space using a multimodal neural network. The multimodal neural network includes a convolutional neural network for processing image data and a transformer model for processing text data in parallel. The product information management unit combines a visual feature vector extracted from the image tensor and a semantic feature vector extracted from the product description text to generate a single integrated feature vector. For example, the input data includes an RGB image tensor of 224×224 pixels and a text character string “moisturizing cream containing organic ingredients”. The product information management unit outputs a 1024-dimensional integrated feature vector representing the product as output data. For example, the output data includes a floating-point array containing both visual similarity and semantic relevance of the product. The product information management unit stores the generated integrated feature vector in the vector database in association with a product ID. The product information management unit stores dynamically fluctuating scalar values such as the number of stocks and a price in an in-memory cache that can be read and written with low latency. With this configuration, the present system enables execution of not only a text search but also an image similarity search and a multimodal recommendation algorithm on a single infrastructure. As a result, the present system exhibits a technical effect of extracting a product that is visually and semantically most suitable at high speed and with high accuracy even for a customer's ambiguous request. Furthermore, the present system maintains a response speed of the entire system under a high traffic environment by distributing a read load of the database to the in-memory cache. The multimodal neural network is optimized by a contrastive language-image pre-training method using pair data of an image and text. The product information management unit asynchronously executes recalculation of the feature vector through an event-driven architecture every time addition or update of a product occurs. As a specific application field, the present system is optimal for an advanced product search system in an e-commerce platform for furniture or apparel in which a visual design is directly linked to a purchase decision.

The order information management unit manages an order history and a delivery status, and centrally manages order content, an order date, a delivery status, a delivery slip number, delivery company information, a payment status, an order change history, a cancellation history, a return history, a gift designation history, and the like for each customer. For example, in response to an inquiry such as “The ordered product has not arrived”, “I want to know the delivery status”, “I want to change the order content”, “I want a receipt issued”, or “I want to add a gift designation”, the order information management unit extracts corresponding information, and the generative AI response unit generates a response in real time. As a specific example of a prompt text to be read by the generative AI, “Generate a response text explaining the delivery status to the customer in an easy-to-understand manner in Japanese based on the following order information. Order information: order number 12345, delivery company X, delivery status: shipped today, scheduled arrival date: tomorrow.” can be cited. Specifically, the order information management unit is a data management module integrating a distributed transaction processing system and a predictive analysis engine. The order information management unit acquires payload data of an order confirmation event transmitted from a payment system as input data. The order information management unit further acquires an update log of a delivery status periodically acquired from an API of a delivery company as a time-series array. The order information management unit normalizes these data and converts the data into graph structure data using a customer ID as a key. The order information management unit includes a regression neural network functioning as a predictive analysis engine. The order information management unit supplies a multidimensional feature vector including a past delivery delay record, current weather data, and traffic congestion information to the regression neural network as input data. For example, the input data includes a numerical pair indicating position coordinates of a delivery base, a scalar value indicating precipitation, and a floating-point number indicating an average delay time of the past week. The regression neural network extracts a potential risk factor of a delivery delay from the input data using a plurality of fully connected layers and a dropout layer. The order information management unit outputs a delivery delay probability score for each order and a timestamp of a predicted arrival date and time as output data. For example, the output data includes a numerical value of a delay probability of 0.15 and a UNIX timestamp indicating the predicted arrival date and time. When the calculated delay probability score exceeds a predetermined threshold, the order information management unit assigns a flag to the order, and transmits a trigger signal for generating a proactive notification to the generative AI response unit. With this configuration, the present system not merely stores past history data but probabilistically predicts a future delivery status, and realizes dynamic customer handling. As a result, the present system exhibits a technical effect of eliminating customer anxiety and reducing a call volume of a support center by detecting a possibility of a delay before an inquiry from a customer occurs and providing guidance in advance. Furthermore, by using the graph structure data, the present system executes a query whose processing is complicated in a relational database, such as a complex order change or divided delivery of a plurality of products, at high speed. The regression neural network is trained by a gradient descent method using past millions of delivery record data so as to minimize a mean absolute error. As a specific application field, the present system is optimal for a back-end system of a quick commerce platform requiring strict delivery time management, such as fresh food and pharmaceuticals.

The external cooperation unit performs API cooperation with a payment system, a delivery management system, an inventory management system, a customer management system, an SNS, an external FAQ database, and the like, and the generative AI refers to external data in real time to generate a response. For example, in response to an inquiry “I want to know the delivery status of the product”, the latest delivery status is acquired from the delivery management system, and a dynamic response such as “Your product has been shipped today and is scheduled to arrive tomorrow” can be generated. Alternatively, it is also possible to generate a real-time response such as “Currently, it is in stock. You can place an order” in cooperation with the inventory management system. A specific example of a prompt text to be read by the generative AI is “Generate a Japanese response text to a customer based on delivery status data acquired from an external delivery management system.” Specifically, the external cooperation unit functions as a high-availability API gateway and a data conversion pipeline that mediate communication between a plurality of heterogeneous systems. The external cooperation unit acquires structured response data transmitted from the external delivery management system as input data. The external cooperation unit further acquires an encrypted token indicating a transaction status transmitted from the external payment system. The external cooperation unit executes schema verification on the received data to confirm whether a missing value or an invalid data type is included. The external cooperation unit uses a data conversion algorithm to convert a data format different for each external system into a standardized multidimensional tensor or structured object that can be commonly used inside the system. For example, the input data includes character string data including a status code “STATUS_99” unique to the external system, and a date character string having a different time zone. The external cooperation unit outputs, as output data, an integer value mapped to a standard status code “DELIVERED” defined in the internal system, and a timestamp normalized to Coordinated Universal Time. For example, the output data includes an integer value 3 indicating a status and a numerical value of a UNIX timestamp. The external cooperation unit publishes the converted standard data to an in-memory messaging queue so that the generative AI response unit and the order information management unit can asynchronously subscribe to the data. The external cooperation unit implements a circuit breaker pattern for calling an external API to prevent a failure of the external system from spreading to the entire system. With this configuration, the system always supplies the latest external data to the AI model while maintaining high fault tolerance against specification changes and temporary downtime of the external system. As a result, the system exhibits a technical effect of ensuring accuracy and real-time property of a response generated by the AI and suppressing generation of a response not based on facts called hallucination. Furthermore, the system consolidates data conversion processing in the external cooperation unit, thereby allowing calculation resources of the generative AI response unit to concentrate on a natural language processing task and improving calculation efficiency of the entire system. In order to ensure communication safety, the external cooperation unit implements mutual TLS authentication in all external communications, and processes encryption and decryption of a payload at high speed using a hardware accelerator. As a specific application field, the system is optimal for an integrated hub system of a global e-commerce platform that cooperates with a plurality of third-party logistics providers and various payment gateways.

The security management unit implements encrypted communication of inquiry data and customer information, access authority management, log audit, personal information protection, data masking, anonymization processing, unauthorized access detection, information leakage prevention, anonymization and aggregation processing of learning data, and the like. For example, inquiry content including personal information can be automatically masked by the AI and transferred to a human operator. Furthermore, all learning data of the AI and update histories of the knowledge base are also recorded as audit logs to prevent unauthorized access and information leakage. A specific example of a prompt text to be read by the generative AI is “Generate a Japanese text in which personal information is automatically masked from the following inquiry content. Inquiry content: ‘I want to change my address’.” Specifically, the security management unit includes an independent authentication and authorization module and a data sanitization engine based on a zero trust architecture. The security management unit acquires a raw inquiry text transmitted from the user interface unit as input data. The security management unit further acquires a metadata vector including a transmission source IP address, a device fingerprint, and a session token of the request. The security management unit hosts a lightweight transformer model specialized for named entity extraction in the data sanitization engine. The security management unit tokenizes the raw inquiry text and supplies it to an input layer of the named entity extraction model. The named entity extraction model calculates a probability that each token belongs to a confidential information category such as a name, an address, a telephone number, and a credit card number. The security management unit outputs, as output data, a sanitized text in which a token determined to be confidential information is replaced with a specific asterisk character string, and an index array indicating a masked position. For example, the input data includes a text string “My phone number is 090-1234-5678”. The security management unit outputs, as output data, a sanitized text “My phone number is ***-****-****” and an integer array indicating a replacement position. The security management unit transfers only this sanitized text to the subsequent generative AI response unit and trend learning unit, and isolates and stores the original raw text in a secure storage using a strong encryption algorithm. The security management unit executes an anomaly detection algorithm using the metadata vector, and scores a behavior deviating from a normal access pattern in real time. With this configuration, the system fundamentally eliminates a risk of personal information being mixed into learning data of a large language model. As a result, the system exhibits a technical effect of automatically achieving strict compliance with data privacy regulations and reducing an enormous business risk due to information leakage. Furthermore, the system executes masking processing with a dedicated lightweight model, thereby completing a security check with low latency without consuming calculation resources of the main generative AI model. The named entity extraction model is fine-tuned to maximize accuracy of token classification using a synthetic data set including personal information in various formats. As a specific application field, the system is optimal for a patient support system of a medical institution to which strict data protection laws are applied, and an automatic response system in online banking of a financial institution.

The operation management unit can centrally manage confirmation of content of the knowledge base, monitoring of response accuracy of the AI, browsing of a trend analysis result, confirmation of an escalation history, monitoring of a system operation status, alert notification at the time of failure occurrence, batch update of FAQs, batch registration of campaign information, management of external cooperation settings, authority management of an operator, and the like from an administrator terminal. For example, when the response accuracy of the AI falls below a certain standard, the administrator can be automatically notified to prompt a review of the knowledge base and relearning of the AI model. A specific example of a prompt text to be read by the generative AI is “Generate a Japanese message for notifying an administrator when response accuracy of the AI decreases.” Specifically, the operation management unit functions as an integrated monitoring engine that collects telemetry data of the entire system and executes statistical analysis. The operation management unit acquires a time-series array of generation reliability scores of each response output from the generative AI response unit as input data. The operation management unit further acquires a numerical vector indicating an escalation occurrence frequency output from the escalation unit, and hardware metrics indicating a CPU usage rate and a memory consumption amount of each calculation node. The operation management unit aggregates these multidimensional data and calculates a moving average and a standard deviation in a certain time window. The operation management unit continuously evaluates whether the calculated statistic deviates from a predefined normal range using a statistical anomaly detection algorithm. For example, the input data includes numerical data of an average value of 0.75 of response reliability scores and an escalation rate of 15 percent in the past one hour. The operation management unit outputs, as output data, a comprehensive health score in a range of 0 to 100 indicating soundness of the entire system, and diagnostic report data for identifying a root cause of an anomaly. For example, the output data includes an integer value of a health score of 82, and a structured alert object indicating “decrease in search hit rate in a specific category of the knowledge base”. When the health score falls below a threshold, the operation management unit transmits an immediate push notification to the administrator terminal, and simultaneously issues a control signal that automatically triggers a relearning pipeline of the AI model. With this configuration, the system quantitatively visualizes inference performance of an AI model that is likely to become a black box, and detects performance degradation at an early stage. As a result, the system exhibits a technical effect of significantly reducing man-hours for an administrator to manually analyze a log, and minimizing system downtime and deterioration of response quality. Furthermore, the system autonomously executes auto-scaling of a cloud infrastructure based on a depletion prediction of hardware resources. The operation management unit compresses and stores the collected telemetry data in a time-series database, enabling long-term performance trend analysis. As a specific application field, the system is optimal for an operation monitoring infrastructure of a large-scale cloud-native application composed of thousands of servers, and an integrated management console of a mission-critical enterprise system. The system automates failure isolation in a complex microservice architecture, and dramatically improves efficiency of operation and maintenance.

The user interface unit is realized by various devices such as a web browser, a smartphone application, a chat application, a voice recognition terminal, a kiosk terminal, a smart speaker, and a wearable terminal used by a customer, and provides various functions such as inquiry input, display of an automatic response by AI, a chat screen with an operator at the time of escalation, FAQ search, voice guidance, push notification, file attachment, inquiry by image recognition, gift designation, review posting, order history display, point balance display, coupon use, and gift wrapping designation. For example, when a customer inputs “Tell me the payment method” in a chat window, the generative AI generates a response on the server side, and immediately displays a response such as “Credit card, electronic payment service, and bank transfer are available” on the terminal side. A specific example of a prompt text to be read by the generative AI is “Generate a Japanese response text easy for a customer to understand by referring to FAQs for the following inquiry content. Inquiry content: ‘Tell me the payment method’.” Specifically, the user interface unit is composed of a lightweight front-end application operating on a client terminal and an edge node managing asynchronous communication on the server side. The user interface unit acquires, as input data, tap coordinate data of a touch screen transmitted from a customer's terminal, a keystroke event of a keyboard, or continuous voice waveform data acquired from a microphone. When receiving voice waveform data, the user interface unit extracts an acoustic feature amount and converts it into a text character string using a built-in voice recognition neural network. The user interface unit further acquires, as input data, an image tensor indicating a defective part of a product photographed by a customer with a camera of a smartphone. The user interface unit packages these multimodal input data into a standardized JSON format payload that can be processed on the server side, and transmits it to the server through a secure WebSocket connection. For example, the input data includes a one-dimensional array of voice sampled at 16 kHz, and an integer pair indicating XY coordinates on a screen. The user interface unit outputs, as output data, a response text returned from the generative AI response unit on the server side, and UI component state data for controlling rendering of a screen. For example, the output data includes a text character string “Tell me the payment method” and a Boolean flag that triggers an animation of a chat bubble. The user interface unit dynamically updates a document object model on a screen of the client terminal based on the received output data, and provides visual or audio feedback to the customer. With this configuration, the system provides a smooth and highly responsive user experience without being affected by network delay or bandwidth limitation. As a result, the system exhibits a technical effect of reducing customer frustration and improving a self-resolution rate. Furthermore, the system significantly reduces a calculation load and communication traffic on the server side by preprocessing unstructured data such as an image and voice on the edge side. The voice recognition neural network is subjected to robust learning using a data augmentation method in order to maintain high recognition accuracy even in a noisy environment. As a specific application field, the system is optimal for a guidance kiosk terminal of a public transportation facility used by users of various age groups, and an in-vehicle infotainment system requiring hands-free operation.

As described above, the system according to the present embodiment includes the inquiry receiving unit, the priority determining unit, the generative AI response unit, the escalation unit, the knowledge base management unit, the trend learning unit, the product information management unit, the order information management unit, the external cooperation unit, the security management unit, the operation management unit, and the user interface unit, and by operating in cooperation with each other, it is possible to consistently realize autonomous and efficient handling centered on generative AI, expansion of a knowledge base, trend analysis, personalization, external cooperation, security, operation management, response to an abnormality, data protection, and industry customization for various customer inquiries on an e-commerce site. Specifically, the system adopts a microservice architecture in which each functional module is deployed as an independent container. The system executes data communication between the modules by an asynchronous event-driven method via a distributed messaging queue. The system acquires thousands of transaction requests per second generated from the user interface unit as input data. The system publishes these requests to a topic of the messaging queue, and the priority determining unit and the generative AI response unit pull messages according to their own processing capabilities. The system generates an event payload including a processing result in each module as output data, and relays it to a module responsible for the next processing. For example, the input data is a text vector including content of a customer inquiry, and the output data includes a finally generated response text and index information of an updated database. When detecting a rapid increase in traffic, the system dynamically scales out the number of replicas of a specific module that is a bottleneck using a container orchestration tool. With this configuration, the system realizes extremely high availability and scalability without having a single point of failure. As a result, the system exhibits a technical effect of preventing a stop of the entire system even when a failure occurs in some modules, and guaranteeing continuous service provision. Furthermore, since each module is loosely coupled, the system can execute functional expansion such as introduction of a new AI model or addition of an external system without stopping and without affecting other modules. In order to manage a state of the entire system, the system visualizes a processing path and latency of each request using a distributed tracing technology. As a specific application field, the system is optimal for an integrated customer support infrastructure of a global cloud service continuously accessed 24 hours a day, 365 days a year by users all over the world. The system provides flexible processing capability for unpredictable load fluctuations and various data formats, which was difficult to handle with a conventional monolithic system.

### Implementation Steps

### Step 1: Inquiry Reception

When a customer makes an inquiry through various devices such as a web browser, a smartphone application, a chat application, a voice recognition terminal, a kiosk terminal, a smart speaker, and a wearable terminal, the inquiry receiving unit receives content of the inquiry in a data format such as text, voice, and image, and transmits it to a server together with additional information such as a reception time, a customer ID, a terminal type, an inquiry channel, position information, language information, and device information. For example, inquiries in various formats are received, such as when a customer inputs “Tell me recommended products” on a chat screen, when a customer speaks “The product I just ordered has not arrived” to a voice recognition terminal, and when a customer transmits a photograph saying “I want you to see a defective part of this product” using an image attachment function. When the content of the inquiry is unclear or an input error is suspected, a re-input request message such as “Please enter the content of your question in a little more detail”, “Please enter the product name accurately”, or “Please specify which order your question is about” is automatically generated using the generative AI and returned to the terminal side. A specific example of a prompt text to be read by the generative AI is “Generate a polite Japanese message for requesting a customer to re-input when the following inquiry content is unclear. Inquiry content: ‘Not arrived’.” Specifically, the inquiry receiving unit functions as an asynchronous IO server supporting multi-thread processing. The inquiry receiving unit acquires a multimodal data stream transmitted from a client terminal as input data. The inquiry receiving unit analyzes header information of the received data, and determines whether a data format is text, voice, or image. The inquiry receiving unit dynamically allocates an appropriate preprocessing pipeline according to the data format. In the case of text data, the inquiry receiving unit executes normalization of a character code and removal of a special character. In the case of image data, the inquiry receiving unit executes downscaling of resolution and conversion into a tensor format. The inquiry receiving unit further converts GPS coordinate data and a timestamp transmitted as additional information into a standardized numerical format. For example, the input data includes image binary data in a JPEG format, and a pair of floating-point numbers indicating latitude and longitude. The inquiry receiving unit outputs, as output data, a multidimensional tensor of inquiry content for which preprocessing has been completed, and a structured object including normalized metadata. For example, the output data includes an image tensor of 224×224×3, and a unique hash character string indicating a customer ID. The inquiry receiving unit pushes the generated structured object to an input queue of the subsequent priority determining unit. When the number of characters of an input text is extremely small, or when an image is unclear and feature amount extraction is difficult, the inquiry receiving unit immediately sets a flag for a re-input request using a lightweight rule-based engine. With this configuration, the system converts enormous and non-uniform data asynchronously transmitted from various devices into a unified mathematical expression that can be processed by a subsequent AI model at high speed. As a result, the system exhibits a technical effect of preventing a system error due to a mismatch of data formats and improving stability of the entire processing pipeline. Furthermore, the system filters invalid data and noise at an initial stage, thereby reducing useless inference execution of a large language model having a high calculation cost. As a specific application field, the system is optimal for an omnichannel contact center system in which not only text chat but also voice call and photograph posting are frequently performed.

### Step 2: Priority Determination

The priority determining unit analyzes the received content of the inquiry using generative AI and natural language processing technology, extracts keywords and contexts such as “cancellation”, “return”, “urgent”, “delay”, “defective product”, “payment error”, “personal information leak”, “claim”, “high-priced order”, and “corporate customer”, and automatically determines urgency and importance of the inquiry. For example, a priority is automatically assigned such that inquiries such as “I want to cancel my order”, “I want to return a product”, “I cannot pay”, “The product was broken”, and “Personal information may have been leaked” are given the highest priority, “I want to know the delivery status”, “I want to change the order content”, and “I want a receipt to be issued” are given a medium priority, and “Tell me recommended products”, “I want to know information on new products”, and “I want to write a review” are given a normal priority. Even when a plurality of inquiries occur simultaneously, the generative AI comprehensively evaluates various factors such as the content of each inquiry, customer attributes, a past handling history, an order amount, and whether or not it is during a campaign period, and manages a task queue so as to process the inquiries in descending order of priority. A specific example of a prompt text to be read by the generative AI is “Determine urgency and importance included in the following inquiry content, and output a priority as a numerical value. Inquiry content: ‘The product was broken’.” Specifically, the priority determining unit is an inference engine that hosts a pre-trained language model specialized for text classification. The priority determining unit acquires an embedding vector of a text output from the inquiry receiving unit as input data. The priority determining unit further acquires a scalar value indicating a past total purchase amount of a customer, and a numerical vector indicating a current system load status. The priority determining unit combines these data and supplies them to an input layer of a classification model. The classification model calculates a degree of influence of each word in the input text on urgency as an attention weight using a self-attention mechanism. The classification model inputs a high-dimensional vector capturing features of the entire context to a fully connected layer, and applies a softmax function to calculate a probability of belonging to each priority class. The priority determining unit outputs, as output data, a priority score that is a continuous value in a range of 0.0 to 1.0, and an index value indicating an insertion position of a task queue. For example, the input data includes a 768-dimensional vector of a text “The product was broken”, and a normalized numerical value indicating a total purchase amount. The priority determining unit outputs, as output data, a numerical value of a priority score of 0.95, and a category label indicating “highest priority queue”. The priority determining unit routes the inquiry data to any of a plurality of priority-specific queues in a messaging system based on the calculated priority score. With this configuration, the system identifies a subtle difference in urgency depending on a context, which cannot be determined by simple keyword matching, with high accuracy. As a result, the system exhibits a technical effect of dynamically concentrating limited operators and calculation resources on the most critical issue, and minimizing a serious customer defection and a risk of compensation for damages. Furthermore, the system functions as a traffic control mechanism that prevents a crash of the entire system by temporarily delaying a low-priority task at the time of high load. The classification model is fine-tuned to minimize a cross-entropy error using a past handling history and a priority label assigned by a human operator. As a specific application field, the system is optimal for a crisis management response system in which a large number of inquiries suddenly flood, such as when a disaster occurs or when a large-scale recall is announced.

### Step 3: Automatic Response Generation

The generative AI response unit integrates information acquired from a knowledge base, the product information management unit, the order information management unit, and the external cooperation unit for the content of the inquiry, and automatically generates an optimal response text using the generative AI. For example, in response to an inquiry “Tell me recommended products”, a customer's purchase history, browsing history, cart information, campaign information, inventory status, review evaluation, purchase trend of similar customers, seasonality, trend information, and the like are comprehensively analyzed, and a personalized proposal such as “Recommended products for you are A, B, and C. Now B is on discount. A has a high review evaluation, and C has only a few in stock” is automatically generated. In response to an inquiry “I want to know the delivery status”, the latest delivery status of the corresponding customer is acquired from the order information management unit, and a real-time response such as “Your ordered product is currently being delivered and is scheduled to arrive tomorrow. The delivery company is Company X, and the slip number is 123456” is returned. In response to an inquiry such as “I want to return a product” or “I want to cancel”, a procedure method and conditions are extracted from the knowledge base, and specific guidance such as “Return can be applied from My Page within 14 days after the product arrives. Food and opened products are not eligible for return” and “Cancellation of an order is possible before shipping. If it has been shipped, please use the return procedure” is provided. A specific example of a prompt text to be read by the generative AI is “Generate the most appropriate Japanese response text by referring to a knowledge base, product information, and order information for the following inquiry content. Inquiry content: ‘I want to return a product’.” Specifically, the generative AI response unit executes an advanced inference pipeline adopting a retrieval-augmented generation architecture. The generative AI response unit acquires a token string of an inquiry text routed from the priority determining unit as input data. The generative AI response unit uses this text vector as a query to execute an approximate nearest neighbor search on a vector database of the knowledge base management unit. The generative AI response unit acquires a text chunk of a related document obtained as a search result. The generative AI response unit further acquires structured data indicating a real-time inventory quantity and delivery status acquired from the external cooperation unit. The generative AI response unit uses a prompt engineering module to combine the inquiry text, the searched document chunk, and the structured data according to a specific template to construct a long context prompt. For example, the input data includes a text “I want to return a product”, a text chunk of “return policy” hit by a vector search, and a timestamp indicating an order date of a customer. The generative AI response unit supplies this context prompt to an input layer of a large language model. The large language model is a transformer network having billions of parameters, calculates a self-attention weight of an input context, and autoregressively predicts an optimal token to appear next. The generative AI response unit outputs, as output data, a generated natural language response text, and a reliability score that is an average value of logarithmic probabilities in each generation step. For example, the output data includes a text character string “Return is possible within 14 days after the product arrives”, and a floating-point number of a reliability score of 0.92. The generative AI response unit passes the generated response text to a subsequent reliability determination process. With this configuration, the system enables a large language model to generate an accurate response based on the latest company-specific information and personal transaction data not included in learning data. As a result, the system exhibits a technical effect of dramatically reducing factual errors and hallucinations, and providing practical and highly reliable support to a customer. Furthermore, since the system can keep response content up-to-date only by updating an external database without relearning a model itself, an operation cost is significantly reduced. As a specific application field, the system is optimal for a customer portal of a large-scale retail business in which a product lineup and campaign information fluctuate daily.

### Step 4: Reliability Determination and Escalation

A reliability of a response generated by the generative AI response unit is determined, and a matching degree with a knowledge base, a past response record, complexity of inquiry content, customer attributes, an order amount, a risk degree, and the like are comprehensively evaluated. For example, in the case of a non-standardized inquiry such as “This inquiry has no corresponding information in the knowledge base, and uncertainty is high in AI inference”, “I want to return a plurality of products at the same time, but some are already opened”, “Special handling of overseas delivery”, “Defect of a high-priced product”, “Suspicion of personal information leak”, and “Claim requiring legal action”, the escalation unit provides guidance such as “We will connect you to an operator”, and transmits inquiry content, customer information, a provisional response generated by AI, a past handling history, related order information, product information, risk evaluation, and the like to an operator terminal. A specific example of a prompt text to be read by the generative AI is “Generate a Japanese message recommending escalation to an operator when there is no corresponding information in a knowledge base for the following inquiry content. Inquiry content: ‘I want to consult about special handling of overseas delivery’.” Specifically, the escalation unit is a calculation module that executes a multivariate evaluation algorithm based on ensemble learning. The escalation unit acquires a generation reliability score of a response text output from the generative AI response unit as input data. The escalation unit further acquires a maximum cosine similarity score at the time of knowledge base search, an integer value indicating the number of past claims of a customer, and a floating-point number indicating a price of a target product. The escalation unit normalizes these heterogeneous metrics and combines them into a single feature amount vector. For example, the input data includes a numerical group of a generation reliability of 0.65, a search similarity of 0.40, the number of claims of 3, and a product price of 50000. The escalation unit supplies this feature amount vector to an input layer of a gradient boosting decision tree model. The gradient boosting decision tree model connects a plurality of weak learners in series, evaluates a non-linear interaction of each feature amount, and calculates a final risk probability. The escalation unit outputs, as output data, a binary flag indicating necessity of escalation, and a category code indicating a root cause of a risk. For example, the output data includes a flag value 1 indicating that escalation is required, and an error code indicating “low search similarity and high-priced product”. When the flag value is 1, the escalation unit discards or suspends the generated response text, and transfers all context data to a routing queue in which a human operator waits while maintaining a session state of the customer. With this configuration, the system determines escalation by multilaterally evaluating a business context and customer attributes instead of depending on a single reliability score. As a result, the system exhibits a technical effect of effectively blocking a case where AI confidently generates a wrong response, and preventing a loss of brand reliability. Furthermore, the system significantly shortens a handling time after handover by structuring and presenting a reason for escalation and related data to an operator. The gradient boosting decision tree model is periodically relearned to minimize a logarithmic loss using past escalation cases and operator feedback. As a specific application field, the system is optimal for a customer support system in an insurance industry or a securities industry in which legal regulations are strict and one wrong answer leads to a serious compliance violation.

### Step 5: Update and Expansion of Knowledge Base

The knowledge base management unit updates the knowledge base as needed by integrating the content of the inquiry, a response history, new information from the outside, manual addition/modification by an administrator, legal revision, campaign information, product specification change, FAQ update, information from an external information source, and the like. For example, by adding information such as “a new electronic payment service has become available”, “a return policy has been changed”, “a new product has been added”, “a delivery company has been changed”, “a campaign period has been extended”, and “a receipt issuing method has been changed due to legal revision” to the knowledge base, the AI can immediately handle customers based on the latest information. A response automatically generated by the generative AI and a frequently occurring inquiry detected by the trend learning unit are also automatically added to the knowledge base. As a specific example of a prompt text to be read by the generative AI, “Analyze the inquiry history of the past week, extract frequently occurring new inquiry content and its response, and list new items to be added to the knowledge base in Japanese.” can be cited. Specifically, the knowledge base management unit is a background worker process that executes automatic structuring of unstructured text and dynamic reconstruction of a vector index. The knowledge base management unit acquires, as input data, a new manual file in a PDF format uploaded from an administrator terminal or a new frequently occurring inquiry text transmitted from the trend learning unit. The knowledge base management unit extracts text data from the input file using optical character recognition technology and natural language processing technology, and chunks the text data for each semantic paragraph. The knowledge base management unit inputs each chunk into a document embedding model to generate a high-dimensional dense vector. For example, the input data includes a text string “YPay has been added as a new electronic payment service”. The knowledge base management unit outputs, as output data, a 768-dimensional floating-point array expressing the meaning of this text. The knowledge base management unit inserts the generated vector into an existing vector database. In the insertion process, the knowledge base management unit updates node connections of a hierarchical navigable small world graph and reconstructs a searchable index. The knowledge base management unit further periodically executes a garbage collection process using a time stamp and an expiration date flag in order to specify a vector including old information. With this configuration, the system completely eliminates the trouble of a human administrator manually changing a schema of a database or registering a search keyword. As a result, the system exhibits a technical effect of dramatically shortening a time lag until the latest information in a company is reflected in an AI response from several days to several minutes. Furthermore, the system automatically prevents duplicate registration of information having different expressions but the same meaning by similarity calculation on a vector space, and suppresses bloat of the database. The document embedding model is pre-trained using a domain-specific corpus, and accurately maps industry-specific technical terms and abbreviations to the vector space. As a specific application field, the system is optimal for a help desk system of a software development company or a SaaS provider in which product version upgrades are frequently performed and support documents are updated daily.

### Step 6: Trend Analysis and Automatic Learning

The trend learning unit analyzes an appearance frequency and a trend of the content of the inquiry and a purchasing trend in real time, and analyzes a past inquiry history and customer behavior data in chronological order. For example, trends such as “return inquiries for a specific brand have increased to three times the normal level this week”, “questions regarding discount conditions are occurring frequently after the start of a new campaign”, “inquiries about seasonal products are rapidly increasing”, “inquiries about delivery delays are concentrated in a specific region”, and “inquiries about products talked about on SNS are rapidly increasing” are automatically detected. The detected trend information is transmitted to the knowledge base management unit, and a new FAQ or troubleshooting guide is automatically generated and registered as needed. As a specific example of a prompt text to be read by the generative AI, “Analyze the inquiry history of the past 30 days in chronological order, and summarize rapidly increasing inquiry content and its background factors in Japanese.” can be cited. Specifically, the trend learning unit is a real-time analysis module combining a stream data processing engine and a time-series anomaly detection algorithm. The trend learning unit acquires, as input data, a stream of hash values of keywords extracted from all text data passing through the inquiry receiving unit, and time stamps indicating occurrence times thereof. The trend learning unit aggregates a keyword appearance frequency within a certain time frame using a sliding window method to generate a multidimensional frequency vector. The trend learning unit supplies this frequency vector to an input layer of an autoencoder-based anomaly detection neural network. The autoencoder performs a process of compressing input data into a low-dimensional latent space and then reconstructing it to the original dimension. The trend learning unit calculates a reconstruction error between the input vector and the reconstructed vector, and uses this as an anomaly score. For example, the input data includes a 1000-dimensional integer vector indicating the number of appearances of 1000 types of keywords in the past hour. The trend learning unit outputs, as output data, an index of a specific keyword whose reconstruction error exceeds a statistical threshold, and its anomaly score. For example, the output data includes an index value corresponding to “return of a specific brand” and a numerical value of an anomaly score of 4.2. The trend learning unit extracts a sample of an inquiry text related to the keyword in which the anomaly is detected, and extracts a topic using a clustering algorithm. The trend learning unit transmits the extracted topic information as structured JSON data to the knowledge base management unit and an operation management unit. With this configuration, the system autonomously discovers an unknown trouble or an unexpected customer reaction in a data-driven manner without depending on a predefined monitoring rule. As a result, the system exhibits a technical effect of supporting rapid decision-making and execution of countermeasures before a problem develops into a large-scale flaming or serious customer defection. Furthermore, by using the autoencoder, the system can detect an unknown anomaly only by learning a normal pattern, thereby reducing the cost of preparing labeled anomaly data. As a specific application field, the system is optimal for a customer insight analysis system of a cosmetics industry in which demand changes suddenly with a single post by an influencer, or a home appliance manufacturer that needs to quickly identify an initial defect immediately after the release of a new product.

### Step 7: Response/Notification to Customer

A user interface unit immediately displays a response text received from the generative AI response unit or the escalation unit or a reply from a human operator on a terminal such as a web browser, a smartphone application, a chat application, a voice recognition terminal, a kiosk terminal, a smart speaker, or a wearable terminal. For example, when “Tell me the payment method” is input into a chat window, the generative AI generates a response on the server side, and immediately displays a response such as “Credit cards, electronic payment services, and bank transfers are available” on the terminal side. When an escalation occurs, the screen automatically switches to a chat screen with a human operator on the terminal side, and the customer and the human operator can directly interact with each other. Voice input and multilingual support are also supported, and a response can be returned in English to a foreign customer. Specifically, the user interface unit is a presentation layer integrating a server push technology and a client-side dynamic rendering engine. The user interface unit acquires, as input data, a response payload in a JSON format transmitted from a messaging broker on the server side. The response payload includes a generated response text, metadata for display, and a status code indicating an escalation state. The user interface unit evaluates the status code and controls screen transition of the client terminal and a display state of a UI component. For example, the input data includes a text string “Credit cards are available” and a status code 200 (normal response). The user interface unit generates, as output data, an HTML element or a view object of a native application drawn on a display of the client terminal. When the status code indicates 300 (escalation), the user interface unit hides a chat bubble for automatic response and establishes a WebRTC connection for real-time communication with a human operator. The user interface unit further includes a function of dynamically translating and displaying the response text on the client side based on locale information acquired from terminal settings of the customer, or a function of calling a text-to-speech API to generate voice waveform data and outputting it from a speaker. With this configuration, the system provides a seamless and intuitive dialogue interface without making the customer aware of complex AI processing or routing switching on the back end. As a result, the system exhibits a technical effect of reducing a cognitive load on the customer and improving satisfaction of the entire support experience. Furthermore, by using an asynchronous communication protocol, the system prevents the UI of the client terminal from freezing even when a processing delay occurs on the server side, and provides appropriate feedback through a loading animation or the like. The user interface unit implements a mechanism of caching the latest dialogue history in a local storage in preparation for network disconnection, and automatically restoring the state upon reconnection. As a specific application field, the system is optimal for an e-commerce application for smartphones used under a mobile network with an unstable communication environment, or a guidance kiosk terminal at an international airport where multilingual support is essential.

### Specific Use Case

For example, on a mail-order site, when a customer uses a chat function of a smartphone application to inquire “The ordered product has not arrived”, the inquiry receiving unit receives this text data and transmits it to the server together with additional information such as a reception time, a customer ID, a terminal type, a channel type, and position information. The priority determining unit analyzes keywords such as “not arrived” and “order” and a context using the generative AI, determines that there is a high possibility of a delivery trouble, and assigns a high priority. As a specific example of a prompt text to be read by the generative AI, “Determine the presence or absence of a delivery trouble and a degree of urgency from the following inquiry content, and explain the reason in Japanese. Inquiry content: ‘The ordered product has not arrived’” can be cited. Specifically, the system processes this series of processes as an event-driven pipeline executed with a latency in milliseconds. The inquiry receiving unit acquires, as input data, a JSON payload transmitted via an HTTPS request from the smartphone application. The payload includes a UTF-8 encoded text string “The ordered product has not arrived” and a 256-bit hash value uniquely identifying the customer. The inquiry receiving unit inputs this text string into a tokenizer and converts it into a token ID list which is an array of numerical values. The priority determining unit acquires this token ID list as input data and supplies it to an input layer of a pre-trained transformer encoder model. The transformer encoder model calculates a syntactic dependency in which a predicate “not arrived” modifies an object “product” on a high-dimensional space using a multi-head attention mechanism. The priority determining unit outputs, as output data, a score value of 0.98 indicating a probability of belonging to a delivery trouble category, and a score value of 0.95 indicating a degree of urgency. The priority determining unit detects that these score values exceed a preset threshold of 0.80, and adds a metadata tag of “high priority” to the request. The priority determining unit immediately pushes the tagged request object to a highest priority processing queue on an in-memory data grid. With this configuration, the system automates triage of requests based on deep semantic understanding of the context, rather than simple character string matching. As a result, the system exhibits a technical effect of preventing development into a complaint by pouring an inquiry about a delivery delay, which causes strong anxiety to the customer, into a processing pipeline with priority over a general product question. Furthermore, by executing the triage process with a lightweight encoder model, the system realizes efficient routing before calling a generative model with a high calculation cost, and suppresses waste of server resources. As a specific application field, the system is optimal for an online store system of a major department store that needs to handle enormous traffic during a gift season such as mid-year gifts or year-end gifts when a delivery delay becomes a fatal problem.

The generative AI response unit acquires an order history and a delivery status of the corresponding customer from an order information management unit, refers to the latest data of a delivery management system through an external cooperation unit, integrates past similar cases and FAQs from the knowledge base, and automatically generates a specific and situation-adapted response text such as “The ordered product is currently being delivered by a delivery company and is scheduled to arrive tomorrow. The delivery slip number is 123456. You can also check the delivery status on My Page” using the generative AI. As a specific example of a prompt text to be read by the generative AI, “Generate a response text in Japanese that can reassure the customer by referring to order information and data of the delivery management system for the following inquiry content. Inquiry content: ‘The ordered product has not arrived’” can be cited. Specifically, the generative AI response unit functions as an orchestration engine that integrates information asynchronously collected from a plurality of data sources and constructs a dynamic prompt. The generative AI response unit acquires, as input data, an inquiry text vector passed from the priority determining unit. The generative AI response unit issues a query to a database of the order information management unit using the customer ID as a key, and acquires an internal status code of the corresponding order. The generative AI response unit simultaneously calls a third-party delivery API via the external cooperation unit, and acquires the latest GPS tracking data and a time stamp of an estimated arrival date and time. The generative AI response unit converts these structured data into a natural language context, and combines them with the inquiry text as an input prompt for a large language model. For example, the input data includes a set of key-value pairs: “Inquiry: Product has not arrived”, “Order status: Shipped”, “Delivery company: Company X”, “Slip number: 123456”, and “Estimated arrival: Tomorrow”. The large language model processes this complex input prompt and generates a contextually natural and fact-based response text through an autoregressive decoding process. The generative AI response unit outputs, as output data, a text string “The ordered product is currently being delivered and is scheduled to arrive tomorrow. The slip number is 123456”, and a probability tensor indicating a certainty factor of each generated word. The generative AI response unit verifies whether an essential variable such as a slip number is correctly included in the generated text using a regular expression filter. With this configuration, the system autonomously generates a highly personalized response combining customer-specific transaction data and external real-time data, without being limited to presenting a static FAQ. As a result, the system exhibits a technical effect of saving the customer the trouble of transitioning through a plurality of screens to search for information, and solving a problem in a one-stop manner. Furthermore, the system completely replaces the work of a human operator logging into a plurality of systems to collate information, and dramatically shortens a handling time per case from several minutes to several seconds. The large language model is fine-tuned using a human feedback method from reinforcement learning in order to maintain a tone and manner unique to a company. As a specific application field, the system is optimal for an integrated customer support system of a large-scale online marketplace where a large number of third-party sellers list products and delivery routes tend to be complicated.

In the reliability determination, when corresponding data does not exist in the delivery management system or when uncertainty in AI inference is high, the escalation unit generates a message such as “We will connect you to a human operator. We apologize for the inconvenience, but please check your order number and order details again”, and transfers the content of the inquiry, customer information, a provisional response generated by the AI, a past response history, and the like to a human operator terminal. As a specific example of a prompt text to be read by the generative AI, “Generate a Japanese message recommending escalation to a human operator when delivery information cannot be acquired for the following inquiry content. Inquiry content: ‘The ordered product has not arrived’” can be cited. Specifically, the reliability determination unit converts input text data into a multidimensional word embedding vector. The large language model processes the vector and outputs a probability distribution and a reliability score of each generated token. The escalation unit transfers data to a subsequent manned handling module when the score is less than a predetermined threshold. Thereby, the system suppresses an uncertain automatic response and improves accuracy of customer handling.

Also, for example, when a customer inquires “Tell me recommended products”, the generative AI response unit comprehensively analyzes a purchasing history, a browsing history, cart information, campaign information, an inventory status, a review evaluation of the customer, a purchasing trend of similar customers, seasonality, trend information, and the like, and automatically generates a personalized proposal such as “Recommended products for you are A, B, and C. B is currently on discount. A has a high review evaluation, and C has only a few left in stock”. As a specific example of a prompt text to be read by the generative AI, “Generate an optimal product recommendation text in Japanese based on the following customer attributes, purchasing history, inventory information, and campaign information. Customer attributes: female in her 30s, purchasing history: cosmetics, inventory: product A in stock, campaign: product B on discount.” can be cited. Specifically, the response unit extracts attribute data and history data of the customer as a numerical tensor. The recommendation model receives the tensor as an input, and outputs an array of fitness scores for a product group. The system extracts upper items of the scores, and inputs them to a natural language generation module to construct a final response text. Thereby, the system executes personalized information provision at high speed and with high accuracy.

Furthermore, for example, when a customer inquires “I want to return a product”, the generative AI response unit extracts a return condition and a procedure method from the knowledge base, acquires an order history of the corresponding product from the order information management unit, and provides specific guidance such as “You can apply for a return from My Page within 14 days after the product arrives. Food and opened products are not eligible for return”. As a specific example of a prompt text to be read by the generative AI, “Generate a response text explaining a return condition and a procedure method in an easy-to-understand manner in Japanese by referring to the knowledge base and order information for the following inquiry content. Inquiry content: ‘I want to return a product’” can be cited. Specifically, the response unit generates a feature vector for intent classification from an input text. The search module searches a vector database using the vector, and extracts related rule data. The generative model integrates the extracted rule data and order data of the customer, and outputs a structured response text. Thereby, the system automates a business process involving complex condition determination, and improves processing efficiency.

In this way, the system of the present invention consistently, autonomously, and efficiently executes from inquiry reception to priority determination, automatic response generation, reliability determination and escalation, update and expansion of the knowledge base, and trend analysis, and realizes high-quality customer handling utilizing the generative AI. In each use case, by appropriately designing a specific example of a prompt text to be read by the generative AI, it is possible to achieve both an optimal automatic response according to the content of the inquiry and business characteristics, and business efficiency improvement. Specifically, the system executes each processing module in parallel on a distributed processing cluster composed of a plurality of calculation nodes. The control unit monitors a data flow between the modules, and dynamically allocates calculation resources according to a load status. The learning unit periodically updates a weight parameter of a model using an accumulated input/output log. Thereby, the system achieves both continuous accuracy improvement and stable large-scale processing.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

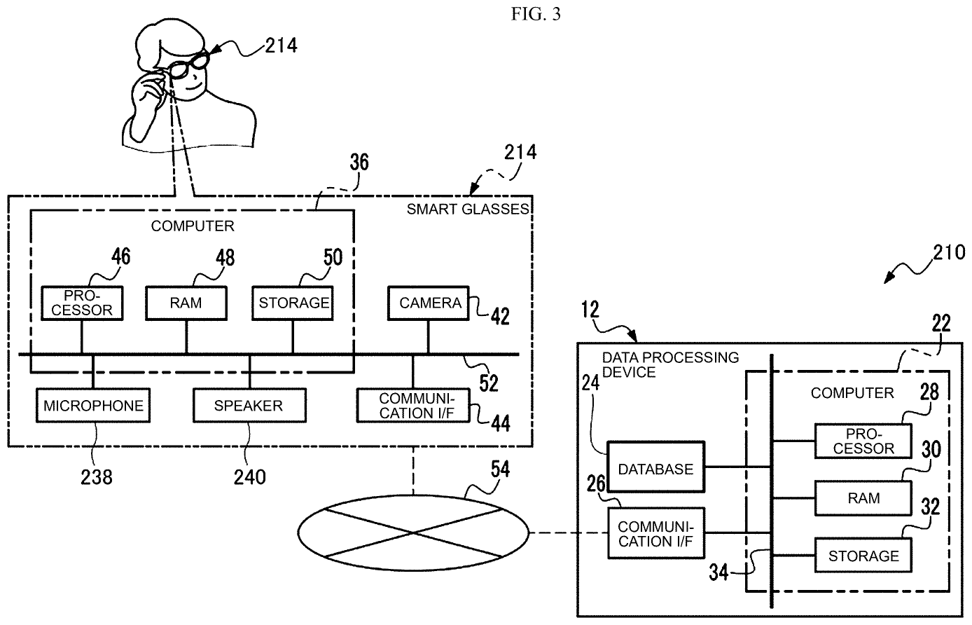

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

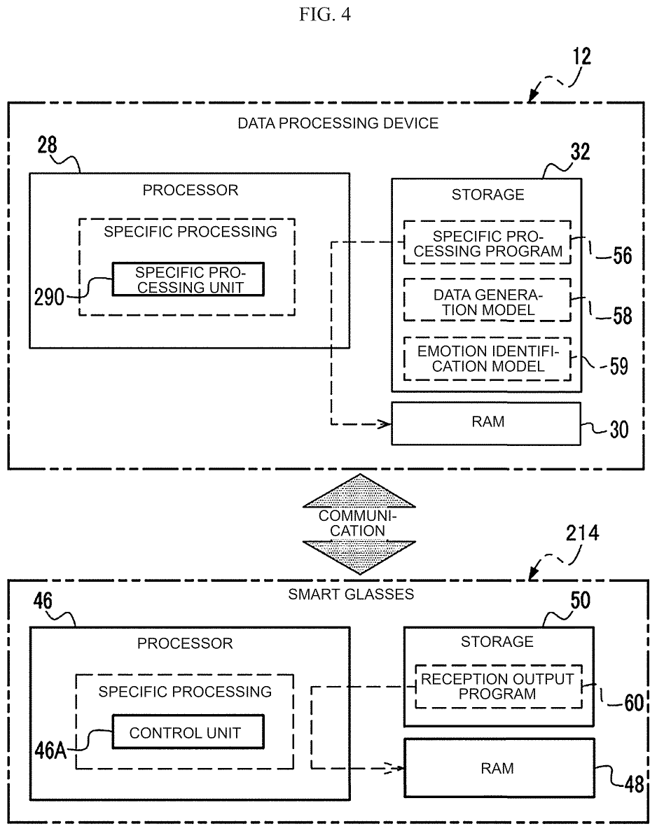

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

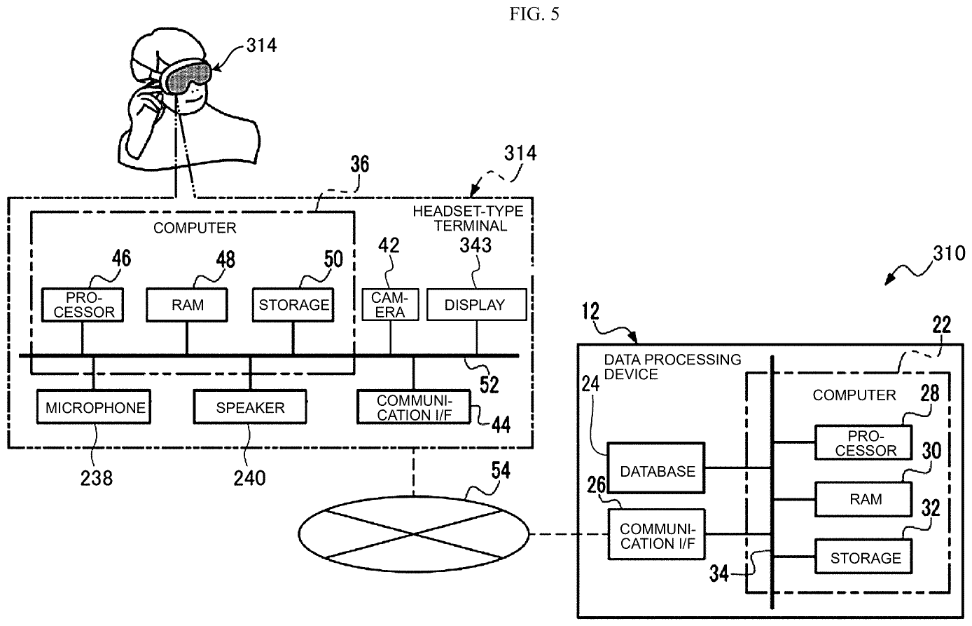

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

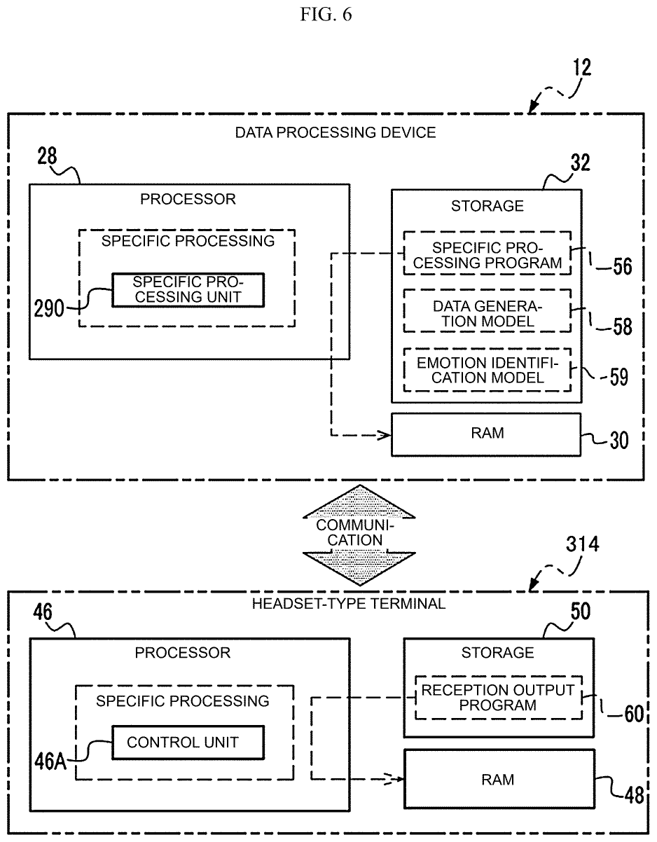

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

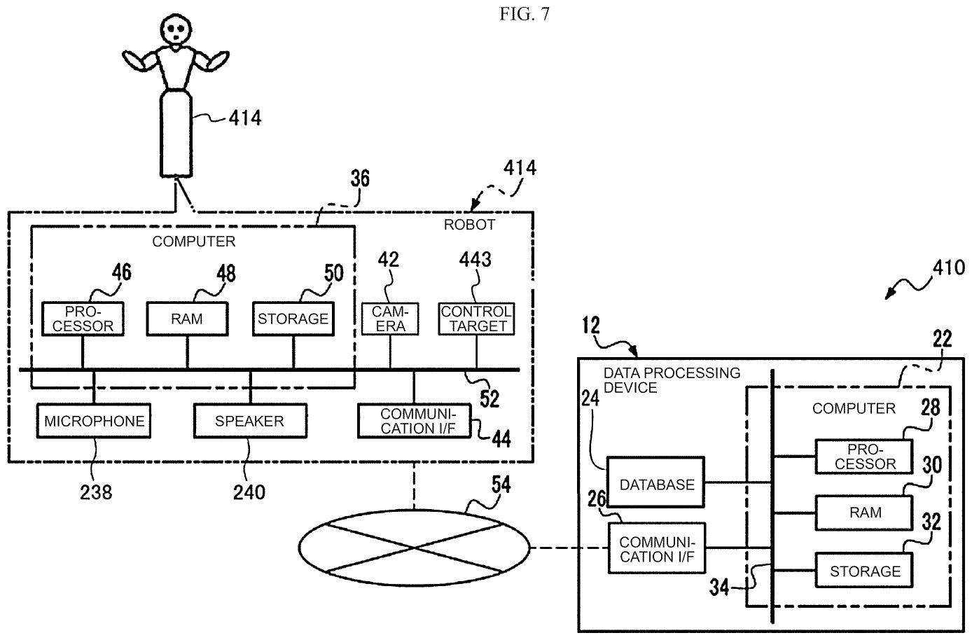

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

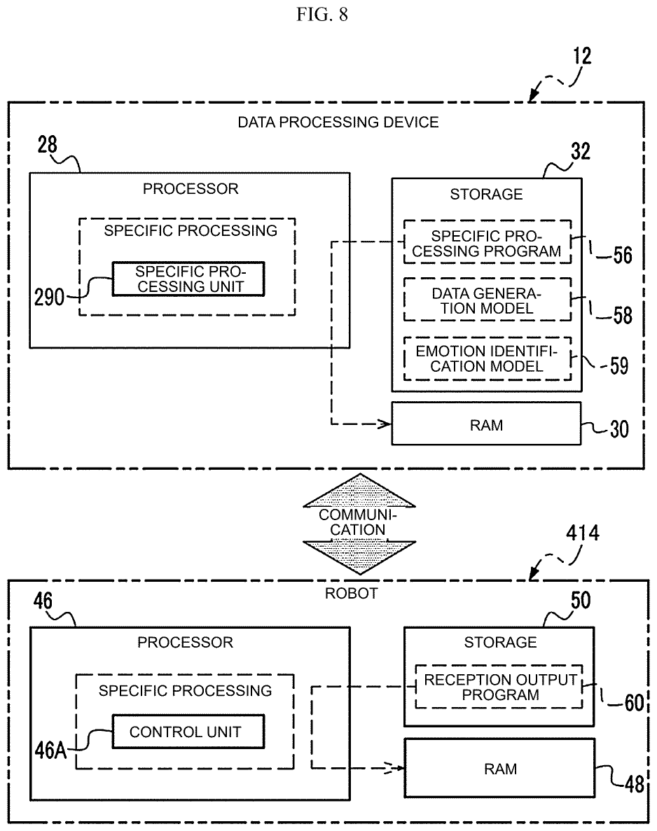

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

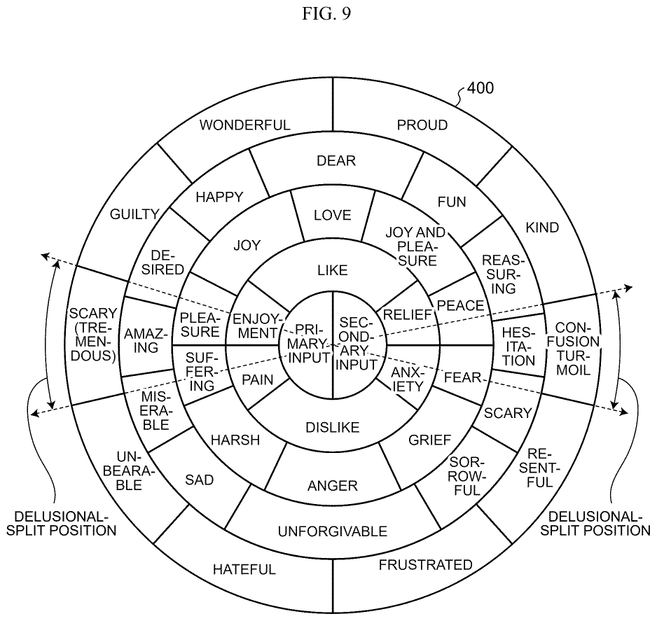

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

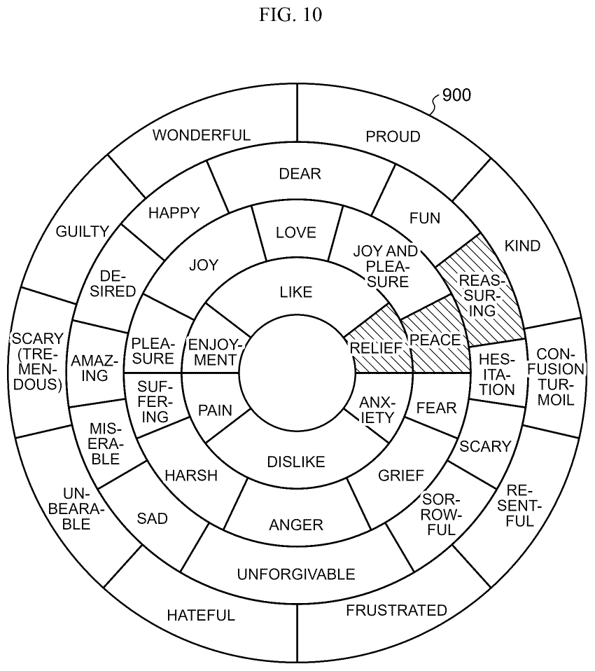

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A customer support system for an e-commerce site comprising: an inquiry receiving unit; a priority determining unit; a generative AI response unit; an escalation unit; a knowledge base management unit; a trend learning unit; a product information management unit; an order information management unit; and an external cooperation unit, wherein the inquiry receiving unit receives a customer inquiry through various devices such as a web browser, a smartphone application, a chat application, and a voice recognition terminal, and transmits the received content of the inquiry to a server together with additional information such as a customer ID, a reception time, terminal information, and a channel type; the priority determining unit analyzes urgency and importance of the content of the inquiry by natural language processing using generative AI, extracts keywords and contexts such as “cancellation”, “return”, and “delivery delay”, for example, and automatically determines a priority; the generative AI response unit integrally refers to information acquired from a knowledge base, the product information management unit, the order information management unit, and the external cooperation unit according to the content of the inquiry, and automatically generates an optimal response text, a product recommendation text, a procedure guidance text, a delivery status notification text, and the like using the generative AI; the escalation unit automatically transfers the content of the inquiry, customer information, an AI-generated response, and the like to a human operator terminal when a reliability of a response by the generative AI response unit is less than a predetermined threshold or when the content of the inquiry is complex; the knowledge base management unit updates the knowledge base as needed by integrating the content of the inquiry, a response history, new information from the outside, and an analysis result from the trend learning unit; the trend learning unit analyzes an appearance frequency and a trend of the content of the inquiry and a purchasing trend in real time, and automatically reflects a frequently occurring new inquiry and a new handling method in the knowledge base; the product information management unit manages a product database; the order information management unit manages an order history and a delivery status; the external cooperation unit acquires external data in real time by API cooperation with a payment system, a delivery management system, an inventory management system, and the like; and all these processes are autonomously and efficiently executed using the generative AI.

### Supplementary Note 2

The customer support system for an e-commerce site according to Supplementary Note 1, wherein the priority determining unit prioritizes a plurality of inquiries received by the inquiry receiving unit according to a degree of urgency and importance of the content; the generative AI response unit autonomously performs a response process in order from an inquiry having a high priority; the escalation unit escalates only a necessary inquiry to a human operator based on a reliability determination; the knowledge base management unit immediately expands and modifies the knowledge base in response to an instruction to add new information or update from an external administrator; the trend learning unit automatically detects content of inquiries and a purchasing trend frequently occurring in a short period of time and reflects them in the knowledge base; the product information management unit updates product information in response to addition of a new product or inventory fluctuation; the order information management unit manages an order history and a delivery status in real time; the external cooperation unit acquires latest information in cooperation with an external system such as payment and delivery; and all these processes are integrally executed using the generative AI.

### Supplementary Note 3

The customer support system for an e-commerce site according to Supplementary Note 1, wherein, even for new inquiry content that does not exist in the knowledge base, the product information management unit, the order information management unit, and the external cooperation unit, the trend learning unit analyzes a past inquiry history and purchasing behavior data to extract highly relevant existing information, and the generative AI response unit inferentially generates a response text and a product recommendation text using the generative AI; and the knowledge base management unit automatically registers the generated response and the inquiry content as a new knowledge base item, so as to enable the generative AI response unit to immediately provide a highly accurate automatic response to a similar inquiry thereafter.

What is claimed is:

1. A system comprising:
circuitry configured to:
receive, via a communication interface coupled to a packet-switched network, inquiry data from a terminal device via an asynchronous IO multiplexing event loop, apply a priority scoring model to the inquiry data to compute an urgency score and an importance score, and assign the inquiry data to a priority tier based on the urgency score and importance score;
retrieve candidate response records from a knowledge base vector database by computing cosine similarity scores between a query embedding vector derived from the inquiry data and stored knowledge base record embedding vectors, and apply a generative neural network model to the inquiry data and the retrieved candidate response records to generate a response text record;
compute a response reliability score for the generated response text record, and route the inquiry data to a human operator processing queue when the response reliability score falls below an escalation threshold parameter;
apply a trend analysis model to accumulated inquiry data records in the storage device to detect emerging topic frequency patterns, generate a trend report data record from the detected patterns, and update the knowledge base vector database with new knowledge base records generated from validated high-confidence response text records; and
transmit the response text record or the escalation routing data to terminal devices via the communication interface.

2. The system according to claim 1, wherein the circuitry is configured to process tens of thousands of simultaneous inquiry connections by applying asynchronous IO multiplexing using an event loop that processes a plurality of IO events per iteration, maintain per-connection session state data in a shared memory data structure, and use an inter-process communication message queuing protocol to distribute inquiry processing tasks across a plurality of processing nodes.

3. The system according to claim 2, wherein the circuitry is configured to apply the priority scoring model to the inquiry data by computing an urgency score from temporal constraint parameters and keyword urgency indicators, and an importance score from historical subject profile data associated with the inquiring terminal device user identifier, and place the inquiry in a priority-ordered processing queue.

4. The system according to claim 1, wherein the circuitry is configured to apply a multi-stage retrieval process by first selecting candidate knowledge base records using approximate nearest neighbor indexing, then applying a cross-encoder relevance model to rerank selected candidates by jointly encoding the inquiry data and each candidate record, and selecting the highest-relevance records for inclusion in the generative neural network model prompt.

5. The system according to claim 4, wherein the circuitry is configured to apply the generative neural network model to the inquiry data and reranked knowledge base records using a retrieval-augmented generation process, generate the response text record by autoregressive decoding, and compute the response reliability score as a factual grounding metric measuring overlap between response text claims and retrieved knowledge base record content.

6. The system according to claim 1, wherein the circuitry is configured to route inquiry data to a human operator processing queue by generating an escalation record comprising the inquiry data, the query embedding vector, the retrieved knowledge base records, and a partial response draft generated by the generative neural network model prior to escalation, and transmitting the escalation record to the operator processing queue.

7. The system according to claim 6, wherein the circuitry is configured to monitor the human operator processing queue for processing status updates, compute a queue wait time estimate for each pending escalated inquiry, and transmit a wait time notification to the originating terminal device when the estimated queue wait time exceeds a notification threshold parameter.

8. The system according to claim 1, wherein the circuitry is configured to apply the trend analysis model to accumulated inquiry topic classification labels by applying a clustering algorithm to topic embedding vectors and computing frequency counts for each cluster, identify clusters with frequency counts exceeding a trend detection threshold, and generate the trend report data record from the identified high-frequency topic clusters.

9. The system according to claim 8, wherein the circuitry is configured to generate new knowledge base record candidates by applying the generative neural network model to representative inquiry text and validated response text from high-frequency topic clusters, compute embedding vectors for each candidate record, and transmit the candidate records to a terminal device associated with an administrative user identifier for review and approval before indexing in the knowledge base vector database.

10. The system according to claim 1, wherein the circuitry is configured to receive feedback data from terminal devices following response transmission comprising satisfaction rating values, update the response quality score associated with the corresponding knowledge base records based on the satisfaction rating values, and apply the updated quality scores as additional weighting factors in the cosine similarity score computation.

11. The system according to claim 1, wherein the circuitry is configured to apply a product information retrieval model to the inquiry data by computing cosine similarity between the query embedding vector and product record embedding vectors indexed in a product information vector database, and incorporate the top-ranked product records as additional context in the generative neural network model prompt.

12. The system according to claim 1, wherein the circuitry is configured to apply an order status lookup model to the inquiry data by extracting order identifier parameters from the inquiry text using a named entity recognition model, retrieve the corresponding order status records from the storage device, and incorporate the retrieved order status records as additional context in the generative neural network model prompt.

13. The system according to claim 1, wherein the circuitry is configured to update the knowledge base vector database on a continuous basis by retrieving updated reference documents from external data service endpoints via the communication interface, applying the natural language processing model to generate updated knowledge base record embedding vectors, and replacing outdated knowledge base records in the vector database index.

14. The system according to claim 1, wherein the circuitry is configured to apply an access control policy by validating a user role parameter associated with each inquiry request before permitting retrieval of restricted knowledge base record categories, and generate an access denial notification when a request attempts to retrieve a record category outside the permitted scope.

15. The system according to claim 1, wherein the circuitry is configured to generate a performance analytics data record from accumulated session log entries comprising average response latency, automated resolution rate by topic tier, escalation rate, and response quality score distributions, and transmit the performance analytics data record to terminal devices associated with management user identifiers.

16. The system according to claim 1, wherein the circuitry is configured to update the generative neural network model by generating training pairs from historical inquiry text data records and corresponding validated high-quality response text records, and fine-tune the model to improve response relevance and reliability for specific topic classification patterns.

17. The system according to claim 1, wherein the inquiry data comprises natural language inquiry text received via a communication channel, the knowledge base vector database stores reference records from a plurality of internal knowledge domains, and the escalation routing routes inquiries below the reliability threshold to operator identifiers with appropriate skill set parameters.

18. A system comprising:
circuitry configured to:
receive, via a communication interface coupled to a packet-switched network, inquiry data via asynchronous IO multiplexing, apply a priority scoring model to assign priority tiers, and retrieve candidate response records by cosine similarity from a knowledge base vector database;
apply a generative neural network model with retrieval-augmented generation to produce response text records and compute response reliability scores;
route low-reliability inquiries to human operator queues with partial response drafts, and monitor queue wait times;
apply trend analysis to accumulated inquiry records to detect emerging topic patterns and generate knowledge base update candidates; and
transmit response text records or escalation routing data to terminal devices.

19. The system according to claim 18, wherein the circuitry is configured to apply product information retrieval and order status lookup models to incorporate domain-specific context in generation prompts, continuously update the knowledge base vector database from external reference sources, and generate performance analytics data records from session log entries.

20. A method comprising:
receiving, via a communication interface coupled to a packet-switched network, inquiry data from a terminal device, applying a priority scoring model to assign a priority tier, and retrieving candidate response records by cosine similarity from a knowledge base vector database;
applying a generative neural network model to generate a response text record and compute a response reliability score;
routing inquiry data to a human operator processing queue when the response reliability score falls below an escalation threshold;
applying a trend analysis model to detect inquiry topic frequency patterns and generate knowledge base update candidates; and
transmitting the response text record or escalation routing data via the communication interface.
